(19) United States
(12) Patent Application Publication
(10) Pub. No.: US 2024/0227132 A9
(43) Pub. Date: Jul. 11, 2024

(54) Screw Driving Machine

(71) Applicant: Max Co., Ltd., Chuo-ku, Tokyo (JP)

(72) Inventor: Kazuya Mochizuki, Tokyo (JP)

(21) Appl. No.: 18/491,210

(22) Filed: Oct. 20, 2023

(30) Foreign Application Priority Data
Oct. 21, 2022 (JP) 2022-169173
Sep. 22, 2023 (JP) 2023-158089

(51) Int. Cl. B25B 21/02; B25B 23/06

(52) U.S. Cl. CPC B25B 21/023; B25B 23/06

(57) ABSTRACT

A screw driving machine includes a contact portion movable from a first position to a second position via a third position by abutting against a driven member to press against the driven member, a driving portion moving a driver bit when the contact portion reaches the third position to drive a screw into the driven member, a tightening portion causing the driver bit to rotate about an axis and tighten the screw after the screw is driven, a tightening depth switching portion switching a tightening depth of the screw by the tightening portion after the screw is driven, a driving depth regulating portion regulating a movement amount of the contact portion between the second position and the third position, and a driving depth switching portion switching whether to regulate the movement amount of the contact portion by the driving depth regulating portion.

### CROSS-REFERENCE TO RELATED APPLICATIONS

The present application claims priorities from Japanese Patent Application No. 2022-169173 filed on Oct. 21, 2022 and Japanese Patent Application No. 2023-158089 filed on Sep. 22, 2023, the entire contents of which are incorporated herein by reference.

### TECHNICAL FIELD

The present disclosure relates to a screw driving machine that performs tightening after driving a screw into a driven member.

### BACKGROUND ART

The screw driving machine is a tool that operates by using compressed air as a power source, causes a driver bit to move in an axial direction to drive a screw such that a head portion of the screw is lifted from a driven member, and then cause the driver bit to rotate to tighten the screw to the driven member.

In such a screw driving machine, when the screw is driven, a tip of the screw needs to be driven to penetrate an upper material of the driven member and to a middle of a lower material thereof. However, when the screw is excessively driven, a hole larger than a screw diameter is deeply bored in the lower material, and thus there is a possibility that an engagement amount of the screw is short and a fastening force is weakened.

Therefore, there has been proposed a mechanism in which a slide member that slides along an axis of an injection portion that guides a driver bit and a screw is provided on a tip side of the injection portion, and an engagement unit is provided which biases a tip of the slide member such that the tip always protrudes, engages with the slide member when the screw is driven, and releases the engagement when the screw is tightened, so that a driving depth of the screw is reduced and the screw can be tightened to a position where a head portion of the screw is flush with an upper material of a driven member when the screw is tightened (for example, see JP3570485B).

### SUMMARY

In a case where the lower material of the driven member is thick, the screw is less likely to be excessively driven, and it is not necessary to reduce the driving depth of the screw. However, even in the case where the lower material of the driven member is thick, by performing an operation of reducing the driving depth of the screw, the slide member is once engaged with the engagement unit in an operation of pressing the slide member of the screw driving machine against the driven member. Therefore, when a position of the screw driving machine is once stopped by the operation of pressing the slide member of the screw driving machine against the driven member and the engagement by the engagement unit is released, the screw driving machine moves in a direction approaching the driven member again. Therefore, the workability may be degraded. On the other hand, when the driving depth of the screw is reduced, depending on a material or a thickness of the driven member, there is a possibility that the screw cannot be driven into the lower material, and in a case where the screw cannot be driven into the lower material, there is a possibility that the screw cannot be tightened into the lower material and the construction fails.

Illustrative aspects of the present disclosure provide a screw driving machine configured to switch a driving depth of a screw.

One illustrative aspect of the present disclosure provides a screw driving machine including: a contact portion configured to abut against a driven member and to move from a first position to a second position via a third position by abutting against the driven member to press against the driven member; a driving portion configured to move a driver bit in an axial direction when the contact portion reaches the third position and to drive a screw into the driven member by moving the driver bit in the axial direction; a tightening portion configured to cause the driver bit to rotate about an axis and tighten the screw at least after the screw is driven; a tightening depth switching portion configured to switch a tightening depth of the screw by the tightening portion after the screw is driven; a driving depth regulating portion configured to regulate a movement amount of the contact portion between the second position and the third position; and a driving depth switching portion configured to switch whether to regulate the movement amount of the contact portion by the driving depth regulating portion.

In the present disclosure, whether the movement amount of the contact portion is to be regulated by the driving depth regulating portion is switched by an operation of the driving depth switching portion.

According to the present disclosure, the driving depth of the screw can be selected according to a material, a thickness, and the like of the driven member. Accordingly, in a case where it is not necessary to reduce the driving depth of the screw, for example, when the lower material of the driven member is thick, by releasing the regulation of the movement amount of the contact portion for reducing the driving depth of the screw, the position of the screw driving machine is not stopped in the middle by an operation of pressing the contact portion of the screw driving machine against the driven member, and the screw driving machine moves in the direction approaching the driven member. Therefore, the workability is improved.

### BRIEF DESCRIPTION OF DRAWINGS

FIG. 1A is a side sectional view illustrating an example of a screw driving machine according to the present illustrative embodiment;

FIG. 1B is a front sectional view illustrating the example of the screw driving machine according to the present illustrative embodiment;

FIG. 1C is a perspective view illustrating the example of the screw driving machine according to the present illustrative embodiment;

FIG. 1D is a perspective view illustrating the example of the screw driving machine according to the present illustrative embodiment;

FIG. 2A is a side sectional view of main parts of the screw driving machine according to the present illustrative embodiment illustrating an example of a switching portion;

FIG. 2B is a side sectional view of the main parts of the screw driving machine according to the present illustrative embodiment illustrating the example of the switching portion;

FIG. 3A is a bottom sectional view of the main parts of the screw driving machine according to the present illustrative embodiment illustrating the example of the switching portion;

FIG. 3B is a bottom sectional view of the main parts of the screw driving machine according to the present illustrative embodiment illustrating the example of the switching portion;

FIG. 4A is a perspective view illustrating an example of a mechanism configured to adjust a force for driving a screw;

FIG. 4B is a perspective view illustrating the example of the mechanism configured to adjust the force for driving the screw;

FIG. 5A is a side view of the screw driving machine illustrating an operation example of the mechanism configured to adjust the force for driving the screw;

FIG. 5B is a side view of the screw driving machine illustrating the operation example of the mechanism configured to adjust the force for driving the screw;

FIG. 6A is a side view illustrating an example of a lower arm;

FIG. 6B is a side view illustrating an example of an upper arm;

FIG. 6C is a side view illustrating an example of a switching member;

FIG. 7 is a side sectional view of the screw driving machine illustrating an example of an operation of driving a screw into a driven member and tightening the screw;

FIG. 8A is a front sectional view of the screw driving machine illustrating an example of the operation of driving the screw into the driven member and tightening the screw;

FIG. 8B is a front sectional view of the screw driving machine illustrating the example of the operation of driving the screw into the driven member and tightening the screw;

FIG. 8C is a front sectional view of the screw driving machine illustrating the example of the operation of driving the screw into the driven member and tightening the screw;

FIG. 8D is a front sectional view of the screw driving machine illustrating the example of the operation of driving the screw into the driven member and tightening the screw;

FIG. 8E is a front sectional view of the screw driving machine illustrating the example of the operation of driving the screw into the driven member and tightening the screw;

FIG. 8F is a front sectional view of the screw driving machine illustrating the example of the operation of driving the screw into the driven member and tightening the screw;

FIG. 8G is a front sectional view of the screw driving machine illustrating the example of the operation of driving the screw into the driven member and tightening the screw;

FIG. 9A is a side sectional view of main parts of the screw driving machine according to the present illustrative embodiment illustrating an example of an operation of driving the screw into the driven member and tightening the screw in a first mode;

FIG. 9B is a side sectional view of the main parts of the screw driving machine according to the present illustrative embodiment illustrating the example of the operation of driving the screw into the driven member and tightening the screw in the first mode;

FIG. 10A is a bottom sectional view of the main parts of the screw driving machine according to the present illustrative embodiment illustrating an example of the operation of driving the screw into the driven member and tightening the screw in the first mode;

FIG. 10B is a bottom sectional view of the main parts of the screw driving machine according to the present illustrative embodiment illustrating the example of the operation of driving the screw into the driven member and tightening the screw in the first mode;

FIG. 11A is a side sectional view of the main parts of the screw driving machine according to the present illustrative embodiment illustrating an example of the operation of driving the screw into the driven member and tightening the screw in the first mode;

FIG. 11B is a side sectional view of the main parts of the screw driving machine according to the present illustrative embodiment illustrating the example of the operation of driving the screw into the driven member and tightening the screw in the first mode;

FIG. 12A is a bottom sectional view of the main parts of the screw driving machine according to the present illustrative embodiment illustrating an example of the operation of driving the screw into the driven member and tightening the screw in the first mode;

FIG. 12B is a bottom sectional view of the main parts of the screw driving machine according to the present illustrative embodiment illustrating the example of the operation of driving the screw into the driven member and tightening the screw in the first mode;

FIG. 13A is a side sectional view of main parts of a screw driving machine according to a first modification of the present illustrative embodiment illustrating a modification of the switching portion that switches a driving depth of the screw;

FIG. 13B is a side sectional view of the main parts of the screw driving machine according to the first modification of the present illustrative embodiment illustrating the modification of the switching portion that switches the driving depth of the screw;

FIG. 14A is a bottom sectional view of main parts of the screw driving machine according to the first modification of the present illustrative embodiment illustrating the modification of the switching portion;

FIG. 14B is a bottom sectional view of the main parts of the screw driving machine according to the first modification of the present illustrative embodiment illustrating the modification of the switching portion;

FIG. 15A is a side sectional view of main parts of a screw driving machine according to the first modification of the present illustrative embodiment illustrating the example of an operation of driving the screw into the driven member and tightening the screw in the first mode;

FIG. 15B is a side sectional view of the main parts of the screw driving machine according to the first modification of the present illustrative embodiment illustrating the example of the operation of driving the screw into the driven member and tightening the screw in the first mode;

FIG. 16A is a bottom sectional view of the main parts of a screw driving machine according to the first modification of the present illustrative embodiment illustrating the example of the operation of driving the screw into the driven member and tightening the screw in the first mode;

FIG. 16B is a bottom sectional view of the main parts of the screw driving machine according to the first modification of the present illustrative embodiment illustrating the example of the operation of driving the screw into the driven member and tightening the screw in the first mode;

FIG. 17A is a side sectional view of main parts of a screw driving machine according to the first modification of the present illustrative embodiment illustrating an example of an operation of driving the screw into the driven member and tightening the screw in a second mode;

FIG. 17B is a side sectional view of the main parts of the screw driving machine according to the first modification of the present illustrative embodiment illustrating the example of the operation of driving the screw into the driven member and tightening the screw in the second mode;

FIG. 18A is a bottom sectional view of the main parts of a screw driving machine according to the first modification of the present illustrative embodiment illustrating the example of the operation of driving the screw into the driven member and tightening the screw in the second mode;

FIG. 18B is a bottom sectional view of the main parts of the screw driving machine according to the first modification of the present illustrative embodiment illustrating the example of the operation of driving the screw into the driven member and tightening the screw in the second mode;

FIG. 19A is a front view of main parts of a screw driving machine according to a second modification of the present illustrative embodiment illustrating a state where the screw is driven into the driven member at a first driving depth (1) in the first mode;

FIG. 19B is a side view of the main parts of the screw driving machine according to the second modification of the present illustrative embodiment illustrating the state where the screw is driven into the driven member at the first driving depth (1) in the first mode;

FIG. 19C is a bottom view of the main parts of the screw driving machine according to the second modification of the present illustrative embodiment illustrating the state where the screw is driven into the driven member at the first driving depth (1) in the first mode;

FIG. 20A is a front view of main parts of a screw driving machine according to second modification of the present illustrative embodiment illustrating a state where the screw is driven into the driven member at a first driving depth (2) in the first mode;

FIG. 20B is a side view of the main parts of the screw driving machine according to the second modification of the present illustrative embodiment illustrating the state where the screw is driven into the driven member at the first driving depth (2) in the first mode;

FIG. 20C is a bottom view of the main parts of the screw driving machine according to the second modification of the present illustrative embodiment illustrating the state where the screw is driven into the driven member at the first driving depth (2) in the first mode;

FIG. 21A is a front view of main parts of a screw driving machine according to second modification of the present illustrative embodiment illustrating a state where the screw is driven into the driven member in the second mode;

FIG. 21B is a side view of the main parts of the screw driving machine according to the second modification of the present illustrative embodiment illustrating the state where the screw is driven into the driven member in the second mode;

FIG. 21C is a bottom view of the main parts of the screw driving machine according to the second modification of the present illustrative embodiment illustrating the state where the screw is driven into the driven member in the second mode;

FIG. 22A is a front view of main parts of a screw driving machine according to second modification of the present illustrative embodiment illustrating a sign-in state where the screw is driven into the driven member at the first driving depth (1) in the first mode;

FIG. 22B is a side view of the main parts of the screw driving machine according to the second modification of the present illustrative embodiment illustrating the sign-in state where the screw is driven into the driven member at the first driving depth (1) in the first mode;

FIG. 23A is a front view of main parts of a screw driving machine according to second modification of the present illustrative embodiment illustrating a sign-in state where the screw is driven into the driven member at the first driving depth (2) in the first mode;

FIG. 23B is a side view of the main parts of the screw driving machine according to the second modification of the present illustrative embodiment illustrating the sign-in state where the screw is driven into the driven member at the first driving depth (2) in the first mode;

FIG. 24A is a front view of main parts of a screw driving machine according to second modification of the present illustrative embodiment illustrating a sign-in state where the screw is driven into the driven member in the second mode;

FIG. 24B is a side view of the main parts of the screw driving machine according to the second modification of the present illustrative embodiment illustrating the sign-in state where the screw is driven into the driven member in the second mode;

FIG. 25A is a cross-sectional view illustrating a first modified configuration example of the screw driving machine according to the present illustrative embodiment;

FIG. 25B is a cross-sectional view illustrating the first modified configuration example of the screw driving machine according to the present illustrative embodiment;

FIG. 26A is a perspective view of main parts illustrating a second modified configuration example of the screw driving machine according to the present illustrative embodiment;

FIG. 26B is a perspective view of the main parts illustrating the second modified configuration example of the screw driving machine according to the present illustrative embodiment;

FIG. 27A is a side sectional view of main parts of a screw driving machine according to a third modification of the present embodiment illustrating a modified example of the switching portion that switches a driving depth of the screw;

FIG. 27B is a side sectional view of the main parts of the screw driving machine according to the third modification of the present embodiment illustrating the modified example of the switching portion that switches the driving depth of the screw;

FIG. 28A is a side sectional view of the main parts of the screw driving machine according to the third modification of the present embodiment illustrating the modified example of the switching portion that switches the driving depth of the screw;

FIG. 28B is a side sectional view of the main parts of the screw driving machine according to the third modification of the present embodiment illustrating the modified example of the switching portion that switches the driving depth of the screw;

FIG. 29A is a side view illustrating a modified example of a lower arm;

FIG. 29B is a side view illustrating a modified example of an upper arm; and

FIG. 29C is a side view illustrating a modified example of a switching member.

### DESCRIPTION OF EMBODIMENTS

Hereinafter, illustrative embodiments of a screw driving machine according to the present disclosure will be described with reference to the drawings.

### Configuration Example of Screw Driving Machine

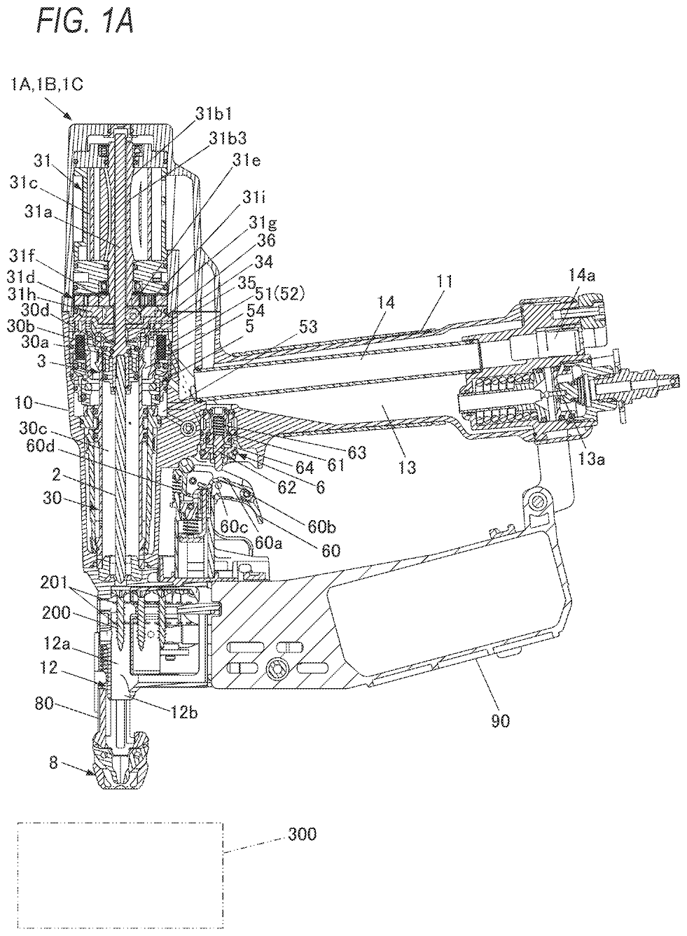

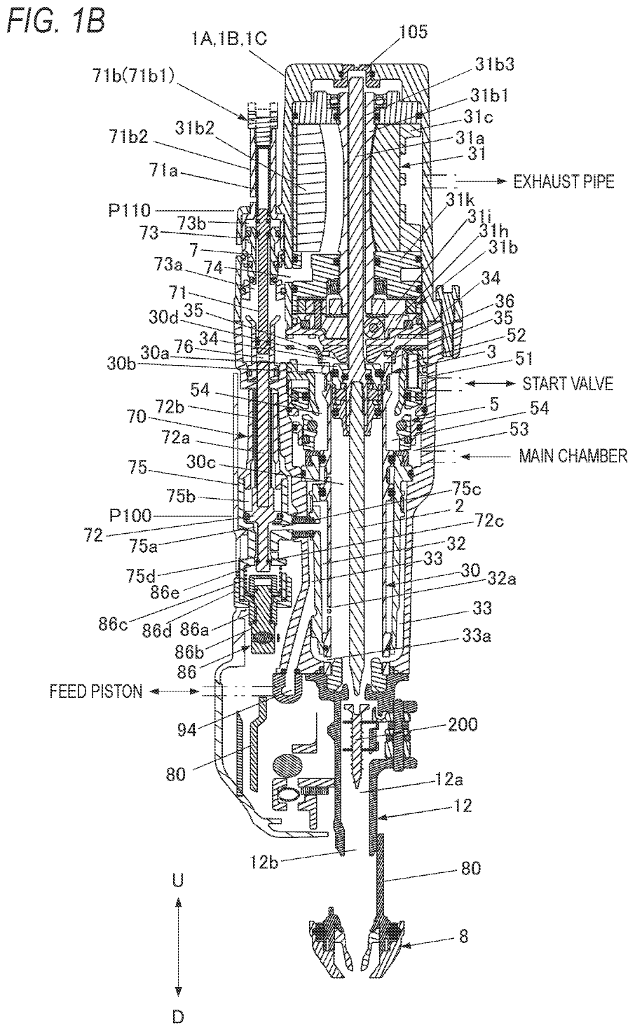

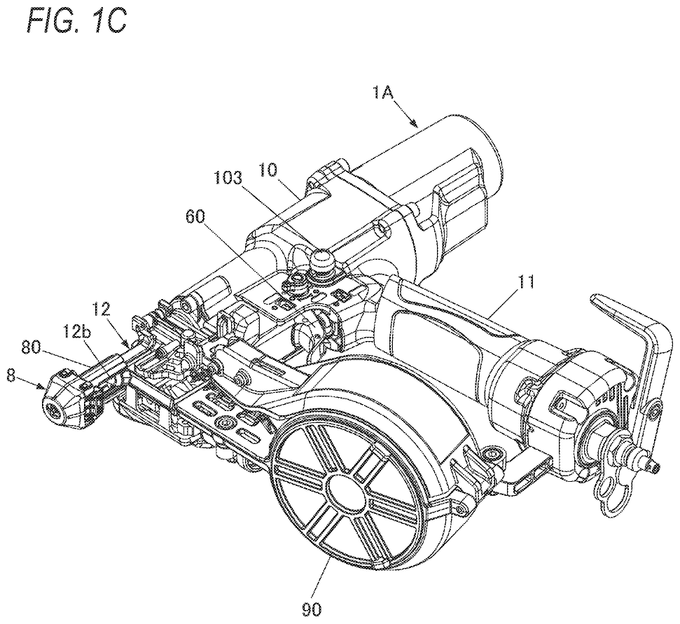

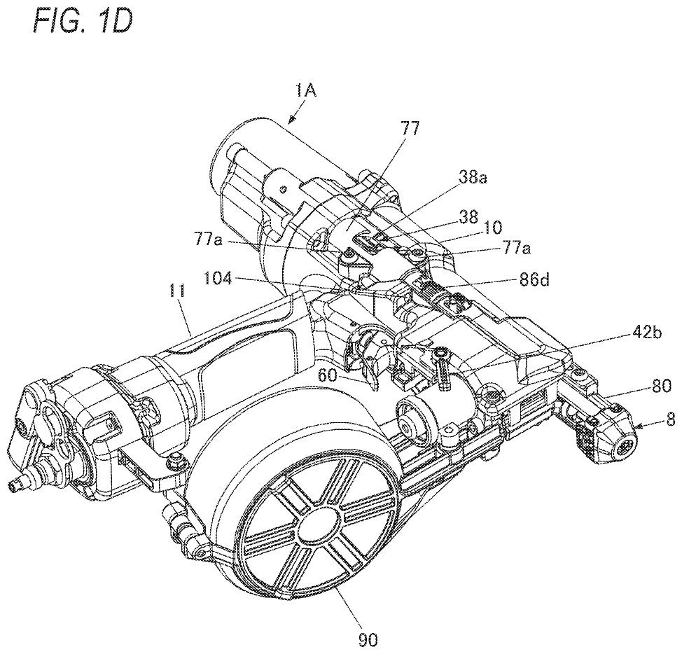

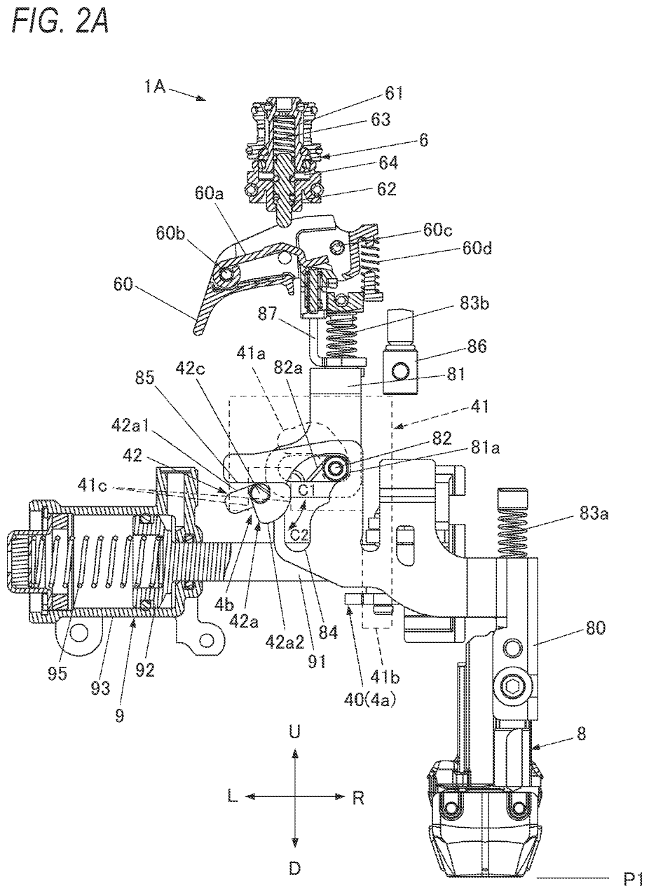

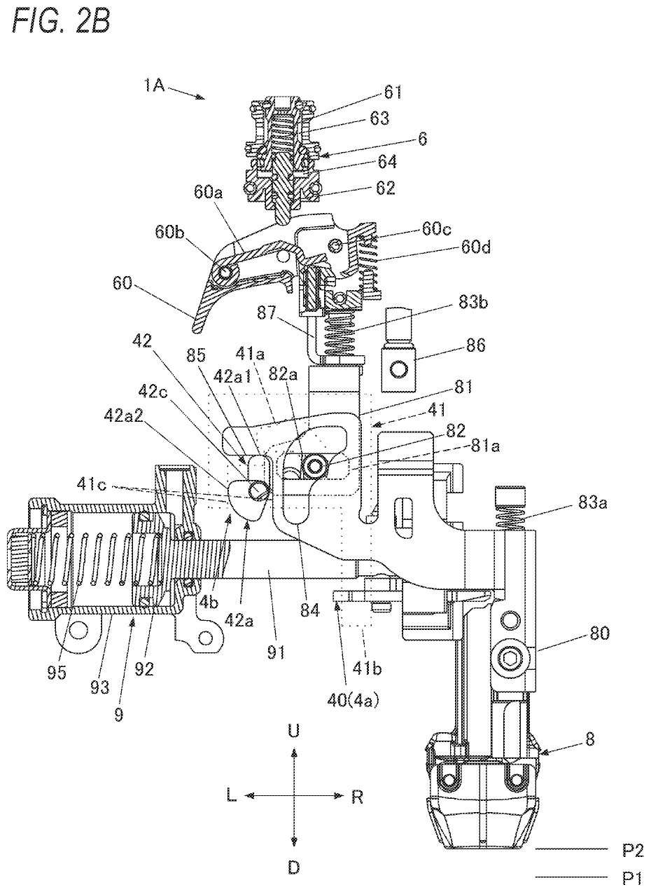

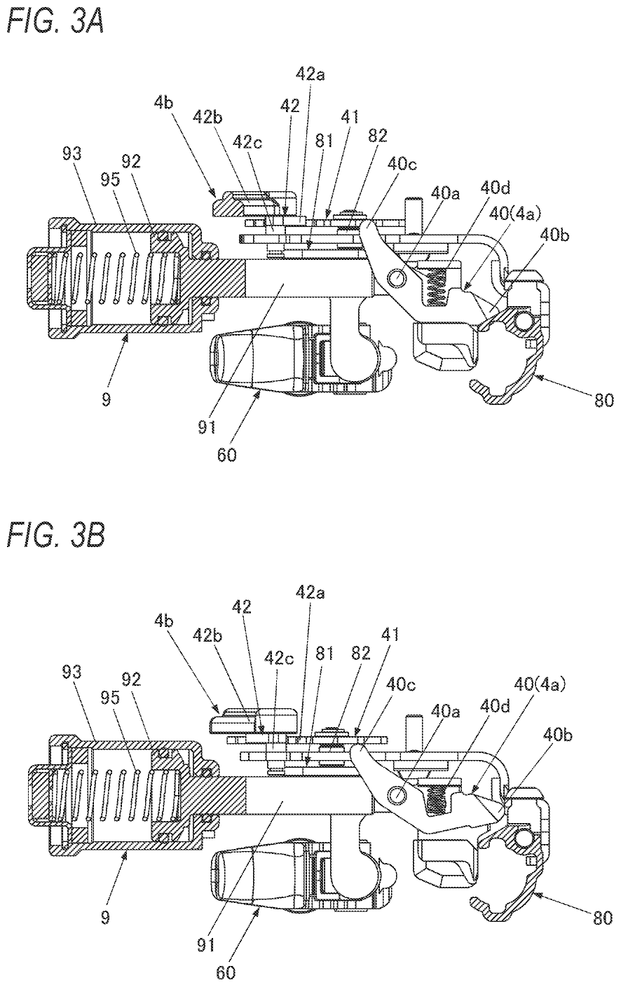

FIG. 1A is a side sectional view illustrating an example of the screw driving machine according to the present illustrative embodiment, and FIG. 1B is a front sectional view illustrating the example of the screw driving machine according to the present illustrative embodiment. In addition, FIGS. 1C and 1D are perspective views illustrating examples of the screw driving machine according to the present illustrative embodiment. Further, FIGS. 2A and 2B are side sectional views of main parts of the screw driving machine according to the present illustrative embodiment illustrating an example of a switching portion that switches a driving depth of a screw, and FIGS. 3A and 3B are bottom sectional views of the main parts of the screw driving machine according to the present illustrative embodiment illustrating examples of the switching portion.

FIGS. 2A and 3A illustrate states of respective parts when a first mode in which the driving depth of the screw is set to a first driving depth is selected. In addition, FIG. 2B and FIG. 3B illustrate states of the respective parts when a second mode in which the driving depth of the screw is set to a second driving depth that is deeper than the first driving depth is selected.

A screw driving machine 1A includes a fastening portion 3. The fastening portion is driven by compressed air, causes a driver bit 2 to move in an axial direction, drives a screw 200 into a driven member 300, and then causes the driver bit 2 to rotate to tighten the screw 200. The fastening portion 3 includes a driving cylinder 30 and an air motor 31. The driving cylinder 30 is configured to cause the driver bit 2 to move in the axial direction. The air motor 31 is configured to causes the driver bit 2 to rotate around an axis.

In addition, the screw driving machine 1A includes a main valve 5, a start valve 6, and a trigger 60. The main valve 5 is configured to switch whether the compressed air is to be supplied to the driving cylinder 30. The start valve 6 is configured to cause the main valve 5 to operate. The trigger 60 is configured to cause the start valve 6 to operate.

Further, the screw driving machine 1A includes an on-off valve 7 and a controller 70. The on-off valve 7 is configured to switch whether the compressed air is to be supplied to the air motor 31. The controller 70 is configured to cause the on-off valve 7 to operate. In addition, the screw driving machine 1A includes a contact arm 8. The contact arm 8 is configured to come into contact with the driven member 300, be movable in the axial direction along a driving direction of the screw 200, enable the start valve 6 to operate in cooperation with an operation of the trigger 60, and cause the controller 70 to operate.

Further, the screw driving machine 1A includes a driving depth regulating portion 4a and a driving depth switching portion 4b. The driving depth regulating portion 4a is configured to regulate a movement amount of the contact arm 8 from a bottom dead center position during a driving operation in which the driving cylinder 30 causes the driver bit 2 to move in the axial direction. The driving depth switching portion 4b is configured to switch whether the movement amount of the contact arm 8 is to be regulated by the driving depth regulating portion 4a.

In addition, the screw driving machine 1A includes a screw feeding portion 9 and a magazine 90. The screw feeding portion 9 is configured to feed the screw 200 to a nose portion 12 to be described later. The magazine 90 is configured to accommodate the screw 200 fed by the screw feeding portion 9.

The screw driving machine 1A includes a main body portion 10 and a handle portion 11. The handle portion 11 extends in a direction intersecting the main body portion 10. In the screw driving machine 1A, the nose portion 12, through which the driver bit 2 passes when the screw 200 is supplied by the screw feeding portion 9, is provided on one side along an extending direction of the main body portion 10 extending along the axial direction of the driver bit 2. In the screw driving machine 1A, the one side along the extending direction of the main body portion 10 on which the nose portion 12 is provided is referred to as a lower side, and the other side along the extending direction of the main body portion 10 is referred to as an upper side.

In the screw driving machine 1A, the magazine 90 is provided on the lower side of the handle portion 11 in a case where one side of the handle portion 11 along an extending direction of the main body portion 10 is directed toward the lower side, and the magazine 90 is provided on a front side of the handle portion 11 in a case where the screw driving machine 1A is used in a lateral orientation. In addition, in the screw driving machine 1A, the air motor 31 is provided on the upper side of the handle portion 11 in the case where the one side of the handle portion 11 along the extending direction of the main body portion 10 is directed toward the lower side, and the air motor 31 is provided on a rear side of the handle portion 11 in the case where the screw driving machine 1A is used in a lateral orientation.

The nose portion 12 includes an injection passage 12a and an injection port 12b. The screw 200 coupled by a coupling band 201 is supplied to the injection passage 12a. The injection port 12b is formed in one end portion along an extending direction of the injection passage 12a indicated by an arrow D. The screw 200 separated from the coupling band 201 is injected from the injection port 12b.

The screw driving machine 1A includes a main chamber 13 to which compressed air is supplied from an external air compressor (not illustrated). The main chamber 13 is provided in the handle portion 11 and on an outer periphery of the driving cylinder 30 connected to an inside of the handle portion 11 in the main body portion 10. Compressed air decompressed by a pressure reducing valve 13a is supplied to the main chamber 13. In addition, the screw driving machine 1A includes an exhaust pipe 14. The compressed air supplied to the driving cylinder 30, the air motor 31, and the like, is exhausted from the exhaust pipe 14. The exhaust pipe 14 is provided in the handle portion 11. The compressed air is exhausted from the exhaust pipe 14 via an exhaust filter 14a.

The driving cylinder 30 is an example of a driving portion. The driving cylinder 30 is provided inside the main body portion 10 in a form of extending vertically. The driving cylinder 30 is provided with a driving piston 30a in a cylindrical internal space so as to be slidable. The driving piston 30a includes a seal portion 30b on an outer periphery thereof. The driving piston 30a is accommodated in the driving cylinder 30. The driving piston 30a partitions an interior of the driving cylinder 30 into a first chamber 30c which is a lower chamber of the driving cylinder and a second chamber 30d which is an upper chamber of the driving cylinder. A motor shaft 31a is attached to the driving piston 30a. The motor shaft 31a is driven by the air motor 31. In a state where the driving piston 30a is at the top dead center position, the driver bit 2 is connected to a first chamber 30c side. That is, the driver bit 2 is detachably attached to the driving piston 30a via the motor shaft 31a in a form of protruding from the driving piston 30a toward the lower side. In addition, the motor shaft 31a is provided on a side opposite to the driver bit 2 with respect to the driving piston 30a. The motor shaft 31a is attached to the driving piston 30a in a form of protruding from the driving piston 30a toward the upper side.

In the driving cylinder 30, the compressed air is supplied from the main chamber 13 to the second chamber 30d. The driving piston 30a is pressed by an air pressure of the compressed air supplied to the second chamber 30d of the driving cylinder 30 and moves in a downward direction indicated by an arrow D, which is a first direction, to cause the driver bit 2 to move in the downward direction along the axial direction. The driver bit 2 and the motor shaft 31a move integrally with the driving piston 30a. The driver bit 2 that moves in the downward direction is guided by the injection passage 12a of the nose portion 12, thereby driving the screw 200 supplied from the magazine 90 to the injection passage 12a of the nose portion 12 into the driven member 300. In addition, when the motor shaft 31a rotates, the driver bit 2 rotates integrally with the motor shaft 31a to fasten the screw 200 driven into the driven member 300.

The screw driving machine 1A includes a timer chamber 32 and a blowback chamber 33. The timer chamber 32 is supplied with the compressed air for causing the controller 70 to operate. The blowback chamber 33 causes the driving piston 30a moved to the bottom dead center position to return to the top dead center position and is supplied with the compressed air for causing the screw feeding portion 9 to operate.

The timer chamber 32 and the blowback chamber 33 are provided on an outer peripheral side of the driving cylinder 30 inside the main body portion 10. The timer chamber 32 is in communication with a space in the driving cylinder 30 via a side hole flow path 32a of the driving cylinder 30. In addition, the blowback chamber 33 is in communication with the space in the driving cylinder 30 via a side hole flow path 33a of the driving cylinder 30. In the timer chamber 32 and the blowback chamber 33, the compressed air is supplied by an operation of the driving piston 30a moving from the top dead center position to the bottom dead center position, and pressure increases according to a position of the driving piston 30a.

The air motor 31 is an example of a tightening unit. The air motor 31 includes a rotor 31b1, a blade 31b2, and a motor housing 31c. The rotor 31b1 is configured to rotate when the compressed air is supplied. The blade 31b2 is configured to receive a flow of air for causing the rotor 31b1 to rotate. The motor housing 31c rotatably supports the rotor 31b1 and is configured to generate the flow of air for causing the rotor 31b1 to rotate. In the air motor 31, rotation of the rotor 31b1 is transmitted to the motor shaft 31a via a speed reducer 31d. The speed reducer 31d is provided between the driving cylinder 30 and the air motor 31. The speed reducer 31d is configured by a planetary gear mechanism. The speed reducer 31 includes a sun gear 31e connected to the rotor 31b1, a plurality of planetary gears 31f meshing with the sun gear 31e, an outer gear 31g meshing with the planetary gears 31f, and a carrier 31h rotatably supporting the planetary gears 31f. In the speed reducer 31d, the sun gear 31e, the planetary gears 31f, and the outer gear 31g are provided on the same surface in the axial direction of the driver bit 2. In addition, in the speed reducer 31d, the carrier 31h is provided on the lower side of the sun gear 31e, the planetary gears 31f, and the outer gear 31g.

The rotor 31b1 has a hollow structure in which a hole portion 31b3 is provided so as to penetrate from an upper end to a lower end in the axial direction along an upward direction indicated by an arrow U and the downward direction indicated by the arrow D. The motor shaft 31a is inserted into the hole portion 31b3 so as to be movable in the axial direction. The hole portion 31b3 is provided coaxially with a center of rotation of the rotor 31b1. The rotor 31b1 is provided with an engagement position connected to the sun gear 31e on the lower end thereof. The engagement position connected to the sun gear 31e is configured by a polygonal shaft, for example, a hexagonal shaft, and in the sun gear 31e, an engagement position connected to the rotor 31b1 is formed by a polygonal hole, for example, a hexagonal hole. The outer gear 31g has teeth formed on an inner peripheral surface of an annular member, and is non-rotatably fixed concentrically with the sun gear 31e. The planetary gear 31f is rotatably supported by the carrier 31h, and meshes with the sun gear 31e and the outer gear 31g in a form of being interposed between the sun gear 31e and the outer gear 31g. Accordingly, in the speed reducer 31d, when the sun gear 31e rotates as the rotor 31b1 rotates, the carrier 31h rotates at a predetermined reduction ratio while the planetary gear 31f rotates.

The carrier 31h includes a plurality of gear rollers 31i that support the motor shaft 31a to be movable in the axial direction. The gear rollers 31i are rotatably supported by the carrier 31h in a disposition in which outer peripheral surfaces thereof are positioned on sides of a polygon, for example, a triangle, surrounding a center of rotation of the carrier 31h. The motor shaft 31a has a configuration in which a position in contact with the gear roller 31i is a flat surface. The motor shaft 31a has three flat surfaces in accordance with the disposition of the gear rollers 31i. Accordingly, the motor shaft 31a is supported at the center of rotation of the carrier 31h by the plurality of gear rollers 31i, and is movable in the axial direction by rotation of the gear rollers 31i. Thus, when the driving piston 30a moves in the downward direction in the driving cylinder 30 due to the air pressure of the compressed air, the motor shaft 31a moves in the downward direction integrally with the driving piston 30a and the driver bit 2.

When the flat surface of the motor shaft 31a comes into contact with the gear roller 31i, the motor shaft 31a rotates together with the carrier 31h. Thus, when the rotor 31b1 of the air motor 31 rotates due to the air pressure of the compressed air, the motor shaft 31a rotates together with the carrier 31h rotating at the predetermined reduction ratio.

The air motor 31 is provided on the upper side of the main body portion 10. In the air motor 31, the motor shaft 31a is provided coaxially with the driver bit 2. Accordingly, the air motor 31 is provided coaxially with the driving cylinder 30 on a side opposite to the lower side on which the nose portion 12 is provided in the main body portion 10 and on the upper side of the driving cylinder 30 along the axial direction of the driver bit 2. In addition, with a configuration in which the motor shaft 31a is inserted into the hole portion 31b3 provided in the rotor 31b1 and a configuration in which the air motor 31 is provided on the upper side of the driving cylinder 30, the air motor 31 ensures a space in which the motor shaft 31a moving in an up-down direction operates.

The main valve 5 is vertically movably provided on an outer peripheral side of the driving cylinder 30. In addition, the main valve 5 is biased by a main valve spring 51 in the downward direction, which is a direction in which an air flow path 54 is closed. Further, in the main valve 5, the compressed air is supplied, via the start valve 6, from the main chamber 13 to a main valve upper chamber 52 in which the main valve spring 51 is provided, and the main valve 5 is pressed in the downward direction by the air pressure of the compressed air. In addition, in the main valve 5, the compressed air is supplied from the main chamber 13 to a main valve lower chamber 53, and the main valve 5 is pressed in the upward direction by the air pressure of the compressed air.

Accordingly, the main valve 5 opens and closes the air flow path 54 connecting the main chamber 13, the driving cylinder 30, and the air motor 31. The air flow path 54 is an example of a first air flow path. The air flow path 54 is provided between the driving cylinder 30 and the main valve 5 on an inner peripheral side of the main valve 5 and on the outer peripheral side of the driving cylinder and is connected to the main valve lower chamber 53 via the main valve 5. When the main valve 5 is not in operation, the main valve 5 is biased in the downward direction to be located at the bottom dead center position based on a relation, the relation being of a force of the main valve spring 51 and a balance between the air pressure of the compressed air supplied to the main valve upper chamber 52 and the air pressure of the compressed air supplied to the main valve lower chamber 53, thereby blocking the air flow path 54 between the main valve lower chamber 53 and the driving cylinder 30. On the other hand, when the main valve 5 is in operation, the main valve 5 is pressed in the upward direction by the air pressure of the compressed air supplied from the main chamber 13 to the main valve lower chamber 53 when the main valve upper chamber 52 is in communication with the atmosphere via the start valve 6, thereby opening the air flow path 54 between the main valve lower chamber 53 and the driving cylinder 30.

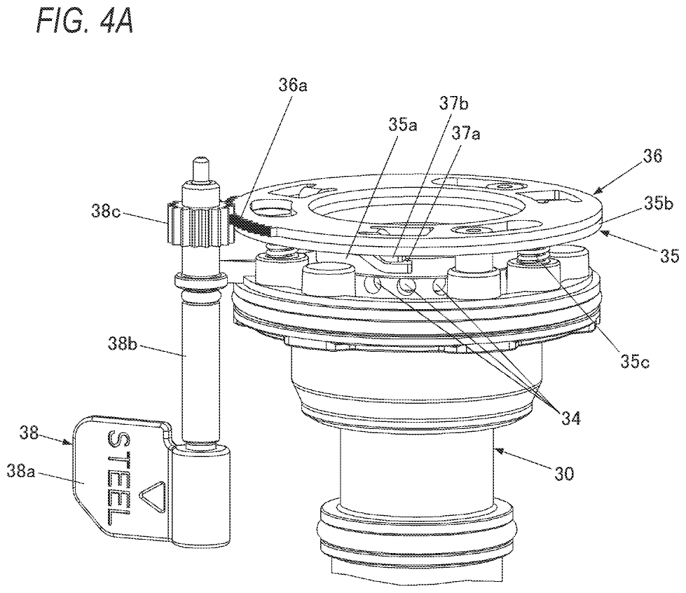

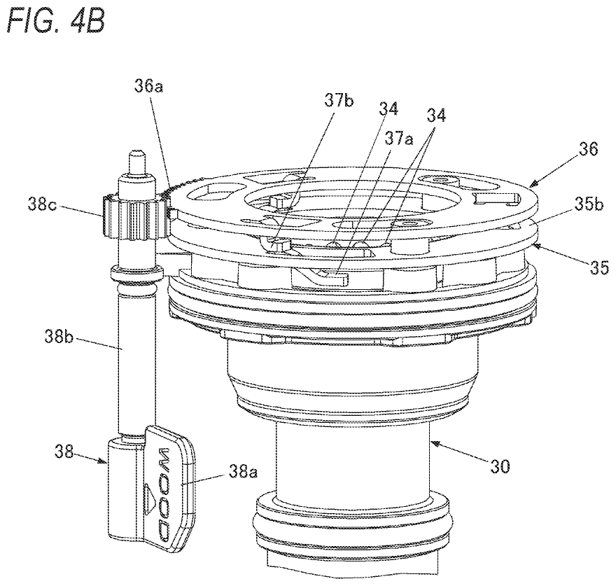

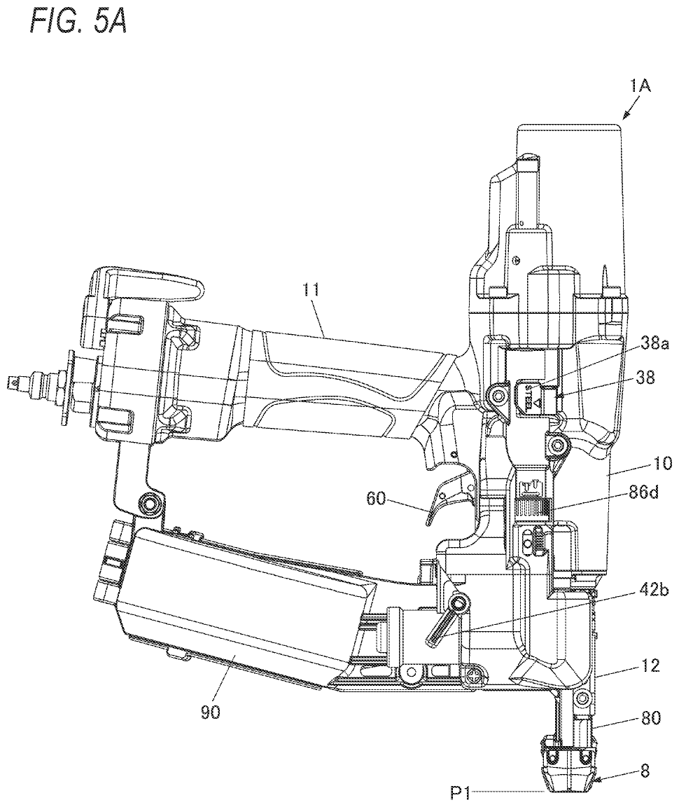

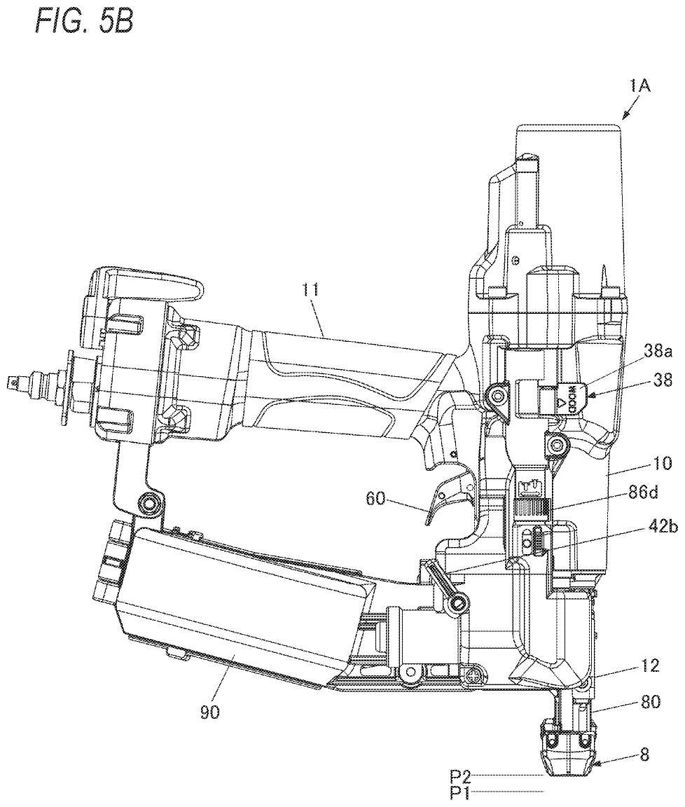

FIGS. 4A and 4B are perspective views illustrating examples of a mechanism that adjusts a force for driving a screw, and FIGS. 5A and 5B are side views of the screw driving machine illustrating an operation example of the mechanism that adjusts the force for driving the screw.

The screw driving machine 1A includes a supply port 34 and a throttle portion 35. The supply port 34 connects the air flow path 54 and the driving cylinder 30 on a downstream side of the main valve 5. The throttle portion 35 is configured to switch an opening area of the supply port 34. The supply port 34 is provided in a side surface of an upper portion of the driving cylinder 30. The supply port 34 is formed by an opening that penetrates a side wall of the driving cylinder 30 and connects an outer side and an inner side of the driving cylinder 30.

The throttle portion 35 includes a cylindrical portion 35a and a plate-like flange portion 35b. The cylindrical portion 35a contacts the outer periphery of the driving cylinder 30. The plate-like flange portion 35b protrudes from the cylindrical portion 35a toward an outer side direction. The throttle portion 35 is vertically movably provided along the outer periphery of the driving cylinder 30 at a portion where the supply port 34 is provided.

The screw driving machine 1A includes a flow rate switching member 36 that is engageable with the throttle portion 35. The flow rate switching member 36 is formed by a plate-like member. The flow rate switching member 36 is provided so as to overlap the upper side of the flange portion 35b of the throttle portion 35 on the outer periphery of the driving cylinder 30. The flow rate switching member 36 is configured to be rotatable about a shaft of the driving cylinder 30 that is coaxial with the axial direction of the driver bit 2.

The throttle portion 35 includes a cam surface 37a that converts rotation of the flow rate switching member 36 into movement of the throttle portion 35 in the axial direction of the driving cylinder 30. In addition, the flow rate switching member 36 includes an engaging portion 37b that follows the cam surface 37a. The cam surface 37a is an example of a cam portion. The cam surface 37 is formed by a surface inclined in the axial direction of the driving cylinder 30 along a rotation direction of the flow rate switching member 36. The engaging portion 37b is an example of the cam portion. The engaging portion 37b is configured by a convex portion that protrudes in a direction from the flow rate switching member 36 toward the throttle portion 35 and is in contact with the cam surface 37a.

The throttle portion 35 is biased by a biasing member 35c such as a coil spring in a direction in which the flange portion 35b approaches the flow rate switching member 36. Accordingly, the throttle portion 35 and the flow rate switching member 36 are engaged with the cam surface 37a via the engaging portion 37b in a form in which the engaging portion 37b is in contact with the cam surface 37a.

The throttle portion 35 does not rotate with respect to the driving cylinder 30, and a portion of the cam surface 37a with which the engaging portion 37b of the flow rate switching member 36 comes into contact changes as the flow rate switching member 36 rotates. Accordingly, the throttle portion 35 moves in a direction approaching and a direction separating from the flow rate switching member 36 according to the rotation direction of the flow rate switching member 36, thereby moving along the axial direction of the driving cylinder 30 interlocking with the rotation of the flow rate switching member 36, and switching a size of the opening area of the supply port 34.

The screw driving machine 1A includes an operation member 38 configured to cause the flow rate switching member 36 to rotate. The operation member 38 includes an operation portion 38a, a shaft portion 38b, and a gear 38c. The operation portion 38a receives an operation of causing the flow rate switching member 36 to rotate. The shaft portion 38b protrudes from the operation portion 38a. The gear 38c is provided on the shaft portion 38b. In the operation member 38, the operation portion 38a is exposed to an outside of the main body portion 10, and the operation portion 38a can be operated from the outside of the main body portion 10.

In the operation member 38, when the operation portion 38a is operated, the gear 38c rotates about the shaft portion 38b as a fulcrum. The gear 38c meshes with a gear 36a provided on an outer periphery of the flow rate switching member 36. Accordingly, in the operation member 38, when the operation portion 38a is operated, the gear 38c rotates about the shaft portion 38b as a fulcrum, and thus the flow rate switching member 36 in which the gear 38c and the gear 36a mesh with each other rotates.

In the operation member 38, a material or the like of the driven member 300 is indicated on the operation portion 38a as a guide for selecting a force for driving the screw 200. The operation member 38 is configured to operate the operation portion 38a in a direction in which an indication of a desired material can be seen, as illustrated in FIGS. 5A and 5B, according to the material of the driven member 300 that performs driving and tightening of the screw 200, thereby switching the size of the opening area of the supply port 34 in accordance with the material or the like of the driven member 300.

The start valve 6 includes a pilot valve 61, a valve stem 62, and a valve stem spring 63. The pilot valve 61 is configured to open and close the main valve upper chamber 52. The valve stem 62 is configured to cause the pilot valve 61 to operate. The valve stem spring 63 is configured to bias the pilot valve 61 in the upward direction and to bias the valve stem 62 in the downward direction.

In the start valve 6, the pilot valve 61 is pressed in the downward direction due to the air pressure of the compressed air supplied from the main chamber 13. In addition, in the start valve 6, the pilot valve 61 is pressed in the upward direction due to the air pressure of the compressed air supplied from the main chamber 13 to a valve lower chamber 64.

Accordingly, in the start valve 6, the pilot valve 61 is held at an upper position based on a relation between a balance of the air pressure of the compressed air and a force of the valve stem spring 63. In contrast, in the start valve 6, when the valve stem 62 moves in the upward direction, the valve lower chamber 64 is in communication with the atmosphere, and thus the pilot valve 61 moves in the downward direction due to the air pressure of the compressed air. Further, when the pilot valve 61 moves in the downward direction, a passage through which the main valve upper chamber 52 communicates with the atmosphere is opened.

The trigger 60 is provided on the lower side of the handle portion 11 and rotates about 60c as a fulcrum in response to an operation of an operator. The trigger 60 is biased in the direction separating from the valve stem 62 of the start valve 6 by a trigger spring 60d.

The trigger 60 includes a contact lever 60a that causes the valve stem 62 of the start valve 6 to operate. The contact lever 60a is supported by the trigger 60 so as to be rotatable about a shaft 60b as a fulcrum. The contact lever 60a does not come into contact with the valve stem 62 only in a state where an operation of pulling the trigger 60 is performed. In contrast, when the contact lever 60a is pressed by an upper arm 81 to be described later of the contact arm 8 in the state where the operation of pulling the trigger 60 is performed, the valve stem 62 is caused to move in the upward direction. When the operation of pulling the trigger 60 is performed in a state where the contact lever 60a is pressed by the upper arm 81, the contact lever 60a causes the valve stem 62 to move in the upward direction. Accordingly, the start valve 6 is operated by a combination of an operation of the trigger 60 and an operation of being pressed by the contact arm 8. An order of the operation of the trigger 60 and the operation of being pressed by the contact arm 8 is optional.

The on-off valve 7 is vertically movably supported by an on-off valve cylinder 73 provided in the motor housing 31c. In the on-off valve cylinder 73, an on-off valve lower chamber 73a is provided on the lower side of the on-off valve 7 indicated by the arrow D, and an on-off valve upper chamber 73b is provided on the upper side of the on-off valve 7 indicated by the arrow U. The on-off valve 7 is operated by the compressed air supplied from the main chamber 13 and, in a state where the compressed air is not supplied to the on-off valve upper chamber 73b, the on-off valve 7 moves in the upward direction indicated by the arrow U due to the compressed air supplied to the on-off valve lower chamber 73a. In addition, when the compressed air is supplied to the on-off valve upper chamber 73b, the on-off valve upper chamber 73b moves in the downward direction as indicated by the arrow D.

The on-off valve 7 is configured to open and close the air flow path 74 connected to the air motor 31 by moving in the up-down direction. The air flow path 74 is an example of a second air flow path. The air flow path 74 is in communication with the air flow path 54 on the downstream side of the main valve 5 and on an upstream side of the supply port 34. In the air flow path 74, a flow of air between the main chamber 13 and the air motor 31 is blocked when the on-off valve 7 moves in the downward direction and is closed. In addition, in the air flow path 74, when the on-off valve 7 moves in the upward direction and opens, communication between the main chamber 13 and the air motor 31 is established. The on-off valve 7 is provided on a side portion of the air motor 31. A controller cover 77 covering the on-off valve 7, the controller 70, and the like is fixed to the main body portion 10 by a screw 77a.

The controller 70 includes a control valve cylinder 75, a first control valve 72, a communication passage 75c, and a second control valve 71. The first control valve 72 is accommodated in the control valve cylinder 75 and partitions an inside of the control valve cylinder 75 into a third chamber 75a and a fourth chamber 75b. The communication passage 75c allows the inside of the driving cylinder 30 and the third chamber 75a in the control valve cylinder 75 to communicate with each other via the timer chamber 32. The second control valve 71 is located on an arrow U direction side with respect to the first control valve 72 and is disposed away from the first control valve 72.

In addition, the controller 70 includes a first biasing member 72b and a second biasing member 71b. The first biasing member 72b is a first biasing portion configured to bias the first control valve 72 in an arrow D direction. The second biasing member 71a is a second biasing portion configured to bias the second control valve 71 in an arrow D direction.

In the control valve cylinder 75, the third chamber 75a is provided on the lower side of the first control valve 72 indicated by the arrow D, and the fourth chamber 75b is provided on the upper side of the first control valve 72 indicated by the arrow U. In the control valve cylinder 75, the third chamber 75a is in communication with the timer chamber 32 via the communication passage 75c, and is in communication with the space in the driving cylinder 30 via the timer chamber 32. In addition, in the control valve cylinder 75, the third chamber 75a is in communication with an outside of a body of the screw driving machine 1A via an exhaust passage 75d.

The first control valve 72 is vertically movably supported by the control valve cylinder 75 along the upward direction indicated by the arrow U and the downward direction indicated by the arrow D. In addition, in the first control valve 72, a rod-shaped coupling portion 72a extending in the up-down direction is coupled in a form protruding in the upward direction indicated by the arrow U. Further, the first control valve 72 is biased in the arrow D direction by the first biasing member 72b such as a coil spring.

The first control valve 72 is configured to be movable to a standby position P100 which is the bottom dead center position by moving in the downward direction indicated by the arrow D, and is configured to be movable to a later-described operation completion position which is the top dead center position by moving in the upward direction indicated by the arrow U.

The first control valve 72 moves to the standby position P100 by being biased in the arrow D direction by the first biasing member 72b.

The first control valve 72 includes a seal portion 72c that opens and closes the exhaust passage 75d. In a state where the first control valve 72 stands by at the standby position P100, the seal portion 72c moves to a position to open the exhaust passage 75d, and the third chamber 75a of the control valve cylinder 75 is in communication with the outside of the body of the screw driving machine 1A via the exhaust passage 75d. When the first control valve 72 moves to a later-described pressure control start position between the standby position P100 and the operation completion position in a process of moving from the standby position P100 to the operation completion position, the seal portion 72c moves to a position to close the exhaust passage 75d.

The first control valve 72 standing by at the standby position P100 is pressed and operated by a later-described lower arm 80 of the contact arm 8 via a tightening depth adjusting portion 86, and moves from the standby position P100 to the pressure control start position. In addition, when the first control valve 72 moves to the pressure control start position, the first control valve 72 is operated due to the compressed air supplied from the timer chamber 32 and moves from the pressure control start position to the operation completion position. In the process of moving from the pressure control start position to the operation completion position, the first control valve 72 presses the second control valve 71 via the coupling portion 72a to cause the second control valve 71 to operate.

The second control valve 71 is configured by a rod-shaped member extending in the up-down direction, and is vertically movably supported with respect to the on-off valve 7. The second control valve 71 moves to a standby position P110 by being biased in the arrow D direction by the second biasing member 71a. In addition, the second control valve 71 is operated by being pressed by the first control valve 72. The second control valve 71 is movable from the standby position P110 to the later-described operation completion position and is configured to cause the on-off valve 7 to operate by switching whether the compressed air is to be supplied to the on-off valve upper chamber 73b of the on-off valve cylinder 73.

In the controller 70, the first control valve 72 and the second control valve 71 are configured by independent members. In the controller 70, a separation portion 76 is formed separating the first control valve 72 moved to the standby position P100 and the second control valve 71 moved to the standby position P110. The separation portion 76 is configured by providing a space between an upper end of the coupling portion 72a, which is an upper end of the first control valve 72, and a lower end of the second control valve 71.

In the controller 70, in a state where the lower arm 80 is moved to the bottom dead center position, since the lower arm 80 does not come into contact with the tightening depth adjusting portion 86, the tightening depth adjusting portion 86 does not come into contact with the first control valve 72. In a state where the tightening depth adjusting portion 86 is not in contact with the first control valve 72, the first control valve 72 is biased by the first biasing member 72b and moves to the standby position P100, and the second control valve 71 is biased by the second biasing member 71a and moves to the standby position P110. Then, the first control valve 72 and the second control valve 71 are separated by the separation portion 76.

In the controller 70, when the lower arm 80 moves to the top dead center position, the first control valve 72 is pressed in the upward direction via the tightening depth adjusting portion 86 and moves from the standby position P100 to the pressure control start position. During a period until the first control valve 72 moves from the standby position P100 to the pressure control start position, the second control valve 71 standing by at the standby position P110 and the first control valve 72 moving to the pressure control start position are maintained in a state of being separated from each other by the separation portion 76. Accordingly, a configuration is provided such that the upper end of the first control valve 72 and the lower end of the second control valve 71 are not in contact with each other with a movement amount of the first control valve 72 due to movement of the lower arm 80 from the bottom dead center position to the top dead center position.

In the controller 70, by moving the first control valve 72 to the pressure control start position, the first control valve 72 is operated due to the compressed air supplied from the timer chamber 32, and when the first control valve 72 moves in the upward direction from the pressure control start position, the first control valve 72 is separated from the tightening depth adjusting portion 86. Further, when the first control valve 72 moves to a second control valve operation start position between the pressure control start position and the operation completion position in the process of moving from the pressure control start position to the operation completion position, the upper end of the first control valve 72 comes into contact with the lower end of the second control valve 71, and the second control valve 71 is pressed in the upward direction by the first control valve 72. In a state where the first control valve 72 has moved to the operation completion position and the second control valve 71 has moved to the operation completion position, the first control valve 72 and the second control valve 71 are not separated from each other.

The screw feeding portion 9 includes a feeding member 91 and a feed piston 92. The feeding member 91 is configured to feed the screw 200. The feed piston 92 is configured to cause the feeding member 91 to operate. The feeding member 91 is supported so as to be movable in a direction approaching and a direction separating from the nose portion 12. The feeding member 91 is configured to feed the screw 200 coupled by the coupling band 201 to the injection passage 12a of the nose portion 12 by locking with a claw portion (not illustrated).

The feed piston 92 is coupled to the feeding member 91 and is provided in a feed cylinder 93 so as to be slidable. The feed cylinder 93 is connected to the blowback chamber 33 via a feed flow path 94, and is supplied with compressed air from the blowback chamber 33.

The feed piston 92 is operated by an air pressure of the compressed air supplied from the blowback chamber 33 to cause the feeding member 91 to move in the direction separating from the nose portion 12. In addition, when the feeding member 91 is biased by the biasing member 95 such as a coil spring in the direction approaching the nose portion 12 and the air pressure in the feed cylinder 93 decreases, the feed piston 92 causes the feeding member 91 to move in the direction approaching the nose portion 12 by biasing of the biasing member 95.

The magazine 90 is provided on the lower side of the handle portion 11 and is coupled to the nose portion 12. In the magazine 90, a plurality of screws 200 are coupled by the coupling band 201, and a screw coupling body in a form of, for example, a spiral shape is accommodated.

The contact arm 8 is an example of a contact portion. The contact arm 8 includes the lower arm 80 that comes into contact with the driven member 300 and the upper arm 81 configured to cause a pressing member 87 that presses the contact lever 60a of the trigger 60 to operate. In addition, the contact arm 8 includes a roller 82 that transmits movement of the lower arm 80 to the upper arm 81. The contact arm 8 is configured to be movable in the downward direction indicated by the arrow D, which is the first direction, and the upward direction indicated by the arrow U, which is the second direction opposite to the first direction. The contact arm 8 is configured such that the lower arm 80 and the upper arm 81 are interlockingly movable along moving directions of the lower arm 80 indicated by the arrows U and D. In addition, the contact arm 8 is configured such that the interlocking between the lower arm 80 and the upper arm 81 is released, and the lower arm 80 is movable independently of the upper arm 81. The contact arm 8 can move from a first position to a second position via a third position, the first position being the bottom dead center position of the lower arm 80, the second position being the top dead center position of the lower arm 80, and the third position being a sign-in position serving as a starting point of an operation of causing the driver bit 2 to move in the axial direction to drive the screw 200.

The lower arm 80 is an example of a first arm, is supported by the nose portion 12 of the screw driving machine 1A so as to be movable in the up-down direction, and is biased in the downward direction by a biasing member 83a. The biasing member 83a is configured by a coil spring or the like.

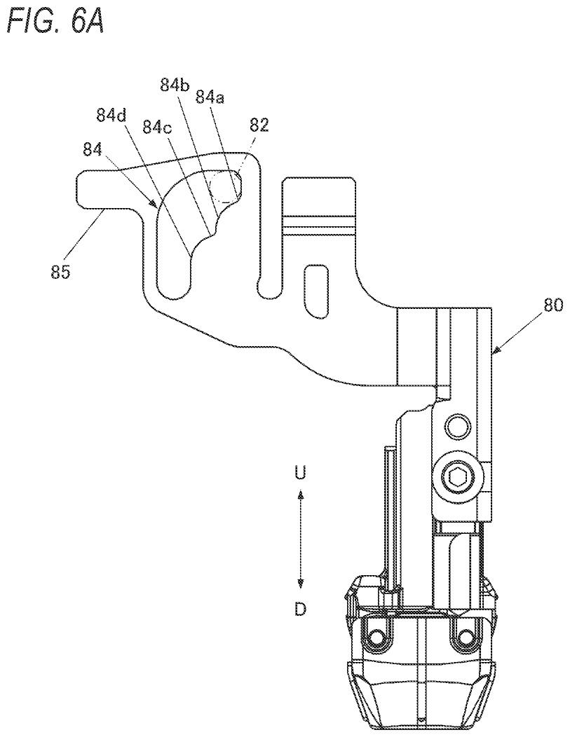

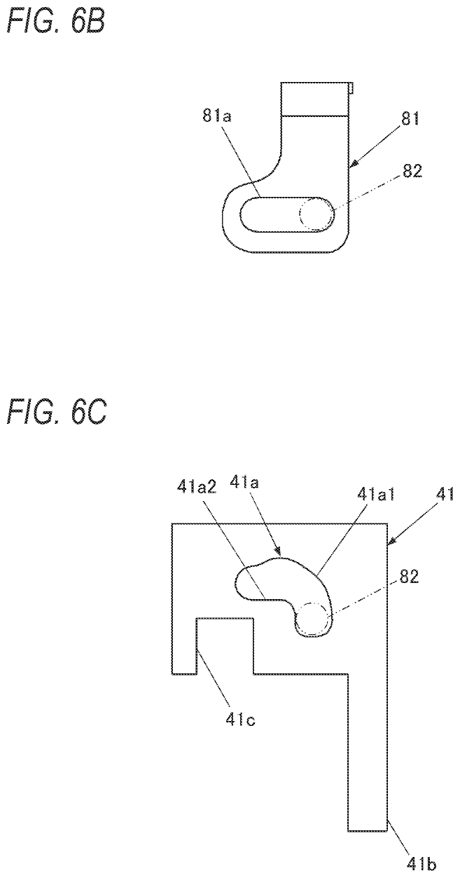

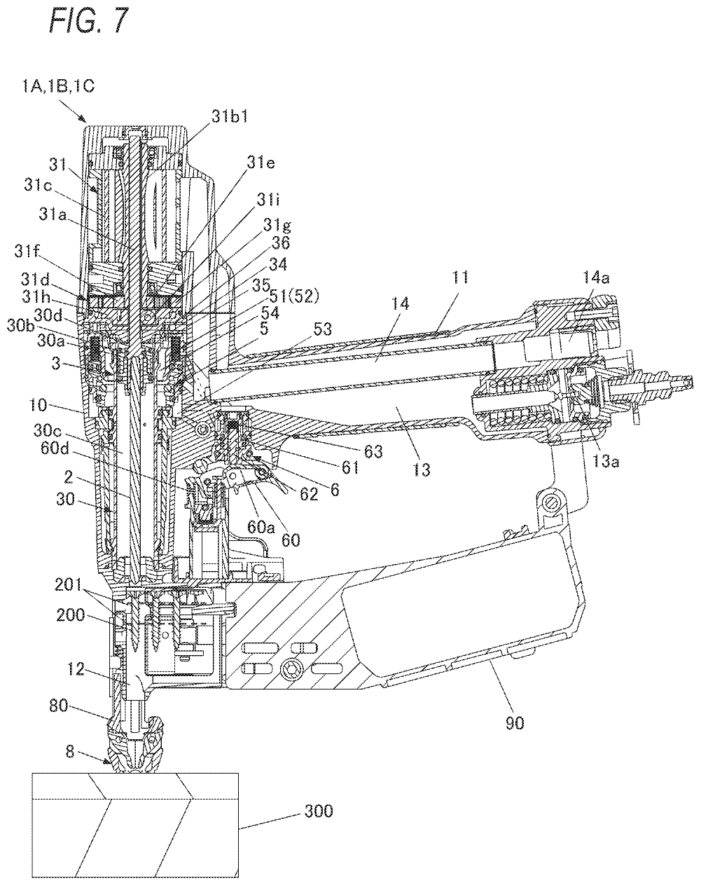

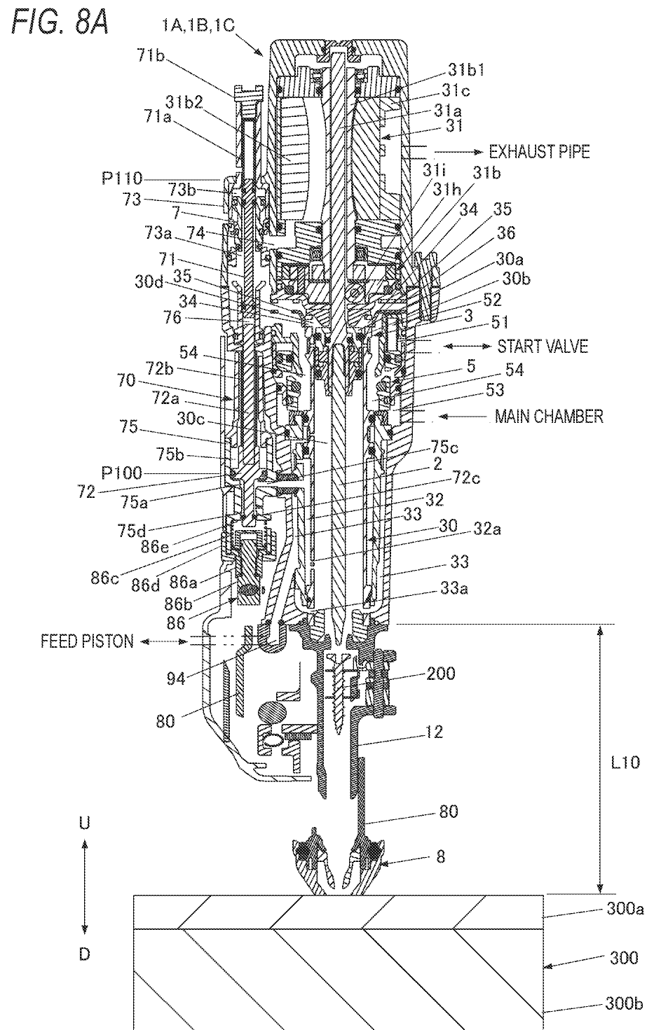

FIG. 6A is a side view illustrating an example of the lower arm. The lower arm 80 includes a cam groove 84. The cam groove 84 is configured to switch whether the lower arm 80 and the upper arm 81 are to be interlocked with each other and to switch relative positions of the lower arm 80 and the upper arm 81 along the moving direction of the lower arm 80. In addition, the lower arm 80 includes a bottom dead center position switching affected portion 85. The bottom dead center position switching affected portion 85 receives a force that causes the lower arm 80 to move in the upward direction by relative movement with respect to the main body portion 10 when the relative positions of the lower arm 80 and the upper arm 81 are switched.

The cam groove 84 includes a first engaging portion 84a and a first engagement releasing portion 84b. The first engaging portion 84a interlockingly engages the lower arm 80 and the upper arm 81 via the roller 82. The first engagement releasing portion 84b releases the interlocking engagement between the lower arm 80 and the upper arm 81 by the first engaging portion 84a via the roller 82, thereby allowing the lower arm 80 to move independently with respect to the upper arm 81. In addition, the cam groove 84 includes a second engaging portion 84c and a second engagement releasing portion 84d. The second engaging portion 84c interlockingly engages the lower arm 80 and the upper arm 81 via the roller 82. The second engagement releasing portion 84d releases the interlocking engagement between the lower arm 80 and the upper arm 81 by the second engaging portion 84c via the roller 82, thereby allowing the lower arm 80 to move independently with respect to the upper arm 81.

The first engaging portion 84a is a portion above the cam groove 84 extending in the up-down direction. The first engaging portion 84a is provided on a surface located on the lower side among surfaces of the cam groove 84 facing each other in the up-down direction. The first engaging portion 84a intersects the moving directions of the lower arm 80 indicated by the arrows U and D, and is formed by a surface capable of pressing the roller 82 in the upward direction indicated by the arrow U by an operation of moving the lower arm 80 in the arrow U direction. The first engagement releasing portion 84b is configured by a surface that extends from the first engaging portion 84a in an oblique downward direction and guides the roller 82 in a lateral direction intersecting the movement direction of the lower arm 80.

The second engaging portion 84c is a portion connected to a lower end of the first engagement releasing portion 84b in the cam groove 84. The second engaging portion 84c is provided on a surface located on the lower side among the surfaces of the cam groove 84 facing each other in the up-down direction. The second engaging portion 84c is configured by a surface that intersects the moving directions of the lower arm 80 indicated by the arrows U and D and presses the roller 82 in the upward direction indicated by the arrow U by the operation of moving the lower arm 80 in the arrow U direction. The second engagement releasing portion 84d is configured by a surface that extends from the second engaging portion 84c in an oblique downward direction and guides the roller 82 in the lateral direction intersecting the movement direction of the lower arm 80.

Accordingly, in the cam groove 84, the first engaging portion 84a, the first engagement releasing portion 84b, the second engaging portion 84c, and the second engagement releasing portion 84d are surfaces connected in a substantially crank shape, and when a position with which the roller 82 comes into contact is changed, the interlocking engagement between the lower arm 80 and the upper arm 81 via the roller 82 and releasing of the interlocking engagement between the lower arm 80 and the upper arm 81 are switched.

The upper arm 81 is an example of a second arm. The upper arm 81 is supported by a side portion of the main body portion 10 of the screw driving machine 1A so as to be movable in the up-down direction, and is biased in the downward direction by a biasing member 83b configured by a coil spring or the like.

FIG. 6B is a side view illustrating an example of the upper arm. The upper arm 81 has a guide groove 81a to which movement of the lower arm 80 is transmitted via the roller 82. A length of the guide groove 81a in a short direction is slightly longer than a diameter of the roller 82, and a longitudinal direction of the guide groove 81a extends in a direction intersecting the moving direction of the upper arm 81 and the moving direction of the lower arm 80 illustrated in FIG. 6B and the like.

The roller 82 is an example of a transmission member. The roller 82 is inserted into the cam groove 84 of the lower arm 80 and the guide groove 81a of the upper arm 81. The roller 82 is formed to have a cylindrical shape rotatable along the cam groove 84 and the guide groove 81a. The roller 82 is biased by a biasing member 82a such as a torsion coil spring in a direction in which the roller 82 is pressed against the first engaging portion 84a, the first engagement releasing portion 84b, the second engaging portion 84c, and the second engagement releasing portion 84d.

The first engaging portion 84a is a surface in the direction intersecting the moving direction of the lower arm 80. Therefore, when the lower arm 80 moves in the upward direction due to the relative movement with respect to the main body portion 10 in a state where the roller 82 is located at a position facing the first engaging portion 84a, the cam groove 84 provided in the lower arm 80 moves in the upward direction, and the first engaging portion 84a comes into contact with the roller 82 from the lower side and presses the roller 82 in the upward direction. In addition, the roller 82 pressed in the upward direction by the first engaging portion 84a of the cam groove 84 presses a surface on the upper side of the guide groove 81a in the upward direction. Accordingly, in a state where the roller 82 is in contact with the first engaging portion 84a, the movement of the lower arm 80 is in a state of being able to be transmitted to the upper arm 81 via the first engaging portion 84a and the roller 82, and the first engaging portion 84a interlockingly engages the lower arm 80 and the upper arm 81 via the roller 82.

On the other hand, the first engagement releasing portion 84b extends from the first engaging portion 84a in the oblique downward direction. Therefore, when the lower arm 80 moves in the upward direction due to the relative movement with respect to the main body portion 10 in a state where the roller 82 is at a position facing the first engagement releasing portion 84b, a force is generated for the first engagement releasing portion 84b to press the roller 82 in the lateral direction. Thus, the first engagement releasing portion 84b guides the roller 82 along the guide groove 81a of the upper arm 81 in the direction intersecting the moving direction of the lower arm 80. Accordingly, in a state where the roller 82 is in contact with the first engagement releasing portion 84b, the movement of the lower arm 80 is in a non-transmission state of not being transmitted to the upper arm 81 via the first engagement releasing portion 84b and the roller 82, and the first engagement releasing portion 84b releases the interlocking engagement between the lower arm 80 and the upper arm 81 via the roller 82.

Similarly, the second engaging portion 84c is a surface in the direction intersecting the moving direction of the lower arm 80. Therefore, when the lower arm 80 moves in the upward direction due to the relative movement with respect to the main body portion 10 in a state where the roller 82 is located at a position facing the second engaging portion 84c, the cam groove 84 provided in the lower arm 80 moves in the upward direction, and the second engaging portion 84c comes into contact with the roller 82 from the lower side and presses the roller 82 in the upward direction. In addition, the roller 82 pressed in the upward direction by the second engaging portion 84c of the cam groove 84 presses the surface on the upper side of the guide groove 81a in the upward direction. Accordingly, in a state where the roller 82 is in contact with the second engaging portion 84c, the movement of the lower arm 80 is in a state of being able to be transmitted to the upper arm 81 via the second engaging portion 84c and the roller 82, and the second engaging portion 84c interlockingly engages the lower arm 80 and the upper arm 81 via the roller 82.

On the other hand, the second engagement releasing portion 84d extends from the second engaging portion 84c in the oblique downward direction. Therefore, when the lower arm 80 moves in the upward direction due to the relative movement with respect to the main body portion 10 in a state where the roller 82 is at a position facing the second engagement releasing portion 84d, a force is generated for the second engagement releasing portion 84d to press the roller 82 in the lateral direction. Thus, the second engagement releasing portion 84d guides the roller 82 along the guide groove 81a of the upper arm 81 in the direction intersecting the moving direction of the lower arm 80. Accordingly, in a state where the roller 82 is in contact with the second engagement releasing portion 84d, the movement of the lower arm 80 is in a non-transmission state of not being transmitted to the upper arm 81 via the second engagement releasing portion 84d and the roller 82, and the second engagement releasing portion 84d releases the interlocking engagement between the lower arm 80 and the upper arm 81 via the roller 82.

The lower arm 80 moves in the upward direction due to the relative movement with respect to the main body portion 10 by an operation of pressing the contact arm 8 against the driven member 300. In a state where the upper arm 81 is interlockingly engaged with the lower arm 80 via the roller 82, when the lower arm 80 moves in the upward direction due to the relative movement with respect to the main body portion 10, the surface on the upper side of the guide groove 81a is pressed by the roller 82, so that the upper arm 81 moves in the upward direction interlockingly with the lower arm 80. In addition, the upper arm 81 moved in the upward direction interlockingly with the lower arm 80 is biased in the downward direction by the biasing member 83b, so that the surface on the upper side of the guide groove 81a comes into contact with the roller 82 and presses the roller 82 in the downward direction. However, in a state where the lower arm 80 is pressed against the driven member 300 and the lower arm 80 is in a state of not moving in the downward direction due to the relative movement with respect to the main body portion 10, the upper arm 81 is regulated from moving downward independently of the lower arm 80. Further, in a state where the interlocking engagement between the upper arm 81 and the lower arm 80 via the roller 82 is released, even when the lower arm 80 moves in the upward direction due to the relative movement with respect to the main body portion 10, the movement of the lower arm 80 is not transmitted via the roller 82 and the upper arm 81 does not move in the upward direction.

In the screw driving machine 1A, the lower arm 80 moves in the upward direction from the bottom dead center position due to the relative movement with respect to the main body portion 10 by the operation of pressing the contact arm 8 against the driven member 300, and at the same time, the upper arm 81 moves in the upward direction interlockingly with the lower arm 80 within a predetermined range in which the lower arm 80 moves in the upward direction from the bottom dead center position. In the screw driving machine 1A, when the lower arm 80 moves in the upward direction from the bottom dead center position, the main body portion 10 and the driven member 300 relatively approach each other. In addition, in the screw driving machine 1A, at the time of driving when the screw 200 is driven into the driven member 300, the driving depth regulating portion 4a regulates, between the sign-in position and the top dead center position, the movement amount of the lower arm 80 from the bottom dead center position. The sign-in position is a third position and is between the top dead center position and a position to which the lower arm 80 moved in the upward direction by a predetermined amount from the bottom dead center position. In addition, when the lower arm 80 is located between the sign-in position and the top dead center position, sign-in is possible. In the screw driving machine 1A, by allowing the driving depth switching portion 4b to operate switching of whether to regulate the movement amount of the lower arm 80 from the bottom dead center position by the driving depth regulating portion 4a, the driving depth of the screw 200 with respect to the driven member 300 is switched.

In the screw driving machine 1A, by enabling the bottom dead center position of the lower arm 80 to be switched, the movement amount of the contact arm 8 is reduced when the driving depth of the screw 200 is increased.

Therefore, the driving depth regulating portion 4a includes a locking member 40 that regulates a movement amount of the lower arm 80 from a first bottom dead center position P1 illustrated in FIG. 2A. In addition, the driving depth switching portion 4b includes a switching member 41 configured to switch whether the movement amount of the lower arm 80 is to be regulated by the locking member 40. The switching member 41 also has a function of guiding a movement path of the roller 82 which moves together with the lower arm 80 and the upper arm 81, and switching whether the lower arm 80 and the upper arm 81 are to be interlocked with each other. Further, the driving depth switching portion 4b includes a switching operation member 42 configured to cause the switching member 41 to operate and to switch the bottom dead center position of the lower arm 80 to the first bottom dead center position P1 illustrated in FIG. 2A or a second bottom dead center position P2 illustrated in FIG. 2B.

The locking member 40 is rotatably supported by the feeding member 91 of the screw 200 with a shaft 40a as a fulcrum. In the locking member 40, a locking portion 40b to be locked to the lower arm 80 is formed on one of end portions with the shaft 40a interposed therebetween. In addition, in the locking member 40, an affected portion 40c that receives a force for causing the locking member 40 to rotate by the switching member 41 is formed on the other of the end portions with the shaft 40a interposed therebetween. The locking member 40 is biased by a biasing member 40d configured by a coil spring or the like in a direction in which the locking portion 40b protrudes to the movement path of the lower arm 80 by a rotating operation with the shaft 40a as a fulcrum.

In a state where the locking member 40 is biased by the biasing member 40d in the direction in which the locking portion 40b protrudes to the movement path of the lower arm 80, the locking member 40 moves, due to the movement of the feeding member 91, between a locking position illustrated in FIG. 3A and the like at which the locking portion 40b protrudes to the movement path of the lower arm 80 and a second retracted position to which the locking portion 40b is retracted from the movement path of the lower arm 80.

In addition, in a state where the locking portion 40b is movable to the locking position due to the movement of the feeding member 91, the locking member 40 moves between the locking position and a first retracted position illustrated in FIG. 3B and the like to which the locking portion 40b is retracted from the movement path of the lower arm 80 by the rotating operation with the shaft 40a as a fulcrum.

The switching member 41 is supported on a side portion of the nose portion 12 of the screw driving machine 1A so as to be movable in an arrow L direction or an arrow R direction intersecting with the up-down direction.

FIG. 6C is a side view illustrating an example of the switching member. The switching member 41 has a guide groove 41a that guides and causes the roller 82 to move to a predetermined position. In addition, the switching member 41 includes an actuation portion 41b that causes the locking member 40 to operate. Further, the switching member 41 includes an affected portion 41c that receives a force for causing the switching member 41 to move in the arrow L direction or the arrow R direction intersecting the up-down direction.

The guide groove 41a has a first guide groove 41a1. The first guide groove 41a1 guides the roller 82 engaged with the first engaging portion 84a of the cam groove 84 from the first engaging portion 84a to the first engagement releasing portion 84b and guides the roller 82 engaged with the second engaging portion 84c of the cam groove 84 from the second engaging portion 84c to the second engagement releasing portion 84d.

The first guide groove 41a1 extends in an oblique upward direction. The first guide groove 41a1 causes the roller 82, which moves in the arrow U direction following the lower arm 80, to move in the arrow L direction from the first engaging portion 84a toward the first engagement releasing portion 84b by an operation of moving the lower arm 80 in the upward direction due to the relative movement with respect to the main body portion 10. In addition, in a case where the roller 82 is engaged with the second engaging portion 84c of the cam groove 84, the first guide groove 41a1 guides the roller 82 from the second engaging portion 84c to the second engagement releasing portion 84d.

In addition, the guide groove 41a has a second guide groove 41a2 that regulates movement of the roller 82 in the downward direction.

The second guide groove 41a2 is a portion extending from the first guide groove 41a1 in the lateral direction intersecting the up-down direction, and is configured by a surface located on the lower side among surfaces facing each other in the up-down direction. When the roller 82 is guided from the first engaging portion 84a to the first engagement releasing portion 84b by the operation of moving the lower arm 80 in the upward direction due to the relative movement with respect to the main body portion 10, the second guide groove 41a2 comes into contact with the roller 82 from the lower side and regulates the movement of the roller 82 in the downward direction indicated by the arrow D. Accordingly, while the roller 82 is located in the second guide groove 41a2, a position of the upper arm 81 in the up-down direction is maintained. Thus, the lower arm 80 moves to an operation possible position interlockingly with the operation of being moved in the upward direction, and the upper arm 81 biased in the downward direction by the biasing member 83b is held at the operation possible position.

The switching operation member 42 is an example of a switching operation portion. The switching operation member 42 includes, as illustrated in FIGS. 2A, 2B, 3A, 3B, and the like, an action portion 42a that causes the lower arm 80 to move interlockingly with the switching member 41, and an operation portion 42b that receives an operation of a person.

The action portion 42a includes a first cam surface 42a1. The first cam surface 42a1 is in contact with the bottom dead center position switching affected portion 85 of the lower arm 80 and causes the lower arm 80 to move in the upward direction. In addition, the action portion 42a includes a second cam surface 42a2. The second cam surface 42a2 is in contact with the affected portion 41c of the switching member 41 and causes the switching member 41 to move in the direction indicated by the arrow L or the arrow R. In the action portion 42a, the first cam surface 42a1 and the second cam surface 42a2 are displaced by a rotating operation with a shaft 42c as a fulcrum.

The operation portion 42b is coupled to the shaft 42c and causes the action portion 42a to rotate with the shaft 42c as a fulcrum. When the operation portion 42b is operated and the action portion 42a is caused to rotate with the shaft 42c as a fulcrum, the switching operation member 42 causes the switching member 41 to move in the direction indicated by the arrow L or the arrow R. In addition, the lower arm 80 is caused to move in the up-down direction.

The roller 82 is guided by the guide groove 41a of the switching member 41 by the operation of moving the lower arm 80 in the up-down direction, and thus the roller 82 engaged with the first engaging portion 84a of the cam groove 84 is guided from the first engaging portion 84a to the first engagement releasing portion 84b. In addition, in the case where the roller 82 is engaged with the second engaging portion 84c of the cam groove 84, the roller 82 is guided from the second engaging portion 84c to the second engagement releasing portion 84d. Accordingly, the lower arm 80 moves in the up-down direction independently of the upper arm 81 by the operation of the operation portion 42b.

The screw driving machine 1A includes the tightening depth adjusting portion 86 configured to adjust a tightening depth of the screw 200 by defining an upper fulcrum position of the lower arm 80 and causes the first control valve 72 to operate when the lower arm 80 moves to the upper fulcrum position.

The tightening depth adjusting portion 86 is an example of a tightening depth switching portion. The tightening depth adjusting portion 86 includes an adjusting portion main body 86a and an abutting portion 86b whose protrusion height with respect to the adjusting portion main body 86a is adjustable. The tightening depth adjusting portion 86 is supported so as to be movable along the moving direction of the lower arm 80 indicated by the arrows U and D, and is biased in the downward direction indicated by the arrow U by a biasing member 86c such as a coil spring.

The tightening depth adjusting portion 86 has a configuration in which the adjusting portion main body 86a and an abutting portion 86b are joined by, for example, screwing a male screw and a female screw. In the tightening depth adjusting portion 86, a dial portion 86d for causing the adjusting portion main body 86a to rotate is exposed to the outside of the main body portion 10. The adjusting portion main body 86a is caused to rotate by an operation of the dial portion 86d, whereby a protrusion amount of the abutting portion 86b with respect to the adjusting portion main body 86a is switched, and an entire length of the tightening depth adjusting portion 86 is changed.

In the tightening depth adjusting portion 86, the abutting portion 86b faces the lower arm 80. In the tightening depth adjusting portion 86, in a state where the lower arm 80 moves to the bottom dead center position, the abutting portion 86b and the lower arm 80 are separated from each other. In the tightening depth adjusting portion 86, when the lower arm 80 moves in the upward direction from the bottom dead center position, the lower arm 80 comes into contact with the abutting portion 86b.

In addition, in the tightening depth adjusting portion 86, the adjusting portion main body 86a faces the first control valve 72. In a state before the tightening depth adjusting portion 86 is pressed by the lower arm 80 and moved, the adjusting portion main body 86a and the first control valve 72 are separated from each other. In the tightening depth adjusting portion 86, when the lower arm 80 moves in the upward direction from the bottom dead center position as indicated by the arrow U, the lower arm 80 comes into contact with the abutting portion 86b, and when the tightening depth adjusting portion 86 is pressed by the lower arm 80 and moved in the upward direction, the adjusting portion main body 86a comes into contact with the first control valve 72.

When the tightening depth adjusting portion 86 is pressed up by the lower arm 80 moving in the arrow U direction and moves to a position where the adjusting portion main body 86a comes into contact with a movement regulating portion 86e, the tightening depth adjusting portion 86 regulates the lower arm 80 from further moving in the upward direction.

Accordingly, the position of the lower arm 80 regulated by the movement of the tightening depth adjusting portion 86 to the position in contact with the movement regulating portion 86e becomes the upper fulcrum position of the lower arm 80.

In the tightening depth adjusting portion 86, the protrusion amount of the abutting portion 86b with respect to the adjusting portion main body 86a is switched by the operation of the dial portion 86d, and the entire length of the tightening depth adjusting portion 86 is changed. When the entire length of the tightening depth adjusting portion 86 changes, the top dead center position of the lower arm 80 moves. When the top dead center position of the lower arm 80 moves, a protrusion amount of the driver bit 2 with respect to a lower end surface of the lower arm 80 changes, the driver bit 2 being moved to the bottom dead center position with respect to the lower end surface of the lower arm 80, and the tightening depth of the screw 200 with respect to the driven member 300 changes.

In the screw driving machine 1A, the tightening depth adjusting portion 86 may not be provided, the lower arm 80 may directly contact the first control valve 72 to cause the first control valve 72 to operate, and the upper fulcrum position of the lower arm 80 may be defined.

### Example of Operation of Switching Driving Depth of Screw

By operating the switching operation member 42, the screw driving machine 1A is switched between a first mode and a second mode. In the first mode, the driving depth of the screw 200 is set to a first driving depth. In the second mode, the driving depth of the screw 200 is set to be deeper than the first driving depth. The switching between the first mode and the second mode is performed at a timing when driving and tightening operations of the screw 200 are not performed, such as after the driving and tightening operations of the screw 200 are finished and before next driving and tightening operations of the screw 200 are started.

In the first mode, the bottom dead center position of the lower arm 80 is set to the first bottom dead center position P1 illustrated in FIG. 2A, and in a state where the movement amount of the lower arm 80 from the first bottom dead center position P1 is regulated, after the screw 200 is driven into the driven member 300, the regulation of the movement amount of the lower arm 80 is released, and the screw 200 is tightened.

Therefore, in the first mode, the bottom dead center position of the lower arm 80 is lowered to the first bottom dead center position P1. In addition, the locking member 40 moves to the locking position where the locking portion 40b of the locking member 40 protrudes to the movement path of the lower arm 80.

Therefore, in the first mode, the action portion 42a rotates counterclockwise as indicated by an arrow C1 by the operation of the operation portion 42b. In a state where the action portion 42a rotates counterclockwise as indicated by the arrow C1, the first cam surface 42a1 is separated from the bottom dead center position switching affected portion 85 of the lower arm 80. Accordingly, the lower arm 80 is biased in the downward direction by the biasing member 83a and stands by in a state of being moved to the first bottom dead center position P1 as illustrated in FIG. 2A.

In the state where the action portion 42a rotates counterclockwise as indicated by the arrow C1, the second cam surface 42a2 presses the affected portion 41c of the switching member 41 in the arrow R direction. Accordingly, the switching member 41 moves in the arrow R direction.

In a state where the lower arm 80 stands by at the first bottom dead center position P1 and the switching member 41 moves in the arrow R direction, the roller 82 is guided to a predetermined position by the first guide groove 41a1 of the guide groove 41a of the switching member 41. Accordingly, the roller 82 is engaged with the first engaging portion 84a of the cam groove 84.

In a state where the switching member 41 moves in the arrow R direction, the actuation portion 41b moves in a direction separating from the affected portion 40c of the locking member 40. Accordingly, the locking member 40 is biased by the biasing member 40d in the direction in which the locking portion 40b protrudes to the movement path of the lower arm 80 by the rotating operation with the shaft 40a as a fulcrum, and thus, as illustrated in FIG. 3A, the locking member 40 moves to the locking position at which the locking portion 40b protrudes to the movement path of the lower arm 80.

In the second mode, the bottom dead center position of the lower arm 80 is set to the second bottom dead center position P2 illustrated in FIG. 2B, and in a state where the regulation of the movement amount of the lower arm 80 from the second bottom dead center position P2 is released, the screw 200 is driven into the driven member 300, and then the screw 200 is tightened.

Therefore, to switch from the first mode to the second mode, the bottom dead center position of the lower arm 80 is raised to the second bottom dead center position P2, and the locking portion 40b of the locking member 40 is caused to move to the retracted position to which the locking portion 40b is retracted from the movement path of the lower arm 80.

Therefore, in the second mode, the action portion 42a is caused to rotate clockwise as indicated by an arrow C2 by the operation of the operation portion 42b. When the action portion 42a rotates clockwise as indicated by the arrow C2, the first cam surface 42a1 comes into contact with the bottom dead center position switching affected portion 85 of the lower arm 80 and presses up the bottom dead center position switching affected portion 85. Accordingly, the lower arm 80 moves in the upward direction and moves to the second bottom dead center position P2 as illustrated in FIG. 2B.

In addition, when the action portion 42a rotates clockwise as indicated by the arrow C2, the second cam surface 42a2 presses the affected portion 41c of the switching member 41 in the arrow L direction. Accordingly, the switching member 41 moves in the arrow L direction.

When the lower arm 80 moves from the first bottom dead center position P1 to the second bottom dead center position P2 and the switching member 41 moves in the arrow L direction, the roller 82 is guided by the guide groove 41a of the switching member 41. Accordingly, the roller 82 is guided from the first engaging portion 84a to the first engagement releasing portion 84b of the cam groove 84, guided from the first engagement releasing portion 84b to the second engaging portion 84c, and engages with the second engaging portion 84c. When the roller 82 is guided to a position in contact with the first engagement releasing portion 84b while the lower arm 80 moves from the first bottom dead center position P1 to the second bottom dead center position P2, a force with which the first engagement releasing portion 84b presses the roller 82 in the lateral direction becomes larger than a force with which the first engagement releasing portion 84b presses the roller 82 in the upward direction by the operation of moving the lower arm 80 in the upward direction. Therefore, the roller 82 moves in the lateral direction along the guide groove 81a of the upper arm 81. Accordingly, even when the lower arm 80 moves from the first bottom dead center position P1 to the second bottom dead center position P2, the position of the upper arm 81 is maintained.

When the switching member 41 moves in the arrow L direction, the actuation portion 41b presses the affected portion 40c of the locking member 40. Accordingly, by the rotating operation with the shaft 40a as a fulcrum, the locking member 40 moves to the first retracted position to which the locking portion 40b is retracted from the movement path of the lower arm 80, as illustrated in FIG. 3B.

### Operation Example of Screw Driving Machine

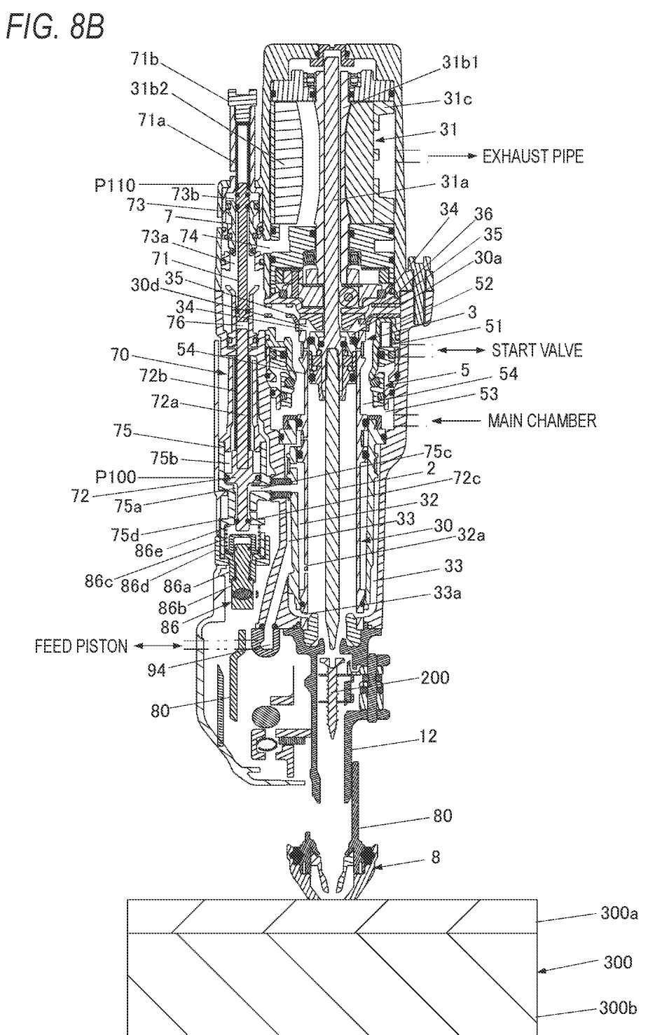

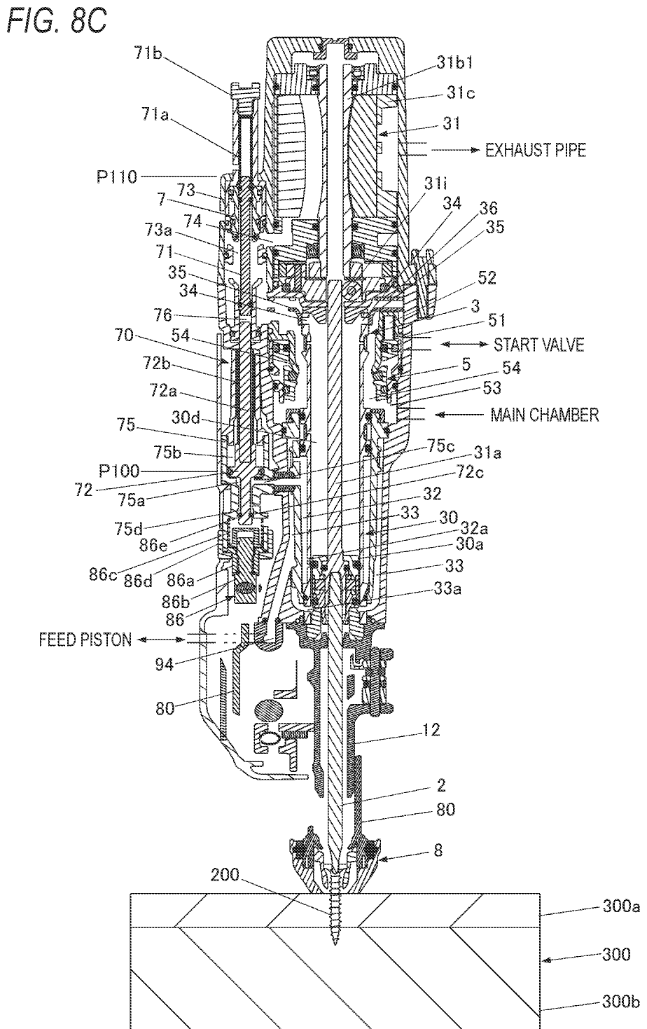

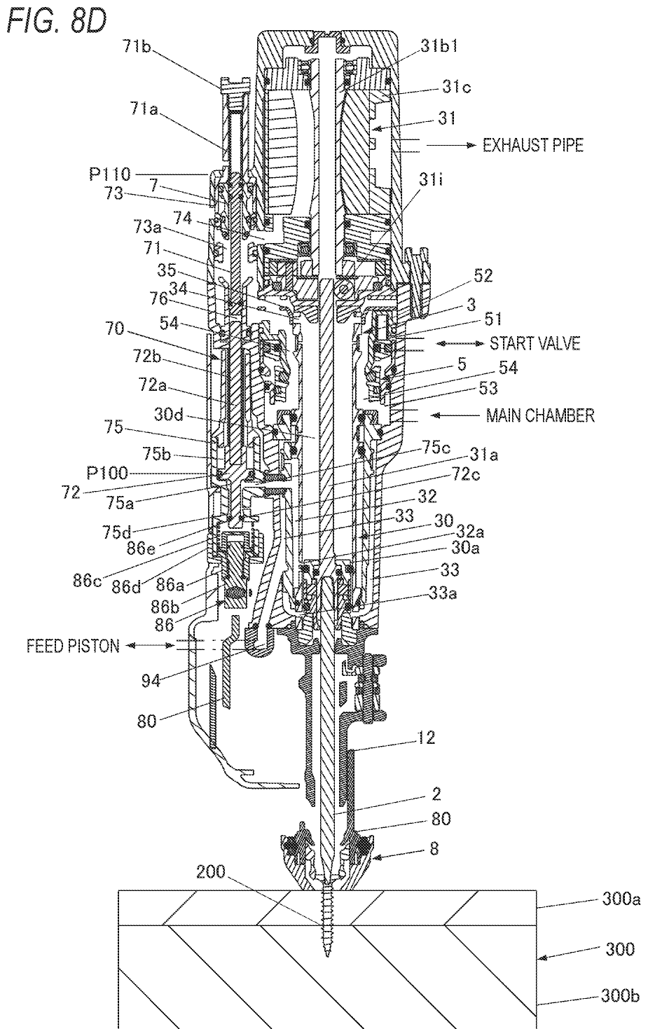

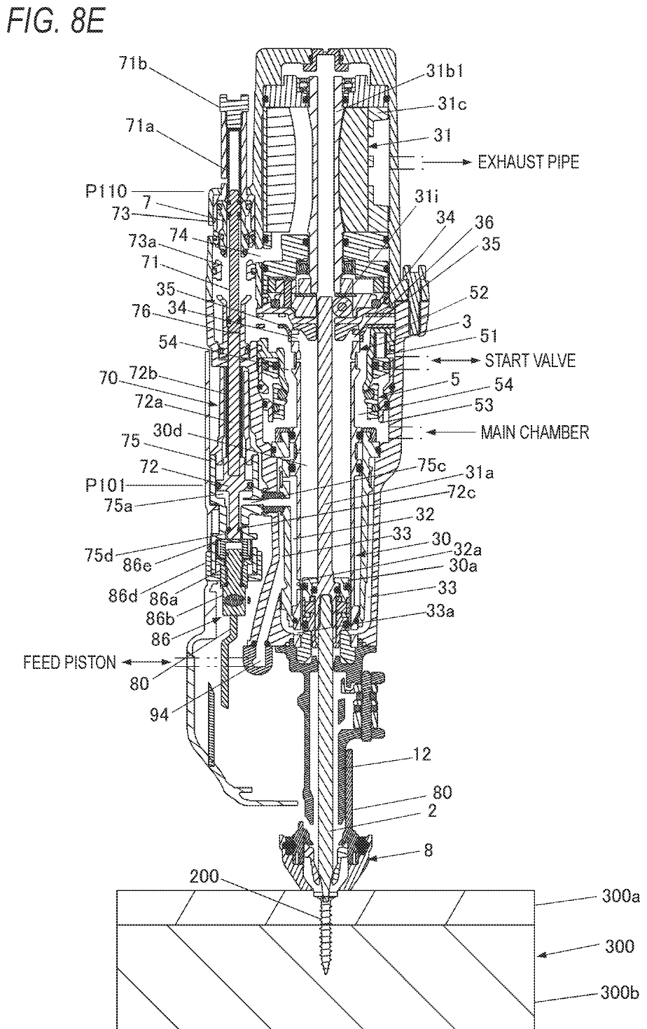

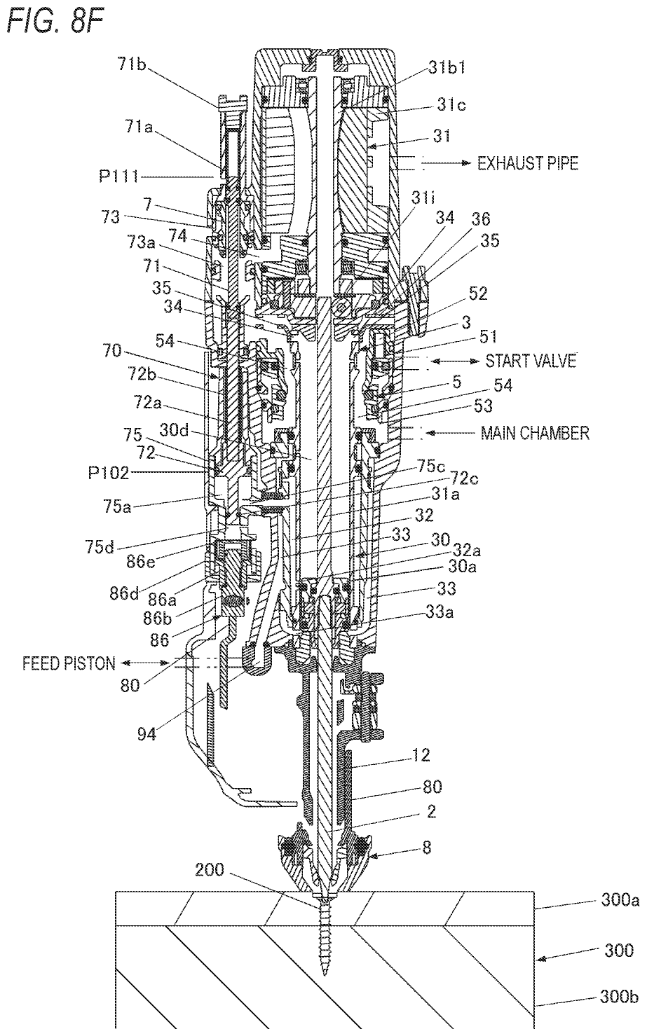

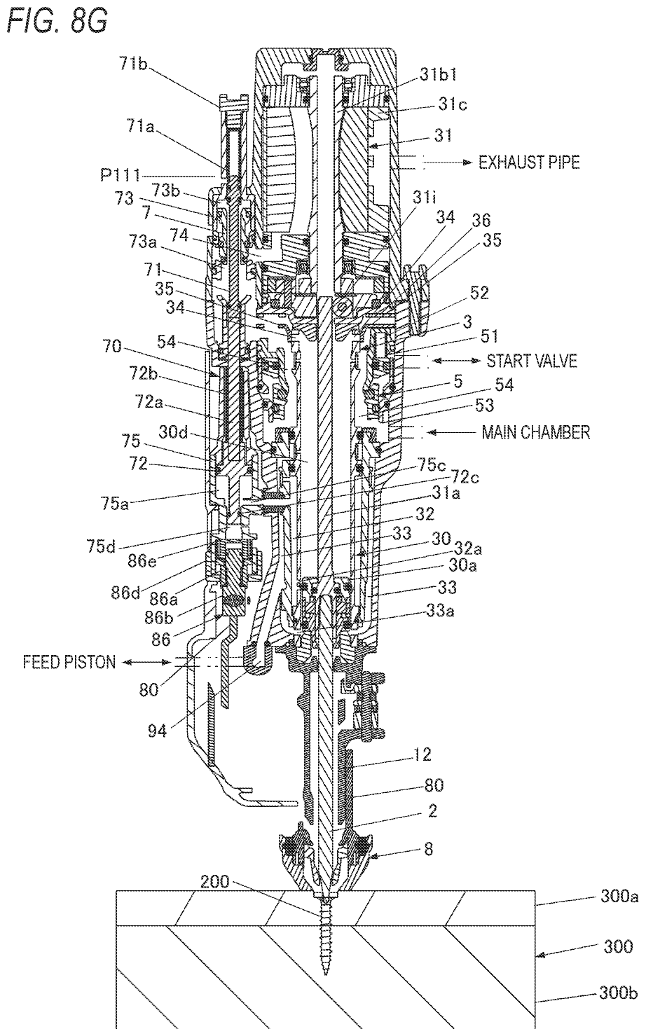

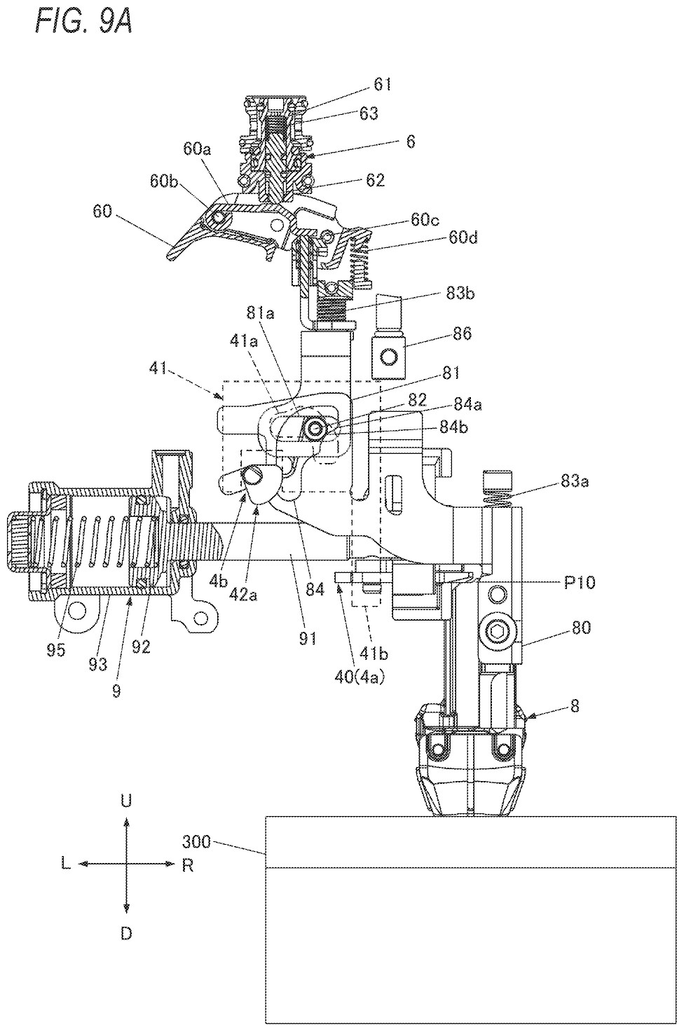

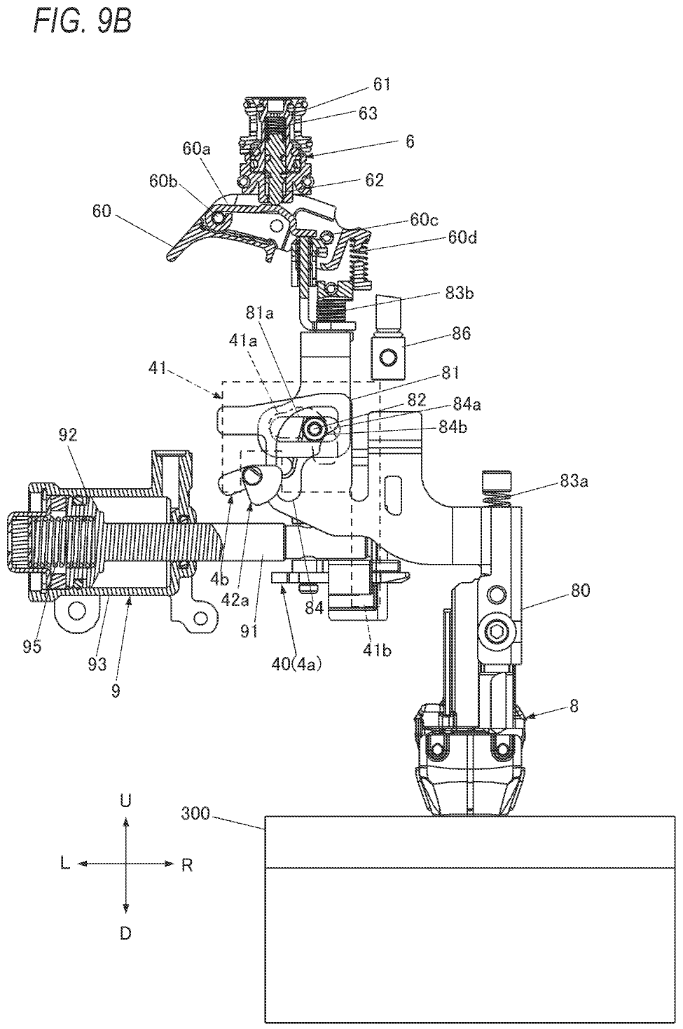

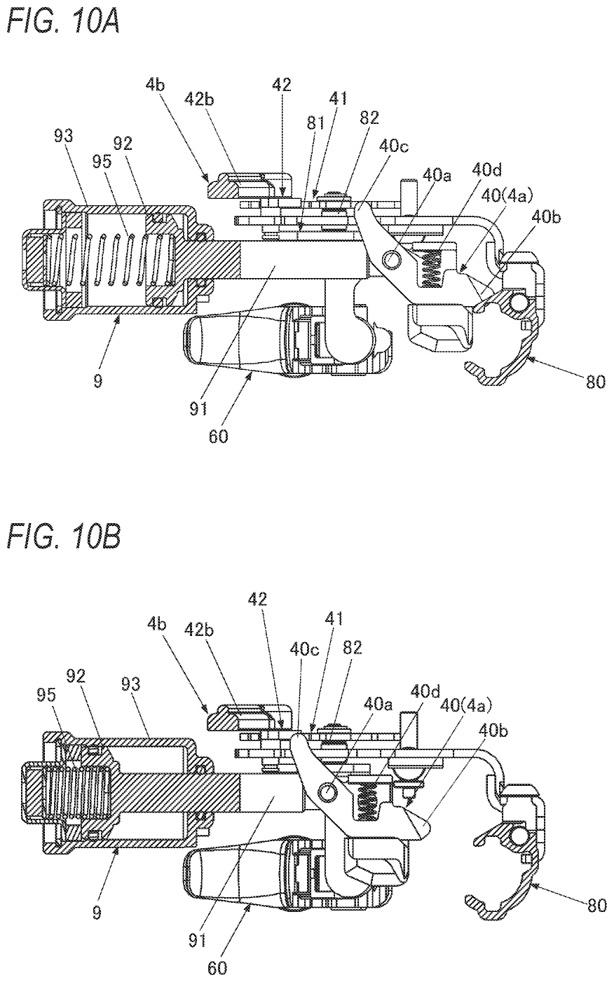

FIG. 7 is a side sectional view of the screw driving machine illustrating an example of an operation of driving a screw into a driven member and tightening the screw, and FIGS. 8A, 8B, 8C, 8D, 8E, 8F, and 8G are front sectional views of the screw driving machine illustrating an example of an operation of driving the screw into the driven member and tightening the screw. In addition, FIGS. 9A and 9B are side sectional views of main parts of the screw driving machine according to the present illustrative embodiment illustrating an example of an operation of driving the screw into the driven member and tightening the screw in the first mode, and FIGS. 10A and 10B are bottom sectional views of the main parts of the screw driving machine according to the present illustrative embodiment illustrating an example of the operation of driving the screw into the driven member and tightening the screw in the first mode.

Next, an example of an operation of the screw driving machine 1A in which the first mode is selected and the driving and tightening of the screw 200 are performed will be described.

In the screw driving machine 1A, in a case where the above-described first mode is selected, as illustrated in FIG. 2A, the lower arm 80 moves to the first bottom dead center position P1. In addition, as illustrated in FIG. 3A, the locking member 40 moves to the locking position where the locking portion 40b protrudes to the movement path of the lower arm 80. The first bottom dead center position P1 of the lower arm 80 is also referred to as the first position.

In a state where the first mode is selected as described above, the operator holds the handle portion 11 of the screw driving machine 1A and presses the contact arm 8 against the driven member 300. In the screw driving machine 1A, when the contact arm 8 is pressed against the driven member 300, the lower arm 80 moves in the upward direction due to the relative movement with respect to the main body portion 10.

When the lower arm 80 moves in the upward direction from the first bottom dead center position P1 due to the relative movement with respect to the main body portion 10, the roller 82 is engaged with the first engaging portion 84a of the cam groove 84, and the lower arm 80 and the upper arm 81 are interlockingly engaged via the roller 82, so that the upper arm 81 moves in the upward direction interlockingly with the lower arm 80.

As illustrated in FIG. 9A, when the lower arm 80 moves to a first driving depth defining position P10 where the lower arm 80 comes into contact with the locking portion 40b of the locking member 40, as illustrated in FIG. 8A, a distance between the driven member 300 and the main body portion 10 is maintained at a predetermined distance L10 such that the driving depth of the screw 200 becomes the first driving depth. In this example, the first driving depth defining position P10 of the lower arm 80 is the same as the third position, but the first driving depth defining position P10 and the third position may be different positions. The third position may be set at the same position as the first driving depth defining position P10, or above the bottom dead center position of the lower arm 80 and below the first driving depth defining position P10. In addition, the upper arm 81 moves to the operation possible position where the contact lever 60a of the trigger 60 is caused to operate. Accordingly, in a state where the contact arm 8 is pressed against the driven member 300 until the lower arm 80 moves to the first driving depth defining position P10, when the operation of pulling the trigger 60 is performed, as illustrated in FIGS. 7A and 9A, the contact lever 60a presses the valve stem 62 of the start valve 6, and the start valve 6 is operated. In this manner, a state where the valve stem 62 is pressed by the contact lever 60a by operating the trigger 60 in the state where the contact arm 8 is pressed against the driven member 300 until the lower arm 80 moves to the first driving depth defining position P10 is referred to as sign-in in the first mode.

When the start valve 6 is operated in the state of sign-in in the first mode, the main valve 5 is operated as illustrated in FIG. 8B, and the compressed air is supplied to the driving cylinder 30 and the on-off valve 7. When the compressed air is supplied to the driving cylinder 30, the driving piston 30a to which the driver bit 2 is attached is pressed by the air pressure, and as illustrated in FIG. 8C, the driver bit 2 (driving piston 30a) moves in the downward direction from the top dead center position to the bottom dead center position, and the screw 200 is driven into the driven member 300. When the driver bit 2 (driving piston 30a) moves in the downward direction from the top dead center position, air on the lower side of the driving piston 30a is supplied to the blowback chamber 33, and pressure in the blowback chamber 33 increases.

When the driver bit 2 (driving piston 30a) moves to the bottom dead center position, the compressed air in the blowback chamber 33 is supplied from the feed flow path 94 of the screw feeding portion 9 to the feed piston 92. Accordingly, as illustrated in FIGS. 9B and 10B, the feeding member 91 coupled to the feed piston 92 moves in the arrow L direction.

When the feeding member 91 moves in the arrow L direction, the locking member 40 attached to the feeding member 91 moves in the arrow L direction. Accordingly, the locking member moves to the second retracted position to which the locking portion 40b is retracted from the movement path of the lower arm 80. When the locking member 40 moves to the second retracted position, by the operation of pressing the contact arm 8 against the driven member 300, the lower arm 80 can move in the upward direction beyond the first driving depth defining position P10 due to the relative movement with respect to the main body portion 10.

When the main valve 5 is operated and the compressed air is supplied to the on-off valve lower chamber 73a of the on-off valve cylinder 73 which is a space on the lower side of the on-off valve 7, as illustrated in FIG. 8C, the on-off valve 7 is operated by the air pressure, and the compressed air is supplied to the air motor 31.

When the compressed air is supplied to the air motor 31, the driver bit 2 rotates, and as illustrated in FIG. 8D, the screw 200 driven into the driven member 300 is tightened. In addition, by the operation of pressing the contact arm 8 against the driven member 300, the main body portion 10 further moves in the downward direction following the tightening of the screw 200.

When the lower arm 80 moves in the upward direction beyond the first driving depth defining position P10 by the relative movement of the main body portion 10 and the lower arm 80, the roller 82 is guided by the guide groove 41a of the switching member 41, and thus the roller 82 engaged with the first engaging portion 84a of the cam groove 84 is guided from the first engaging portion 84a to the first engagement releasing portion 84b by the first guide groove 41a1 of the guide groove 41a. When the roller 82 is guided to the first engagement releasing portion 84b, the interlocking engagement between the lower arm 80 and the upper arm 81 via the roller 82 is released.

By the operation of moving the lower arm 80 in the upward direction, the roller 82 guided from the first engaging portion 84a to the first engagement releasing portion 84b of the cam groove 84 is guided from the first guide groove 41a1 to the second guide groove 41a2 of the guide groove 41a. Accordingly, while the upper arm 81 moves to the operation possible position and the roller 82 is located in the second guide groove 41a2, the position of the upper arm 81 is maintained at the operation possible position.

By the operation of pressing the contact arm 8 against the driven member 300, the main body portion 10 further moves in the downward direction following the tightening of the screw 200, and the lower arm 80 moves relatively in the upward direction. When the lower arm 80 moves relatively in the upward direction, the lower arm 80 comes into contact with the tightening depth adjusting portion 86 and presses the tightening depth adjusting portion 86 in the upward direction. When the tightening depth adjusting portion 86 is pressed up by the lower arm 80 moving in the upward direction and the tightening depth adjusting portion 86 moves to a position where the tightening depth adjusting portion 86 comes into contact with the movement regulating portion 86e, the lower arm 80 is regulated from further moving in the upward direction. Accordingly, the position of the lower arm 80 regulated by the movement of the tightening depth adjusting portion 86 to the position in contact with the movement regulating portion 86e becomes the upper fulcrum position of the lower arm 80. When the lower arm 80 moves to the top dead center position, as illustrated in FIG. 8E, the lower arm 80 presses the first control valve 72 in the upward direction via the tightening depth adjusting portion 86, and the first control valve 72 moves from the standby position P100 illustrated in FIG. 8A and the like to a pressure control start position P101. The pressure control start position P101 is also referred to as a second position of the first control valve 72.

During a period in which the lower arm 80 comes into contact with the tightening depth adjusting portion 86, the tightening depth adjusting portion 86 comes into contact with the first control valve 72, and the first control valve 72 moves from the standby position P100 to the pressure control start position P101, the second control valve 71 standing by at the standby position P110 illustrated in FIG. 8D and the like and the first control valve 72 are separated from each other by the separation portion 76. In addition, even when the first control valve 72 moves to the pressure control start position P101, the second control valve 71 standing by at the standby position P110 and the first control valve 72 are separated by the separation portion 76. In a state where the first control valve 72 moves to the pressure control start position P101, the lower arm 80 comes into contact with the tightening depth adjusting portion 86, and the tightening depth adjusting portion 86 comes into contact with the first control valve 72. In this state, when the first control valve 72 comes into contact with the second control valve 71, a load for pressing up the second control valve 71 is applied to the lower arm 80. Thus, the operator may weaken the force for pressing the screw driving machine 1A against the driven member 300, and there is a possibility that a tightening failure occurs. Therefore, a configuration is provided in which even when the first control valve 72 moves to the pressure control start position P101, the second control valve 71 standing by at the standby position P110 and the first control valve 72 are separated by the separation portion 76.

In the control valve cylinder 75, the third chamber 75a is normally in communication with the space in the driving cylinder 30 via the communication passage 75c and the side hole flow path 32a of the driving cylinder 30. When the main valve 5 is operated, the driving piston 30a moves in the downward direction by a predetermined distance, and the seal portion 30b passes through the side hole flow path 32a, the second chamber 30d in the driving cylinder 30, which is the upper chamber of the driving cylinder, and the third chamber 75a of the control valve cylinder 75 are in communication with each other. In addition, the compressed air is supplied from the second chamber 30d to the timer chamber 32. During a period in which the first control valve 72 moves to the pressure control start position P101 from a state where the first control valve 72 stands by at the standby position P100, the seal portion 72c of the first control valve 72 is at a position where the exhaust passage 75d is opened, and the third chamber 75a of the control valve cylinder 75 is in communication with the outside of the body of the screw driving machine 1A via the exhaust passage 75d. Accordingly, even when the compressed air is supplied from the timer chamber 32 to the third chamber 75a of the control valve cylinder 75, the third chamber 75a is maintained at atmospheric pressure, and the first control valve 72 does not operate with the air pressure.

When the first control valve 72 moves to the pressure control start position P101, the seal portion 72c of the first control valve 72 closes the exhaust passage 75d. When the air flow path to an outside of a gas passing through the exhaust passage 75d is blocked, pressure in the control valve cylinder 75 increases due to the air pressure of the compressed air supplied from the timer chamber 32 to the third chamber 75a of the control valve cylinder 75. When the pressure in the control valve cylinder 75 increases, the first control valve 72 is operated due to the air pressure, and as illustrated in FIG. 8F, the first control valve 72 further moves in the upward direction.

When the first control valve 72 further moves in the upward direction from the pressure control start position P101 due to the air pressure of the compressed air and the first control valve 72 moves to the second control valve operation start position, the first control valve 72 comes into contact with the second control valve 71, and the first control valve 72 presses the second control valve 71 in the upward direction. When the second control valve 71 moves to an operation completion position P111 by movement of the first control valve 72 to an operation completion position P102, the compressed air is supplied to the on-off valve upper chamber 73b of the on-off valve cylinder 73 which is a space on the upper side of the on-off valve 7.

When the compressed air is supplied to the on-off valve upper chamber 73b, the on-off valve 7 moves in the downward direction as illustrated in FIG. 8G due to a difference between pressure acting on the on-off valve 7 due to the compressed air supplied to the on-off valve upper chamber 73b and pressure acting on the on-off valve 7 due to the compressed air supplied to the on-off valve lower chamber 73a, and supply of the compressed air to the air motor 31 is stopped. When the supply of the compressed air to the air motor 31 is stopped, rotation of the driver bit 2 is stopped.

When the rotation of the driver bit 2 is stopped and the tightening of the screw 200 is completed, the operator weakens the force for pressing the contact arm 8 against the driven member 300 and moves the main body portion 10 in a direction separating from the driven member 300.

When the main body portion 10 moves in the direction separating from the driven member 300, the lower arm 80 moves in the arrow D direction by the biasing of the biasing member 83a due to the relative movement of the main body portion 10 and the lower arm 80. When the lower arm 80 moves in the arrow D direction from the top dead center position, the roller 82 moves in the arrow R direction by a biasing force of the biasing member 82a, so that the roller 82 comes out of the second guide groove 41a2 and becomes movable in the downward direction, and the upper arm 81 follows the lower arm 80 due to the biasing of the biasing member 83b and moves in the arrow D direction due to the relative movement with respect to the main body portion 10, and the roller 82 entering the guide groove 81a moves in the arrow D direction.

When the upper arm 81 moves in the arrow D direction, the pressing of the contact lever 60a is released, and the contact lever 60a is separated from the start valve 6. When the contact lever 60a is separated from the start valve 6, the main valve 5 is closed, and the supply of the compressed air to the driving cylinder 30 is stopped.

When the supply of the compressed air to the driving cylinder 30 is stopped and the pressure in the driving cylinder 30 decreases to the atmospheric pressure, the compressed air in the blowback chamber 33 is supplied to a space on the lower side of the driving piston 30a, and the driver bit 2 (driving piston 30a) moves to the top dead center position.

When the driver bit 2 moves to the top dead center position and the pressure in the blowback chamber 33 decreases, the supply of the compressed air to the feed piston 92 is stopped. When the supply of the compressed air to the feed piston 92 is stopped, the feeding member 91 coupled to the feed piston 92 moves in the arrow R direction due to the biasing of the biasing member 94a.

When the feeding member 91 moves in the arrow R direction, a feeding pawl (not illustrated) provided on the feeding member 91 feeds a next screw 200 to the nose portion 12. In addition, the locking member 40 attached to the feeding member 91 moves in the arrow R direction. Accordingly, the locking member 40 moves to the locking position where the locking portion 40b protrudes to the movement path of the lower arm 80.

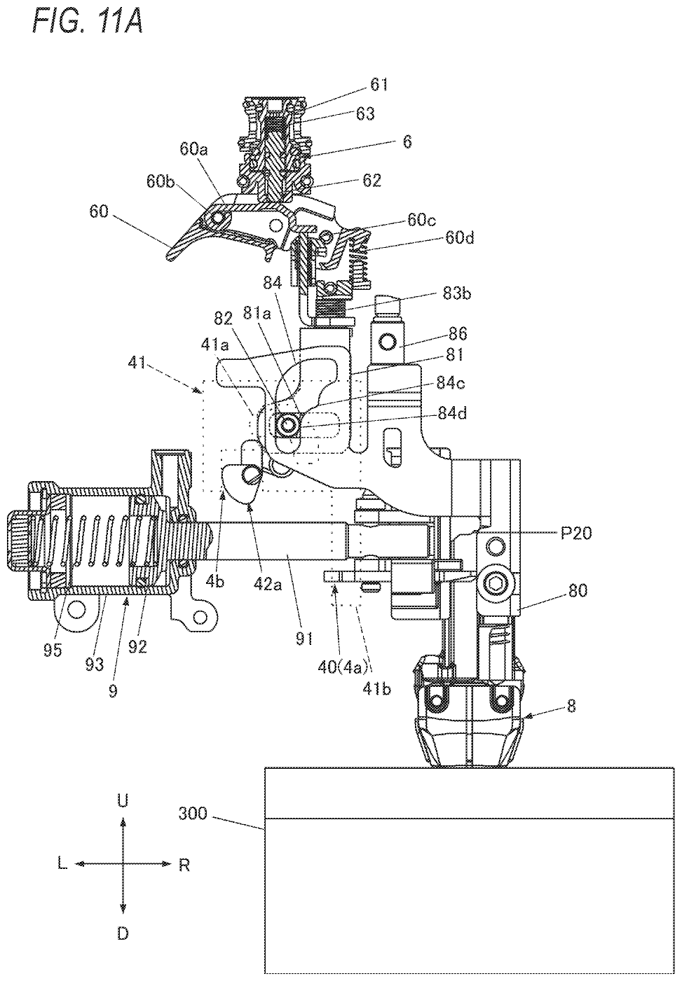

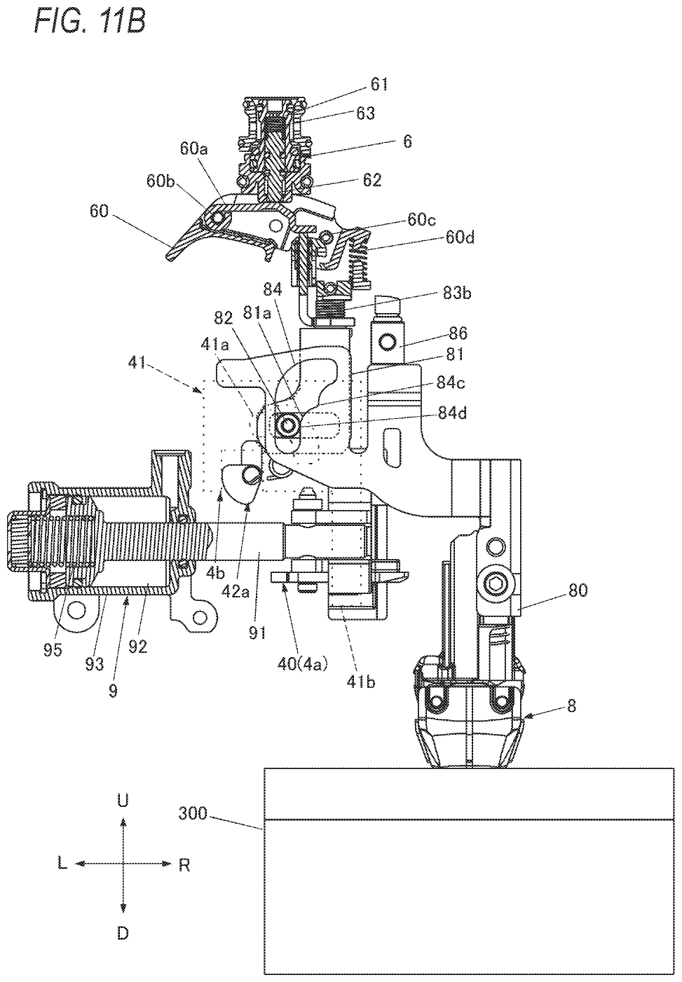

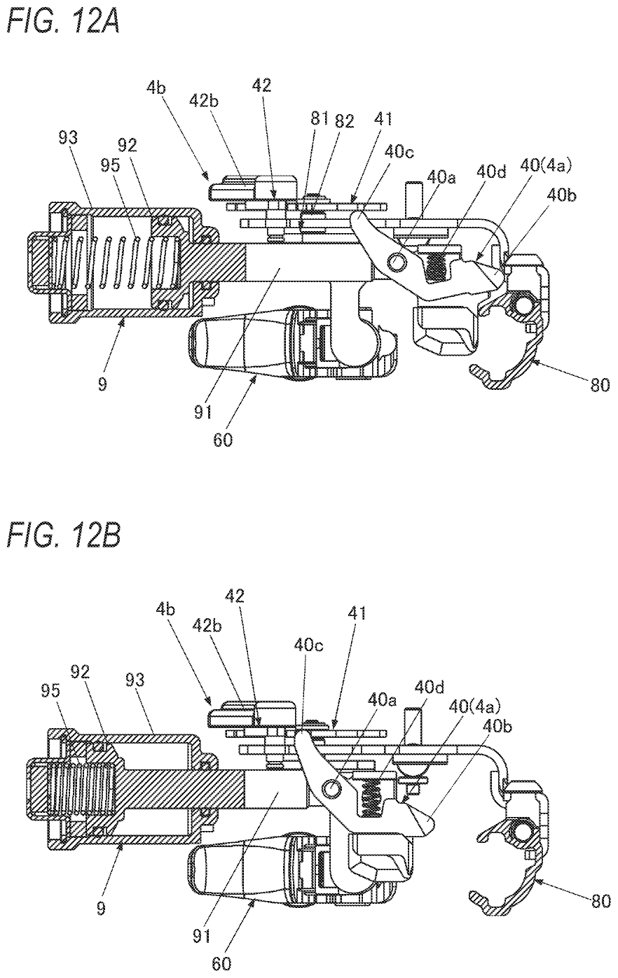

FIGS. 11A and 11B are side sectional views of main parts of the screw driving machine according to the present illustrative embodiment illustrating the example of the operation of driving the screw into the driven member and tightening the screw in the second mode, and FIGS. 12A and 12B are bottom sectional views of the main parts of the screw driving machine according to the present illustrative embodiment illustrating the example of the operation of driving the screw into the driven member and tightening the screw in the second mode.

Next, an example of an operation of the screw driving machine 1A in which the second mode is selected and the driving and tightening of the screw 200 are performed will be described.

In the screw driving machine 1A, when the above-described second mode is selected, as illustrated in FIG. 2B, the lower arm 80 moves to the second bottom dead center position P2. In addition, as illustrated in FIG. 3B, the locking member 40 moves to the first retracted position to which the locking portion 40b is retracted from the movement path of the lower arm 80. The second bottom dead center position P2 of the lower arm 80 is also referred to as the first position.

In a state where the second mode is selected as described above, the operator holds the handle portion 11 of the screw driving machine 1A and presses the contact arm 8 against the driven member 300. In the screw driving machine 1A, when the contact arm 8 is pressed against the driven member 300, the lower arm 80 moves in the upward direction due to the relative movement with respect to the main body portion 10.

In a state where the lower arm 80 moves to the second bottom dead center position P2, the roller 82 is engaged with the second engaging portion 84c of the cam groove 84, and the lower arm 80 and the upper arm 81 are interlockingly engaged via the roller 82, so that when the lower arm 80 moves in the upward direction from the second bottom dead center position P2 due to the relative movement with respect to the main body portion 10, the upper arm 81 moves in the upward direction interlockingly with the lower arm 80.

As illustrated in FIG. 11A, when the lower arm 80 moves in the upward direction due to the relative movement with respect to the main body portion 10, the locking position of the lower arm 80 with respect to the locking member 40 is beyond the locking member 40, and the lower arm 80 moves to a second driving depth defining position P20, the upper arm 81 moves to the operation possible position where the contact lever 60a of the trigger 60 is caused to operate. The second driving depth defining position P20 of the lower arm 80 is the top dead center position. Accordingly, in a state where the contact arm 8 is pressed against the driven member 300 until the lower arm 80 moves to the second driving depth defining position P20, when the operation of pulling the trigger 60 is performed, the contact lever 60a presses the valve stem 62 of the start valve 6, and the start valve 6 is operated. In this manner, a state where the valve stem 62 is pressed by the contact lever 60a by operating the trigger 60 in the state where the contact arm 8 is pressed against the driven member 300 until the lower arm 80 moves to the second driving depth defining position P20 is referred to as sign-in in the second mode.

When the start valve 6 is operated in the state of sign-in in the second mode, the main valve is operated as illustrated in FIG. 8B, and the compressed air is supplied to the driving cylinder 30. When the compressed air is supplied to the driving cylinder 30, the driving piston 30a to which the driver bit 2 is attached is pressed by the air pressure, and as illustrated in FIG. 8C, the driver bit 2 (driving piston 30a) moves in the downward direction from the top dead center position to the bottom dead center position, and the screw 200 is driven into the driven member 300.

When the driver bit 2 (driving piston 30a) moves to the bottom dead center position, the compressed air in the blowback chamber 33 is supplied from the feed flow path 94 of the screw feeding portion 9 to the feed piston 92. Accordingly, as illustrated in FIGS. 11B and 12B, the feeding member 91 coupled to the feed piston 92 moves in the arrow L direction.

When the feeding member 91 moves in the arrow L direction, the locking member 40 attached to the feeding member 91 moves in the arrow L direction. Accordingly, even when the locking member 40 moves from the first retracted position, the locking portion 40b maintains a state of being retracted from the movement path of the lower arm 80.

In the second mode, operations after the main valve 5 is operated are the same as those in the first mode except for the operation of releasing the interlocking engagement between the lower arm 80 and the upper arm 81 by the cam groove 84 or the like and an operation of returning the locking member 40. That is, when the lower arm 80 moves in the upward direction due to the relative movement of the main body portion 10 and the lower arm 80, the roller 82 is guided by the guide groove 41a of the switching member 41, and thus the roller 82 engaged with the second engaging portion 84c of the cam groove 84 is guided from the second engaging portion 84c to the second engagement releasing portion 84d by the first guide groove 41a1 of the guide groove 41a. When the roller 82 is guided to the second engagement releasing portion 84d, the interlocking engagement between the lower arm 80 and the upper arm 81 via the roller 82 is released.

By the operation of moving the lower arm 80 in the upward direction, the roller 82 guided from the second engaging portion 84c to the second engagement releasing portion 84d of the cam groove 84 is guided from the first guide groove 41a1 to the second guide groove 41a2 of the guide groove 41a. Accordingly, while the upper arm 81 moves to the operation possible position and the roller 82 is located in the second guide groove 41a2, the position of the upper arm 81 is maintained at the operation possible position.

Further, in the operation of returning the locking member 40, the locking member 40 moves to the first retracted position, and the locking portion 40b is maintained in the state of being retracted from the movement path of the lower arm 80.

### Example of Operation and Effect of Screw Driving Machine

In the screw driving machine 1A, at a timing of driving the screw 200 into the driven member 300 in the second mode, a length from the lower end (tip) of the driver bit 2 to the lower end (tip) of the contact arm 8, that is, a length from the lower end (tip) of the driver bit 2 to the driven member 300 can be made shorter than the same length in the first mode.

On the other hand, in the operation of driving the screw 200 into the driven member 300 by causing the driver bit 2 to move in the axial direction, a movement amount of the driver bit 2 is the same in the first mode and the second mode.

Accordingly, the screw driving machine 1A can make the second driving depth deeper than the first driving depth, the second driving depth being the driving depth of the screw 200 in the second mode, and the first driving depth being the driving depth of the screw 200 in the first mode.

When the screw 200 is driven, the tip of the screw 200 needs to penetrate an upper material 300a of the driven member 300 and be driven halfway into a lower material 300b. When the screw 200 is excessively driven, a hole larger than a screw diameter is deeply bored in the lower material 300b, and thus there is a possibility that an engagement amount of the screw 200 is short and a fastening force is weakened. To the contrary, in a case where the screw 200 cannot be driven into the lower material 300b, there is a possibility that the screw 200 cannot be tightened into the lower material 300b and the construction fails.

Therefore, in the screw driving machine 1A, the first mode is selected in a case where the screw 200 is driven and tightened into the driven member 300 in which the screw 200 is likely to be excessively driven. By selecting the first mode, the driving depth of the screw 200 is made relatively shallow, and a hole larger than the screw diameter can be prevented from being deeply bored in the lower material 300b, and a decrease in the fastening force can be prevented.

In addition, in the screw driving machine 1A, the second mode is selected in a case where the screw 200 is driven and tightened into the driven member 300 in which the screw 200 is less likely to be excessively driven. By selecting the second mode, the driving depth of the screw 200 is made relatively deep, the screw 200 can be reliably driven into the lower material 300b, and the tightening of the screw 200 can be reliably performed.

As described above, in the screw driving machine 1A, the driving depth of the screw 200 can be selected according to a material, a thickness, and the like of the driven member 300.

In the screw driving machine 1A, in the second mode, by moving the bottom dead center position of the contact arm 8 (lower arm 80) to the second bottom dead center position P2, a relative movement amount between the main body portion 10 and the contact arm 8 by which the lower arm 80 is caused to move from the bottom dead center position to the top dead center position can be reduced in the operation of pressing the contact arm 8 against the driven member 300 as compared to that in the first mode.

Accordingly, a time required for an operation of moving the contact arm 8 (lower arm 80) from the second bottom dead center position P2 to the top dead center position and an operation of returning the contact arm 8 from the top dead center position to the second bottom dead center position P2 can be shortened, and a time required for an operation of continuously driving and tightening the screw 200 can be shortened.

In the screw driving machine 1A, in the second mode, the lower arm 80 is locked to the locking member 40 once and an operation of moving in two stages is not performed, an operation feeling can be improved.

Further, in the screw driving machine 1A, by making the contact arm 8 (lower arm 80) and the locking member 40 interlocked with each other via the switching member 41, the operation of causing the bottom dead center position of the contact arm 8 (lower arm 80) to move to the second bottom dead center position P2 and the operation of causing the locking member 40 to move to the retracted position can be performed interlockingly with each other by the switching operation member 42 that causes the switching member 41 to move. Accordingly, the switching between the first mode and the second mode can be easily performed by operating the operation portion 42b of the switching operation member 42.

In addition, a force for driving the screw 200 into the driven member 300 is switched by switching the size of the opening area of the supply port 34 in accordance with the switching between the first mode and the second mode. That is, in the case where the screw 200 is driven and tightened into the driven member 300 in which the screw 200 is likely to be excessively driven, the first mode is selected as described above. In a case where the first mode is selected, a base material of the driven member 300 is a steel plate having a small thickness. Therefore, the screw 200 is likely to be excessively driven, and since the base material is hard, it is necessary to increase the force for driving the screw 200 into the driven member 300 as compared to wood or the like.

Therefore, as illustrated in FIG. 5A, in a case where the first mode is selected by the operation of the operation portion 42b of the switching operation member 42, the operation portion 38a of the flow rate switching member 36 is operated in a direction in which an indication (iron or the like) of a desired material can be seen. Accordingly, as illustrated in FIG. 4A, the throttle portion 35 moves in a direction approaching the flow rate switching member 36 according to the rotation direction of the flow rate switching member 36, thereby moving along the axial direction of the driving cylinder 30 interlocking with the rotation of the flow rate switching member 36, and widening the opening area of the supply port 34. Accordingly, a flow rate of the compressed air supplied to the driving cylinder 30 can be increased, and the force for driving the screw 200 into the driven member 300 can be increased.

In contrast, in a case where the second mode is selected, the base material of the driven member 300 is often wood having a large thickness. Therefore, the excessive driving of the screw 200 is less likely to occur, and it is necessary to reduce the force for driving the screw 200 into the driven member 300 as compared to a base material such as a steel plate.

Therefore, as illustrated in FIG. 5B, in a case where the second mode is selected by the operation of the operation portion 42b of the switching operation member 42, the operation portion 38a of the flow rate switching member 36 is operated in a direction in which an indication (wood or the like) of a desired material can be seen. Accordingly, as illustrated in FIG. 4B, the throttle portion moves in a direction separating from the flow rate switching member 36 according to the rotation direction of the flow rate switching member 36, thereby moving along the axial direction of the driving cylinder 30 interlocking with the rotation of the flow rate switching member 36, and narrowing the opening area of the supply port 34. Thus, a flow rate of the compressed air supplied to the driving cylinder 30 can be reduced, and the force for driving the screw 200 into the driven member 300 can be reduced.

The air flow path 74 connecting the main chamber 13 and the air motor 31 is connected to the air flow path 54 on the downstream side of the main valve 5 and on the upstream side of the supply port 34. Accordingly, the compressed air supplied to the air motor 31 does not pass through the supply port 34 and is not affected by the throttle portion 35. Therefore, the flow rate of the compressed air flowing to the air motor 31 is not reduced, and a speed of tightening due to the rotation of the driver bit 2 does not decrease.

Further, in the screw driving machine 1A, the screw coupling body is accommodated in the magazine 90, so that in a case where the screw driving machine 1A is used in a lateral orientation, a weight of the screw coupling body is applied to the front side of the handle portion 11. In contrast, in the case where the screw driving machine 1A is used in a lateral orientation, a weight of the air motor 31 is applied to the rear side of the handle portion 11. Accordingly, the screw driving machine 1A has a configuration in which heavy members are provided on both the front and rear sides with the handle portion 11 interposed therebetween. Therefore, in the screw driving machine 1A, when the operation of driving and tightening the screw 200 into the driven member 300 while holding the handle portion 11 in hand is performed as described above, a weight balance is prevented from being biased to one side on both the front and rear sides with the handle portion 11 interposed therebetween.

Since the throttle portion 35 for switching the opening area of the supply port 34 is provided on the outer periphery of the driving cylinder 30, a space for providing the throttle portion 35 and the flow rate switching member 36 and a space for the throttle portion 35 to operate are not required between the driving cylinder 30 and the air motor 31. Further, the throttle portion 35 and the flow rate switching member 36 are configured such that the plate-like flange portion 35b of the throttle portion 35 and the plate-like flow rate switching member 36 are overlapped in the axial direction of the driving cylinder 30. Accordingly, with a configuration in which the air motor 31 is provided on the upper side which is the other side along the extending direction of the main body portion 10 and a configuration including a mechanism that adjusts the force for driving the screw 200 into the driven member 300, it is possible to prevent an increase in the length of the screw driving machine 1A along the axial direction of the driver bit 2.

In the screw driving machine 1A, with an operation of pressing the contact arm 8 against the driven member 300, the first control valve 72 is pressed by the lower arm 80 and moves from the standby position P100 to the pressure control start position P101, whereby a force by which the first biasing member 72b biases the first control valve 72 is applied to the contact arm 8 via the first control valve 72.

On the other hand, the first control valve 72 moving from the standby position P100 to the pressure control start position P101 and the second control valve 71 standing by at the standby position P110 are separated from each other by the separation portion 76, and a force by which the second biasing member 71a biases the second control valve 71 is not applied to the contact arm 8 via the first control valve 72. Accordingly, a force required to press the contact arm 8 against the driven member 300 is reduced, and operability is improved.

When the force by which the second biasing member 71a biases the second control valve 71 is weak, a time for the second control valve 71 to move from the standby position P110 to an operation completion position P111 can be shortened, and an operation response of the on-off valve 7 is improved. When the operation response of the on-off valve 7 is improved, the rotation of the driver bit 2 is stopped at the same time as a tightening completion state in which a head portion of the screw 200 is tightened to a state of being flush with the driving surface of the driven member 300 or being slightly recessed. Accordingly, wasteful consumption of the compressed air is prevented, and repetition of engagement and engagement releasing of the driver bit 2 with the head portion of the screw 200 is prevented, thereby reducing wear of the driver bit 2.

On the other hand, when the force by which the second biasing member 71a biases the second control valve 71 is weak, depending on a magnitude of a reaction force generated when the screw 200 is driven and tightened under different construction conditions, the timing at which the on-off valve 7 operates becomes too early, and the rotation of the driver bit 2 may be stopped in a state where the screw 200 is lifted.

Therefore, the controller 70 includes a biasing force adjusting portion 71b that adjusts the biasing force of the second biasing member 71a. In the biasing force adjusting portion 71b, an adjustment member 71b1 is attached to an attachment portion 71b2 of the biasing force adjusting portion 71b provided on the upper side of the on-off valve cylinder 73 by screwing a screw. In addition, in the biasing force adjusting portion 71b, the second biasing member 71a is disposed on the attachment portion 71b2 between the second control valve 71 and the adjustment member 71b1. As indicated by a broken line in FIG. 1B, the biasing force adjusting portion 71b adjusts an amount of tightening of the screw of the adjustment member 71b1, thereby switching the force by which the second biasing member 71a biases the second control valve 71 according to an attachment height of the adjustment member 71b1 along the first direction or the second direction with respect to the attachment portion 71b2. Accordingly, by adjusting the force by which the second biasing member 71a biases the second control valve 71, the timing at which the second control valve 71 is pressed by the first control valve 72 and operates can be adjusted.

While the first control valve 72 pressed against the driven member 300 moves from the standby position P100 to the pressure control start position P101, the force by which the second biasing member 71a biases the second control valve 71 is not applied to the contact arm 8 via the first control valve 72. Therefore, an optimum biasing force can be set according to a user or the construction conditions without affecting the force required to press the contact arm 8 against the driven member 300, and both improvement of the operation response of the on-off valve 7 and setting of an optimum timing to stop the rotation of the air motor 31 can be achieved.

A plurality of adjustment members having different lengths and an adjustment portion to which the adjustment members are attached may be provided, and the force by which the second biasing member 71a biases the second control valve 71 may be changed by changing the adjustment members attached to the adjustment portion.

In the screw driving machine 1A, the on-off valve 7 and the controller 70 are provided on one side portion of the main body portion 10. In the controller 70, the on-off valve 7, the second control valve 71, and the first control valve 72 are coaxially provided, and are arranged in the up-down direction along the extending direction of the main body portion 10.

The on-off valve 7 is provided on a side portion of the air motor 31, the second control valve 71 is provided on the lower side of the on-off valve 7, and the first control valve 72 is provided on the lower side of the second control valve 71. In this manner, by providing the on-off valve 7 on the side portion of the air motor 31, a length of the air flow path 74 connected to the air motor 31 can be shortened, and loss of the compressed air supplied to the air motor 31 can be prevented. In addition, the on-off valve 7 is vertically movably supported by the on-off valve cylinder 73 provided in the motor housing 31c. By providing the on-off valve cylinder 73 on the side portion of the air motor 31, the length of the air flow path 74 connected to the air motor 31 can be shortened, and the loss of the compressed air supplied to the air motor 31 can be prevented.

{Modifications to Screw Driving Machine}

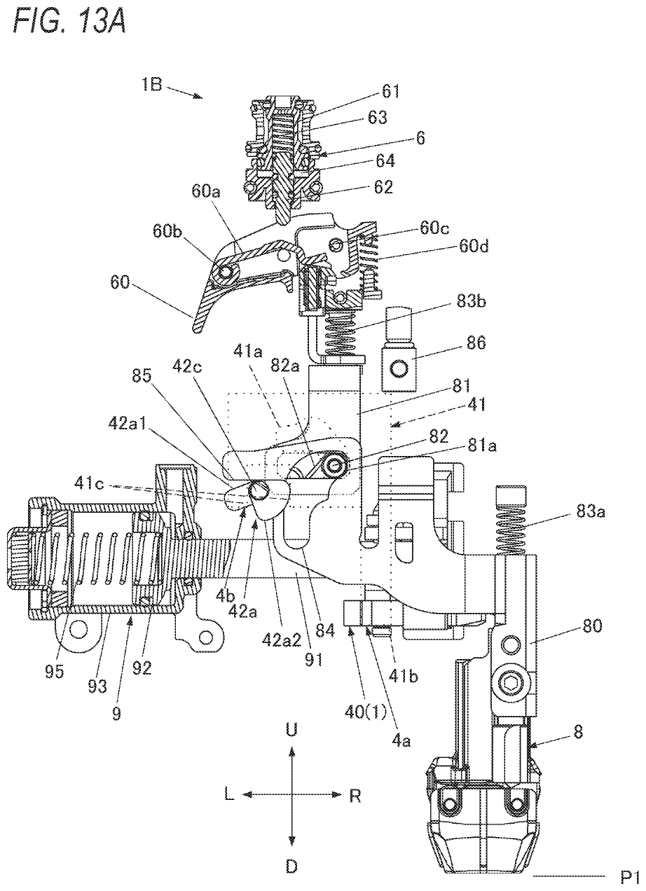

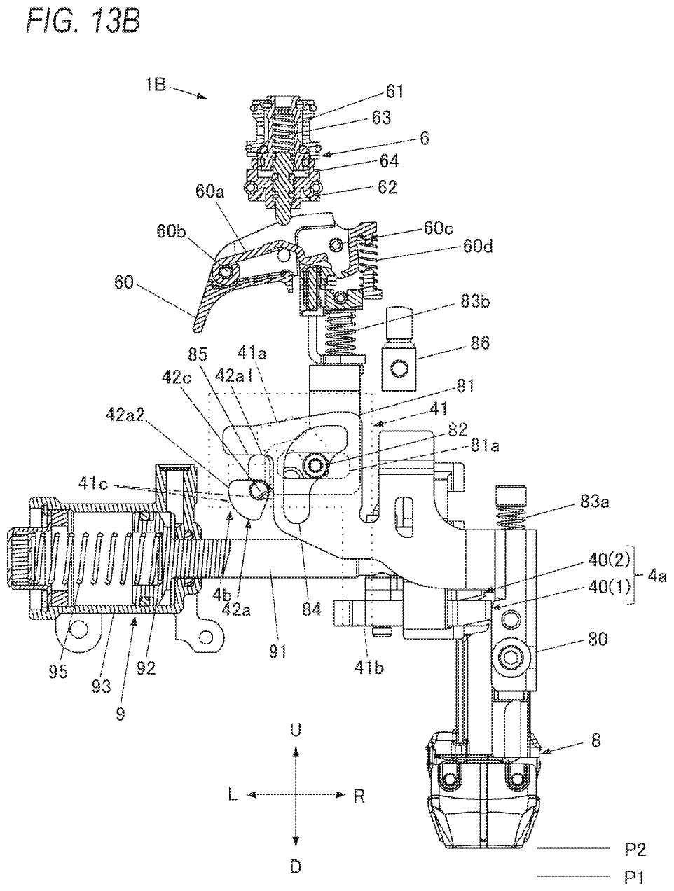

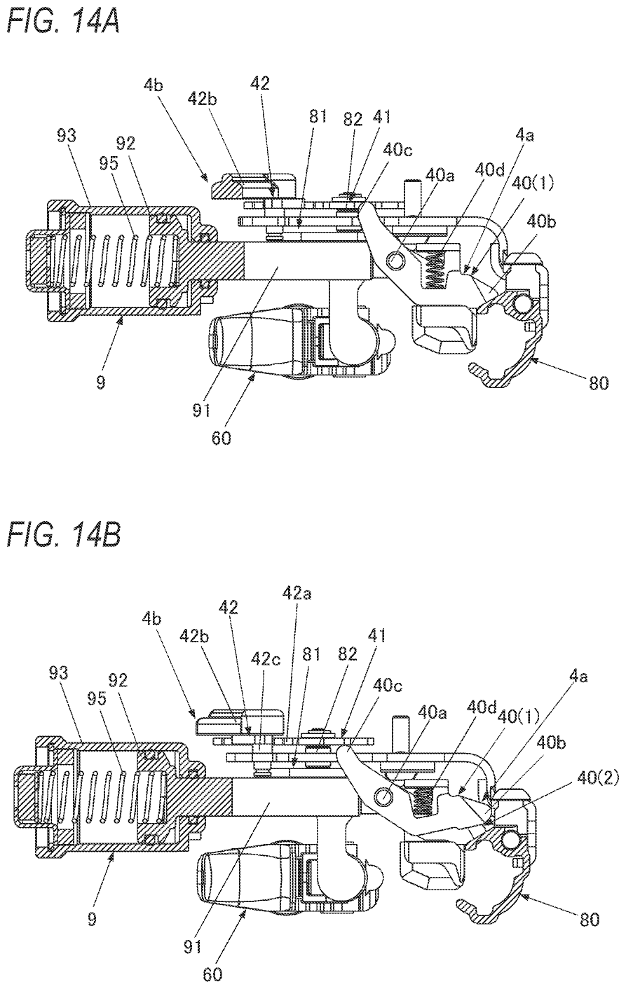

FIGS. 13A and 13B are side sectional views of main parts of a screw driving machine according to a first modification of the present illustrative embodiment illustrating a modification of a switching portion that switches a driving depth of a screw, and FIGS. 14A and 14B are bottom sectional views of the main parts of the screw driving machine according to the first modification of the present illustrative embodiment illustrating the modification of the switching portion.

FIGS. 13A and 14A illustrate states of respective parts when the first mode in which the driving depth of the screw is set to the first driving depth is selected. In addition, FIG. 13B illustrates states of the respective parts when the second mode in which the driving depth of the screw is set to the second driving depth that is deeper than the first driving depth is selected, and FIG. 14B illustrates states of the respective parts when switching of the driving depth is selected in the first mode. In a screw driving machine 1B according to the first modification, the same reference numerals are given to the same components as those of the screw driving machine 1A.

In the screw driving machine 1B according to the first modification, the contact arm 8 moves in the upward direction from the bottom dead center position by the operation of pressing the contact arm 8 against the driven member 300, similarly to the screw driving machine 1A. In the screw driving machine 1B, by enabling the movement amount from the bottom dead center position to be switched in the first mode, the driving depth of the screw 200 with respect to the driven member 300 is switched.

In addition, in the screw driving machine 1B, by enabling the bottom dead center position of the lower arm 80 to be switched in the second mode, the movement amount of the contact arm 8 is reduced when the driving depth of the screw 200 with respect to the driven member 300 is increased.

Therefore, the driving depth regulating portion 4a includes a first locking member 40(1) that regulates the movement amount of the lower arm 80 from the first bottom dead center position P1 illustrated in FIG. 13A in the first mode, and a second locking member 40(2) that switches the movement amount of the contact arm 8 from the first bottom dead center position P1 in the first mode. By switching between regulating the movement amount of the contact arm 8 from the first bottom dead center position P1 by the first locking member 40(1) or regulating the movement amount of the contact arm 8 from the first bottom dead center position P1 by the second locking member 40(2), the driving depth regulating portion 4a switches the movement amount of the lower arm 80 from the first bottom dead center position P1 in the first mode.

Further, the driving depth switching portion 4b includes the switching member 41 that switches between the first mode and the second mode by, in the first mode, switching whether the movement amount of the lower arm 80 is to be regulated by the first locking member 40(1) and switching whether the movement amount of the lower arm 80 is to be regulated by the first locking member 40(1) and the second locking member 40(2).

The switching member 41 also has a function of guiding a movement path of the roller 82 which moves together with the lower arm 80 and the upper arm 81, and switching whether the lower arm 80 and the upper arm 81 are to be interlocked with each other. Further, the driving depth switching portion 4b includes a switching operation member 42 that causes the switching member 41 to operate and switches the bottom dead center position of the lower arm 80 to the first bottom dead center position P1 illustrated in FIG. 13A or a second bottom dead center position P2 illustrated in FIG. 13B.

The first locking member 40(1) is rotatably supported by the feeding member 91 with the shaft 40a as a fulcrum. In the first locking member 40(1), the locking portion 40b to be locked to the lower arm 80 is formed on one of end portions with the shaft 40a interposed therebetween. In addition, in the first locking member 40(1), the affected portion 40c that receives a force for causing the locking member 40 to rotate by the switching member 41 is formed on the other of the end portions with the shaft 40a interposed therebetween.

In a state where the first locking member 40(1) is biased by the biasing member 40d in a direction in which the locking portion 40b protrudes to the movement path of the lower arm 80, the first locking member 40(1) moves, by the movement of the feeding member 91 and the rotating operation with the shaft 40a as a fulcrum, between a locking position illustrated in FIG. 14A in which the locking portion 40b protrudes to the movement path of the lower arm 80 and a first retracted position (1) illustrated in FIG. 14B to which the locking portion 40b is retracted from the movement path of the lower arm 80. In addition, in a state where the first locking member 40(1) has moved to the first retracted position (1), the second locking member 40(2) moves to the locking position illustrated in FIG. 14B by the movement of the feeding member 91. As a result, the movement amount of the contact arm 8 from the first bottom dead center position P1 in the first mode is switched.

Further, the first locking member 40(1) moves, by the movement of the feeding member 91, between the locking position where the locking portion 40b protrudes to the movement path of the lower arm 80 and a second retracted position to which the locking portion 40b is retracted from the movement path of the lower arm 80. In addition, the second locking member 40(2) moves, by the movement of the feeding member 91, between the locking position and the second retracted position interlocking with the first locking member 40(1). A configuration in which the first locking member 40(1) and the second locking member 40(2) are caused to move to the second retracted position may not be provided, only a configuration in which the first locking member 40(1) moves between the locking position and the first retracted position (1) may be provided, the second mode may not be provided, and only the adjustment of the driving depth depending on presence or absence of the first locking member 40(1) may be performed in the first mode.

In the first mode, by causing the first locking member 40(1) to move to the locking position, the movement amount of the lower arm 80 from the first bottom dead center position P1 is defined by the first locking member 40(1), and the first driving depth (1) of the screw 200 is defined. In addition, in the first mode, by causing the first locking member 40(1) to move to the first retracted position (1), the movement amount of the lower arm 80 from the first bottom dead center position P1 is defined by the second locking member 40(2), and the first driving depth (2) of the screw 200 is defined. In this example, the first driving depth (1) in the first mode is defined by a thickness of the first locking member 40(1) along the moving direction of the contact arm 8, but the first driving depth (1) may be defined by a position of the first locking member 40(1) along the moving direction of the contact arm 8.

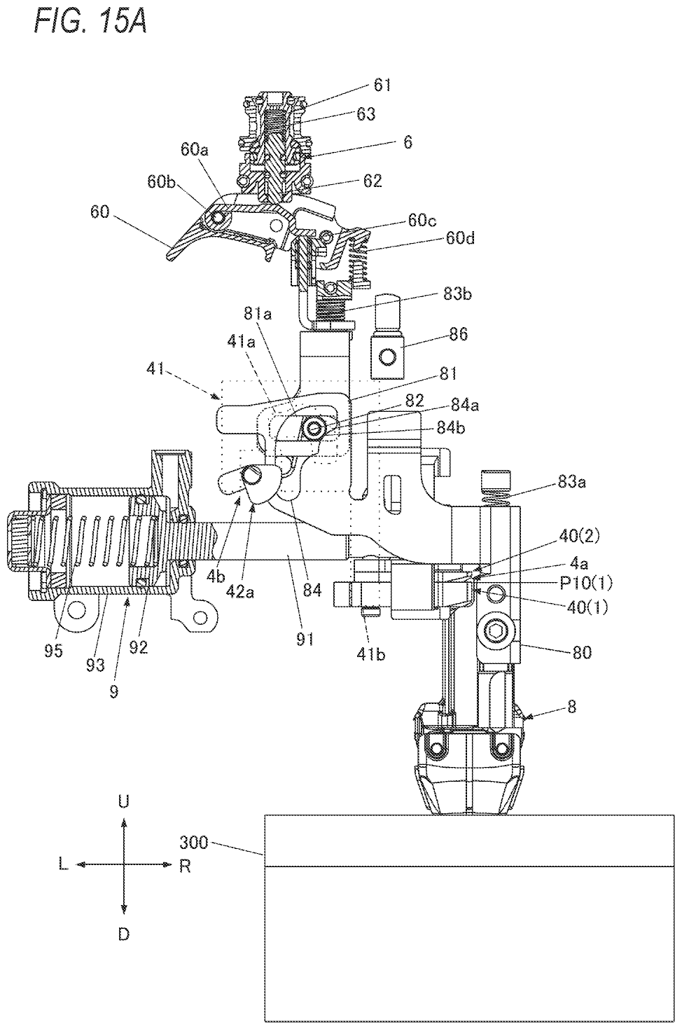

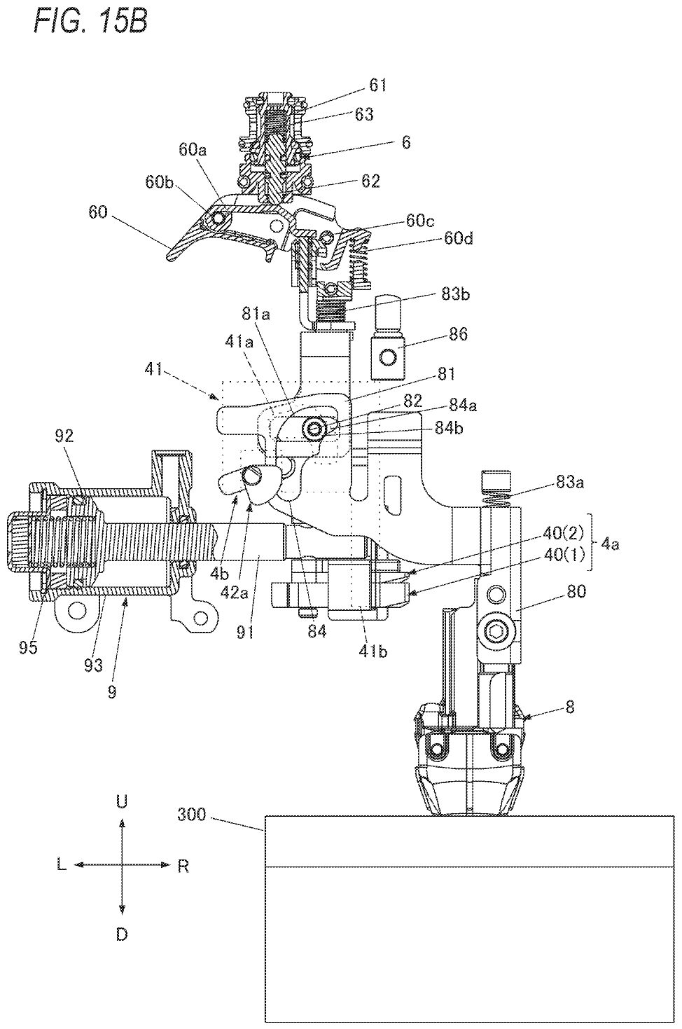

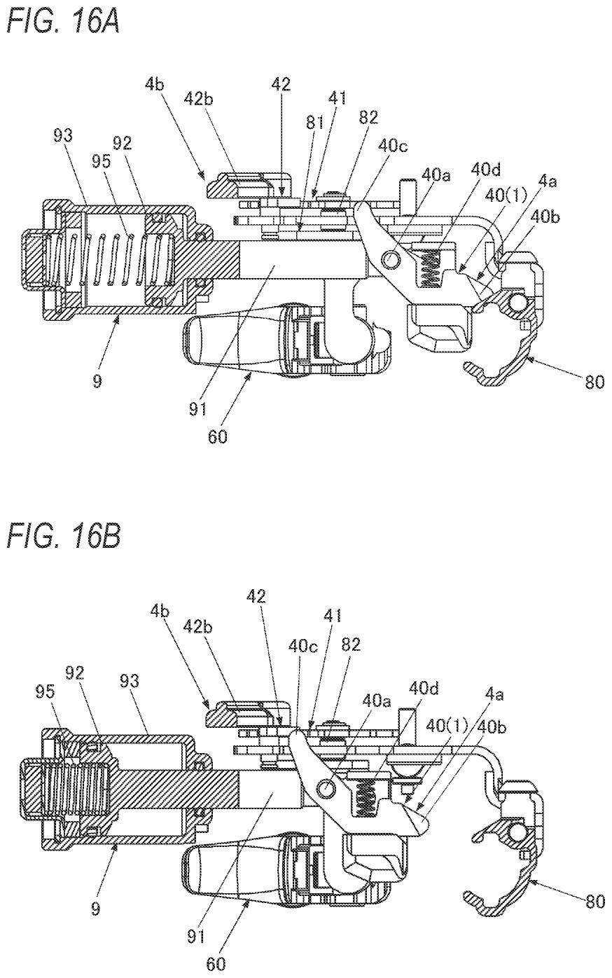

FIGS. 15A and 15B are side sectional views of main parts of a screw driving machine according to the first modification of the present illustrative embodiment illustrating an example of an operation of driving a screw into a driven member at a first driving depth (1) and tightening the screw in a first mode, and FIGS. 16A and 16B are bottom sectional views of the main parts of the screw driving machine according to the first modification of the present illustrative embodiment illustrating an example of the operation of driving the screw into the driven member at the first driving depth (1) and tightening the screw in the first mode.

Next, an example of the operation of the screw driving machine 1B in which the first driving depth (1) is selected in the first mode and the driving and tightening of the screw 200 are performed will be described.

In the screw driving machine 1B, when the first driving depth (1) is selected in the first mode, the lower arm 80 moves to the first bottom dead center position P1 during standby as illustrated in FIG. 13A. In addition, as illustrated in FIG. 14A, the first locking member 40(1) moves to the locking position where the locking portion 40b protrudes to the movement path of the lower arm 80.

In a state where the first driving depth (1) is selected in the first mode as described above, in the screw driving machine 1B, when the contact arm 8 is pressed against the driven member 300, as illustrated in FIG. 15A, the lower arm 80 moves to a first driving depth defining position P10(1) where the lower arm 80 comes into contact with the locking portion 40b of the first locking member 40(1), and the upper arm 81 moves to the operation possible position where the contact lever 60a of the trigger 60 is caused to operate. Accordingly, in a state where the contact arm 8 is pressed against the driven member 300 until the lower arm 80 moves to the first driving depth defining position P10(1), when the operation of pulling the trigger 60 is performed, as illustrated in FIG. 15A, the contact lever 60a enters a sign-in state where the valve stem 62 of the start valve 6 is pressed, and the start valve 6 is operated.

When the start valve 6 is operated in the sign-in state, the main valve 5 is operated as illustrated in FIG. 8B, and the compressed air is supplied to the driving cylinder 30. When the compressed air is supplied to the driving cylinder 30, as illustrated in FIG. 8C, the driver bit 2 (driving piston 30a) moves in the downward direction from the top dead center position to the bottom dead center position, and the screw 200 is driven into the driven member 300.

When the driver bit 2 (driving piston 30a) moves to the bottom dead center position, the compressed air is supplied to the feed piston 92. Accordingly, as illustrated in FIGS. 15B and 16B, the feeding member 91 coupled to the feed piston 92 moves in the arrow L direction.

When the feeding member 91 moves in the arrow L direction, the first locking member 40(1) and the second locking member 40(2) attached to the feeding member 91 move in the arrow L direction. Accordingly, the first locking member 40(1) and the second locking member 40(2) move to the second retracted position where retraction from the movement path of the lower arm 80 is performed. When the first locking member 40(1) and the second locking member 40(2) move to the second retracted position, with the operation of pressing the contact arm 8 against the driven member 300, the lower arm 80 can move in the upward direction beyond the first driving depth defining position P10 due to the relative movement with respect to the main body portion 10. The following operation is the same as that in the first mode of the screw driving machine 1A.

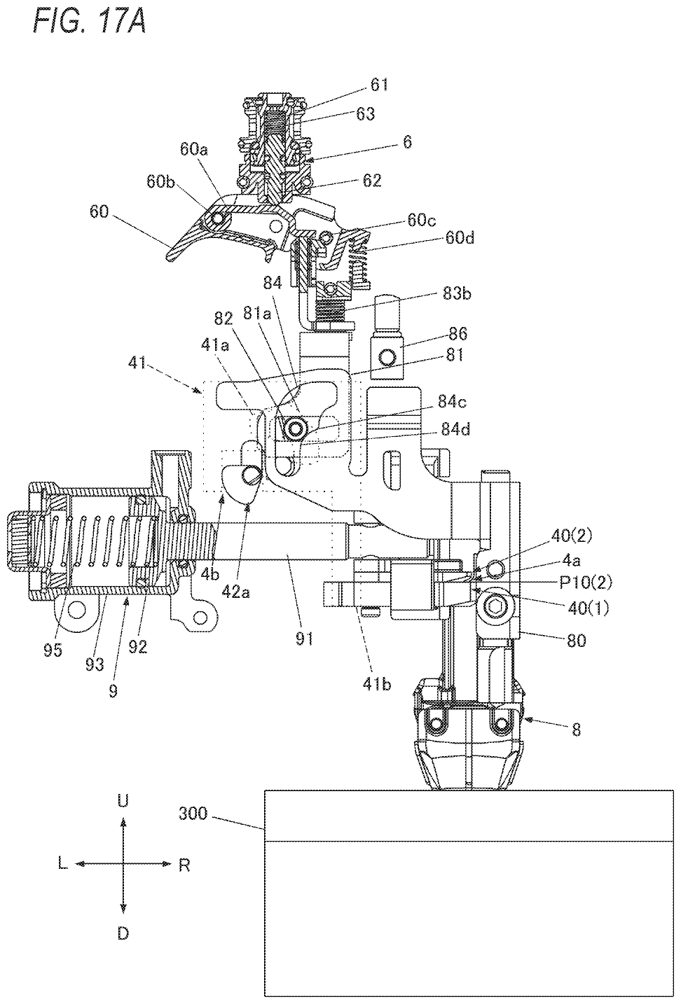

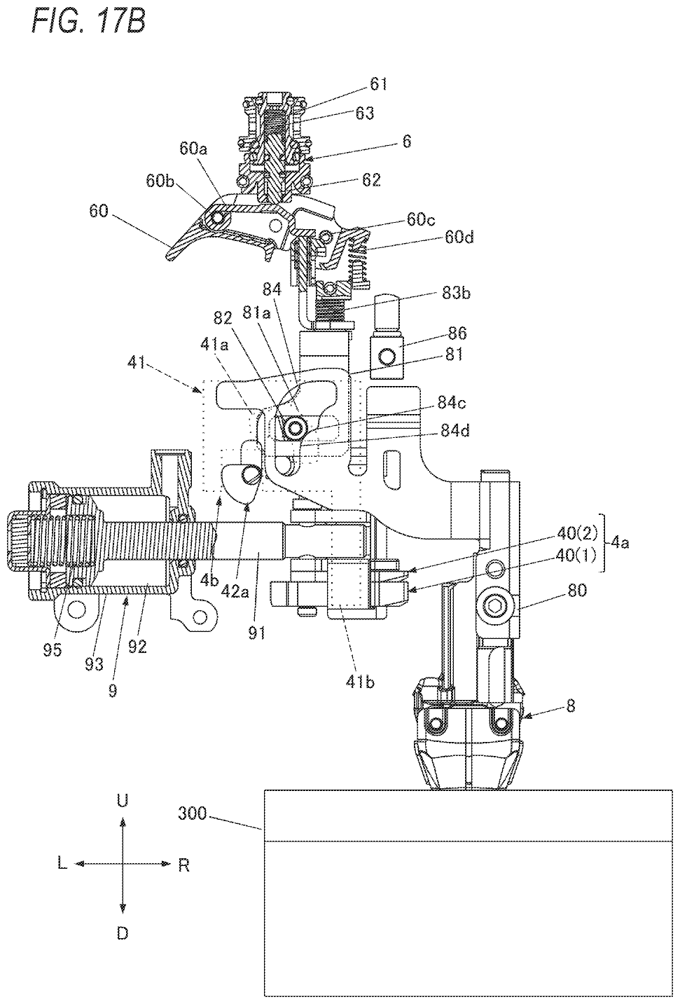

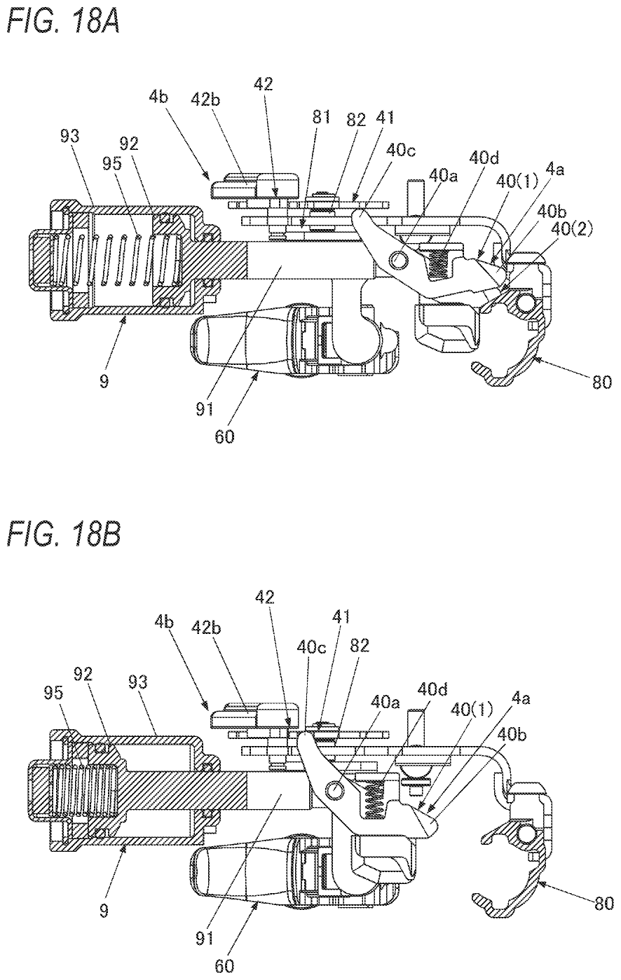

FIGS. 17A and 17B are side sectional views of main parts of a screw driving machine according to the first modification of the present illustrative embodiment illustrating an example of an operation of driving a screw into a driven member at a first driving depth (2) and tightening the screw in a first mode, and FIGS. 18A and 18B are bottom sectional views of the main parts of the screw driving machine according to the first modification of the present illustrative embodiment illustrating an example of the operation of driving the screw into the driven member at the first driving depth (2) and tightening the screw in the first mode.

Next, an example of the operation of the screw driving machine 1B in which the first driving depth (2) is selected in the first mode and the driving and tightening of the screw 200 are performed will be described.

In the screw driving machine 1B, when the first driving depth (2) is selected in the first mode, the lower arm 80 moves to the first bottom dead center position P1 as in the case where the first driving depth (1) is selected. In addition, as illustrated in FIG. 14B, the first locking member 40(1) moves to the first retracted position (1) to which the locking portion 40b is retracted from the movement path of the lower arm 80. On the other hand, the second locking member 40(2) moves to the locking position where the locking portion 40b protrudes into the movement path of the lower arm 80.

In a state where the first driving depth (2) is selected in the first mode as described above, in the screw driving machine 1B, when the contact arm 8 is pressed against the driven member 300, as illustrated in FIG. 17A, the lower arm 80 moves to a first driving depth defining position P10(2) where the lower arm 80 comes into contact with the second locking member 40(2), and the upper arm 81 moves to the operation possible position where the contact lever 60a of the trigger 60 is caused to operate. Accordingly, in a state where the contact arm 8 is pressed against the driven member 300 until the lower arm 80 moves to the first driving depth defining position P10(2), when the operation of pulling the trigger 60 is performed, as illustrated in FIG. 17A, the contact lever 60a enters a sign-in state where the valve stem 62 of the start valve 6 is pressed, and the start valve 6 is operated.

When the start valve 6 is operated in the sign-in state, the main valve 5 is operated as illustrated in FIG. 8B, and as illustrated in FIG. 8C, the driver bit 2 (driving piston 30a) moves in the downward direction from the top dead center position to the bottom dead center position, and the screw 200 is driven into the driven member 300.

When the driver bit 2 (driving piston 30a) moves to the bottom dead center position, the compressed air is supplied to the feed piston 92. Accordingly, as illustrated in FIGS. 17B and 18B, the feeding member 91 coupled to the feed piston 92 moves in the arrow L direction.

When the feeding member 91 moves in the arrow L direction, the first locking member 40(1) and the second locking member 40(2) attached to the feeding member 91 move in the arrow L direction. Accordingly, the first locking member 40(1) and the second locking member 40(2) move to the second retracted position where retraction from the movement path of the lower arm 80 is performed. When the first locking member 40(1) and the second locking member 40(2) move to the second retracted position, with the operation of pressing the contact arm 8 against the driven member 300, the lower arm 80 can move in the upward direction beyond the second driving depth defining position P10(1) due to the relative movement with respect to the main body portion 10. The following operation is the same as that in the first mode of the screw driving machine 1A.

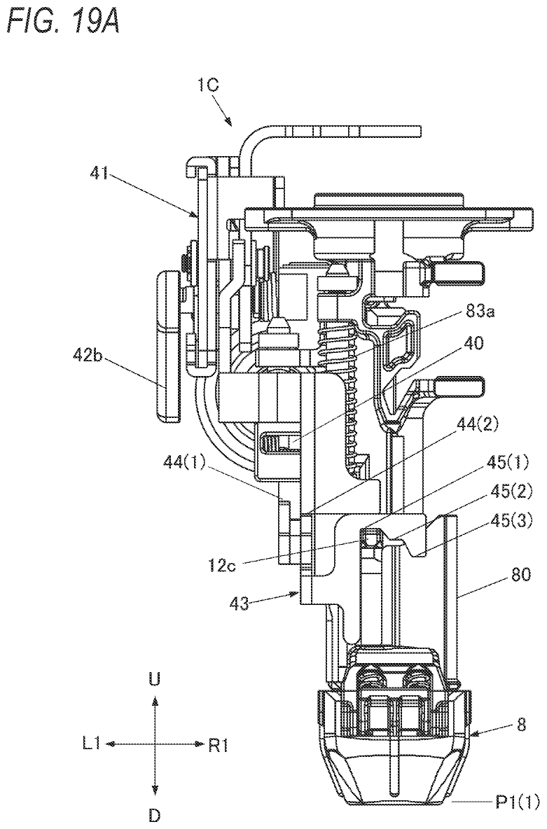

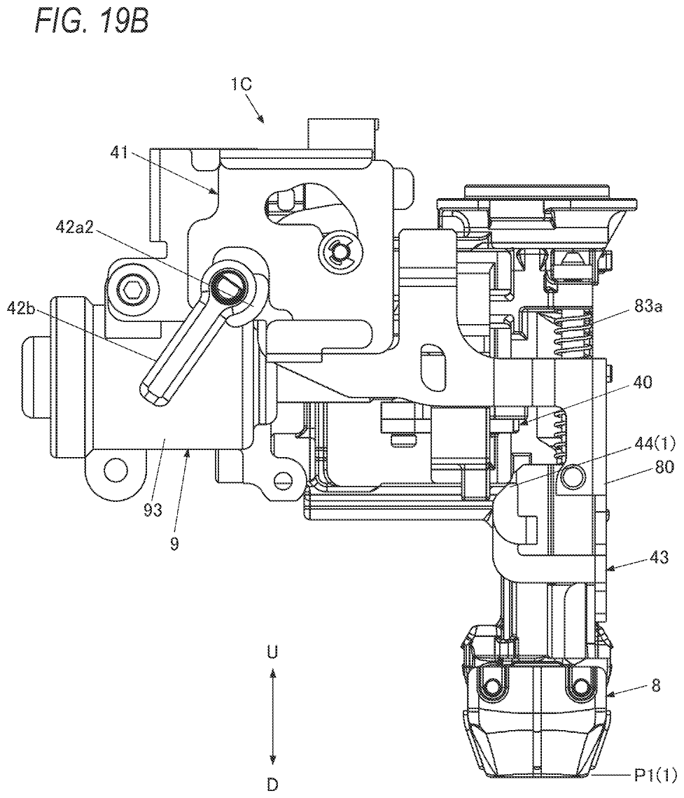

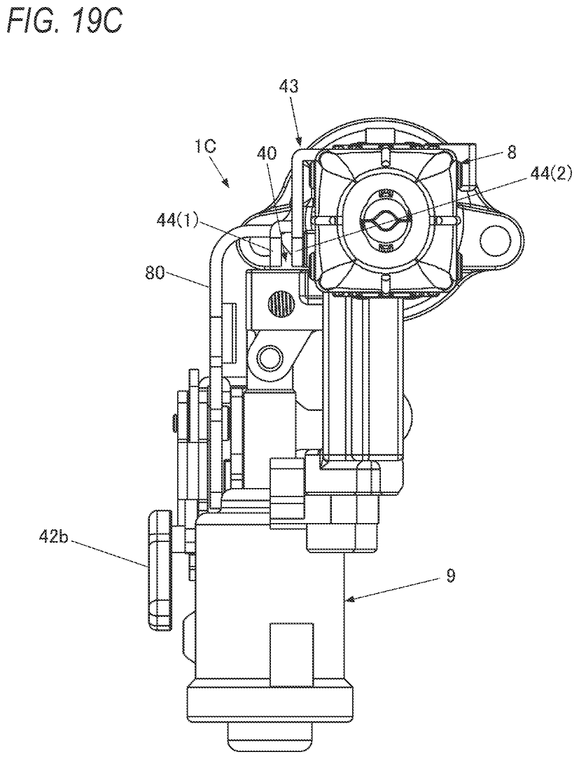

FIG. 19A is a front view of main parts of a screw driving machine according to a second modification of the present illustrative embodiment illustrating a state where the screw is driven into the driven member at a first driving depth (1) in the first mode, FIG. 19B is a side view of the main parts of the screw driving machine according to the second modification of the present illustrative embodiment illustrating the state where the screw is driven into the driven member at the first driving depth (1) in the first mode, and FIG. 19C is a bottom view of the main parts of the screw driving machine according to the second modification of the present illustrative embodiment illustrating the state where the screw is driven into the driven member at the first driving depth (1) in the first mode.

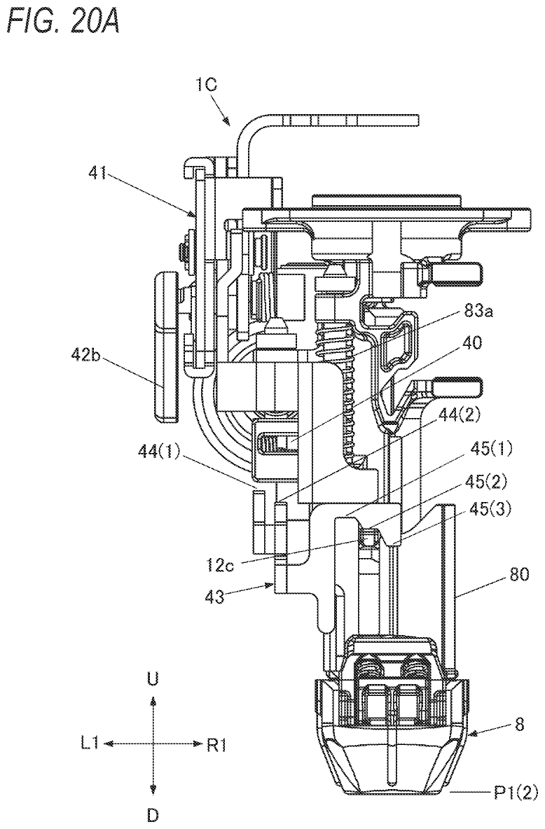

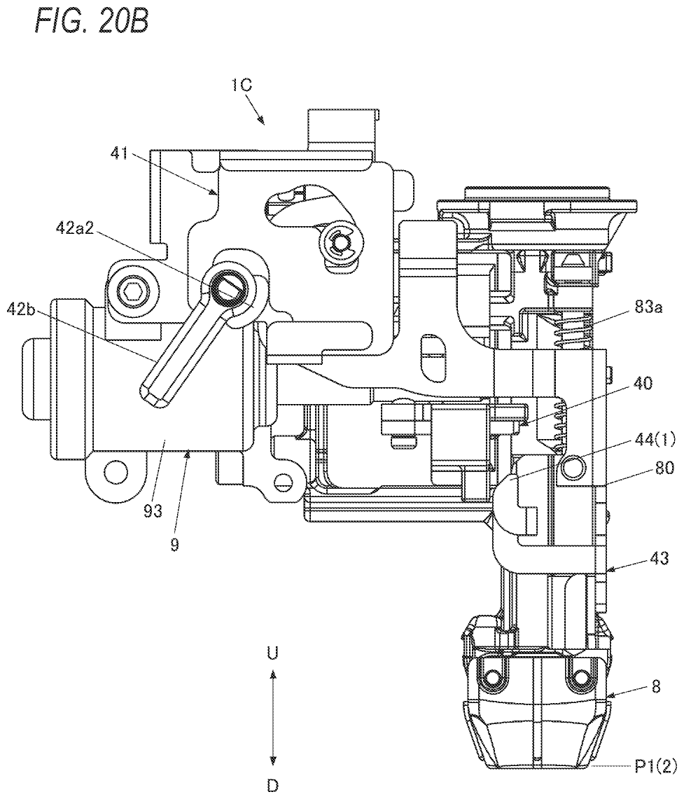

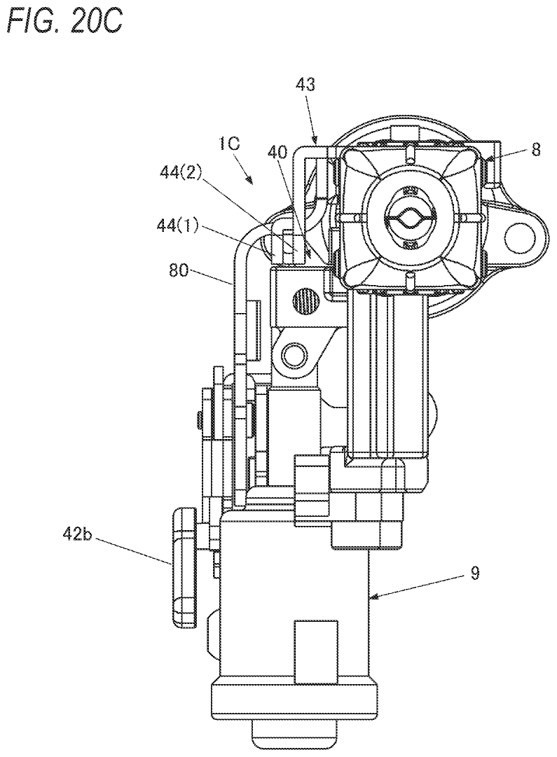

In addition, FIG. 20A is a front view of main parts of a screw driving machine according to the second modification of the present illustrative embodiment illustrating a state where the screw is driven into the driven member at a first driving depth (2) in the first mode, FIG. 20B is a side view of the main parts of the screw driving machine according to the second modification of the present illustrative embodiment illustrating the state where the screw is driven into the driven member at the first driving depth (2) in the first mode, and FIG. 20C is a bottom view of the main parts of the screw driving machine according to the second modification of the present illustrative embodiment illustrating the state where the screw is driven into the driven member at the first driving depth (2) in the first mode.

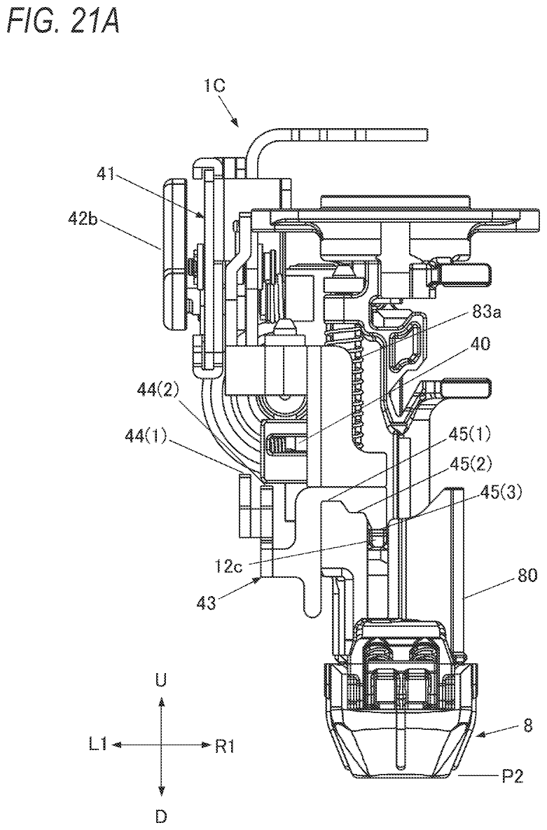

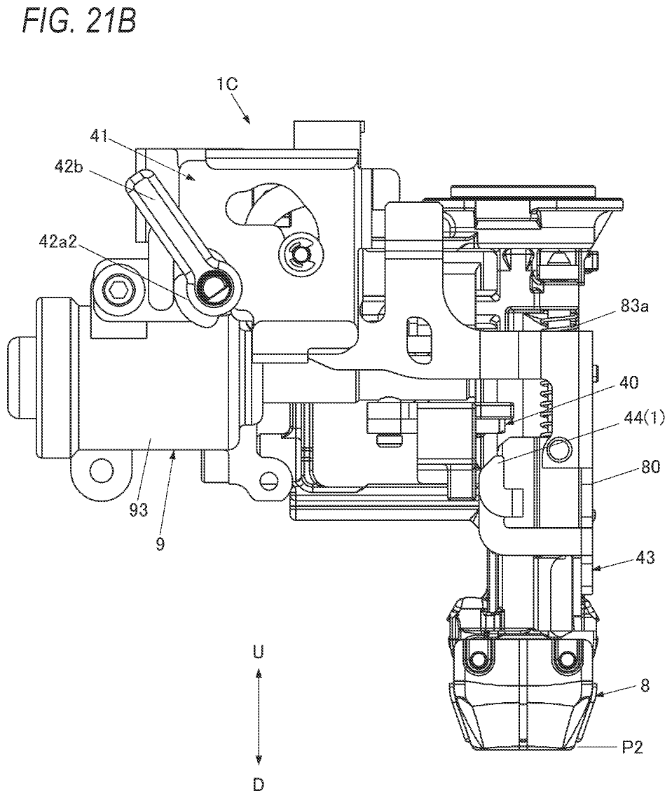

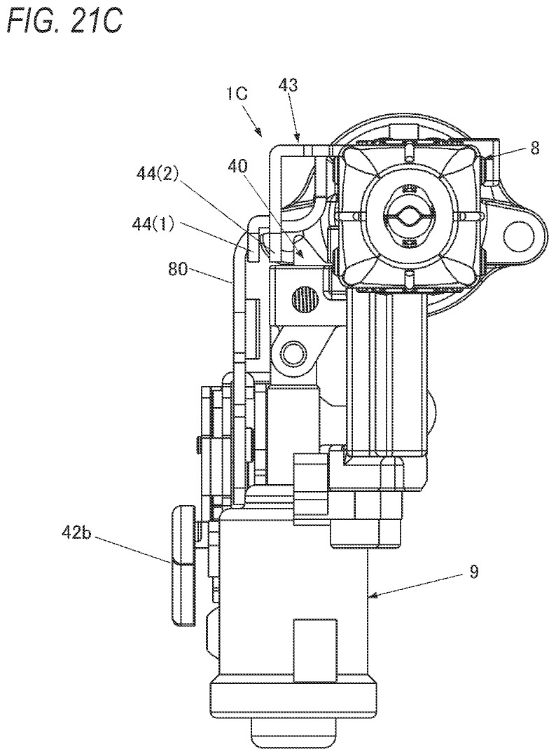

Further, FIG. 21A is a front view of main parts of a screw driving machine according to the second modification of the present illustrative embodiment illustrating a state where the screw is driven into the driven member in the second mode, FIG. 21B is a side view of the main parts of the screw driving machine according to the second modification of the present illustrative embodiment illustrating the state where the screw is driven into the driven member in the second mode, and FIG. 21C is a bottom view of the main parts of the screw driving machine according to the second modification of the present illustrative embodiment illustrating the state where the screw is driven into the driven member in the second mode.

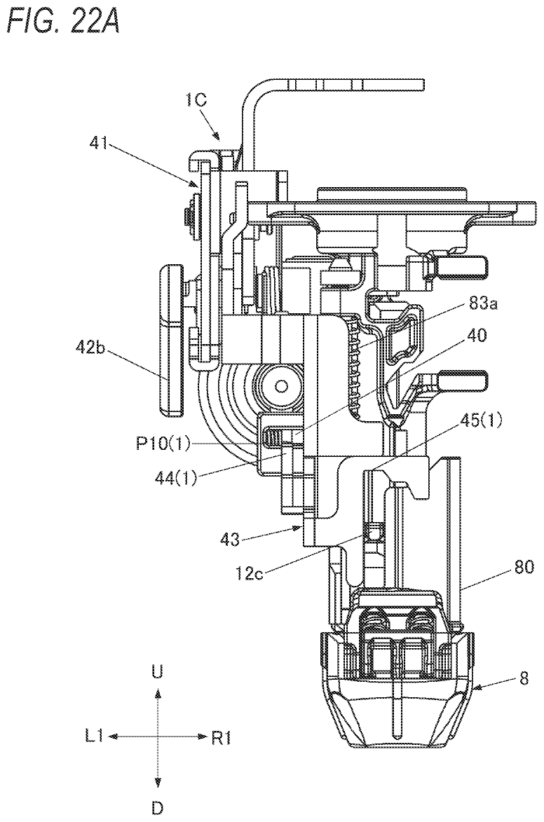

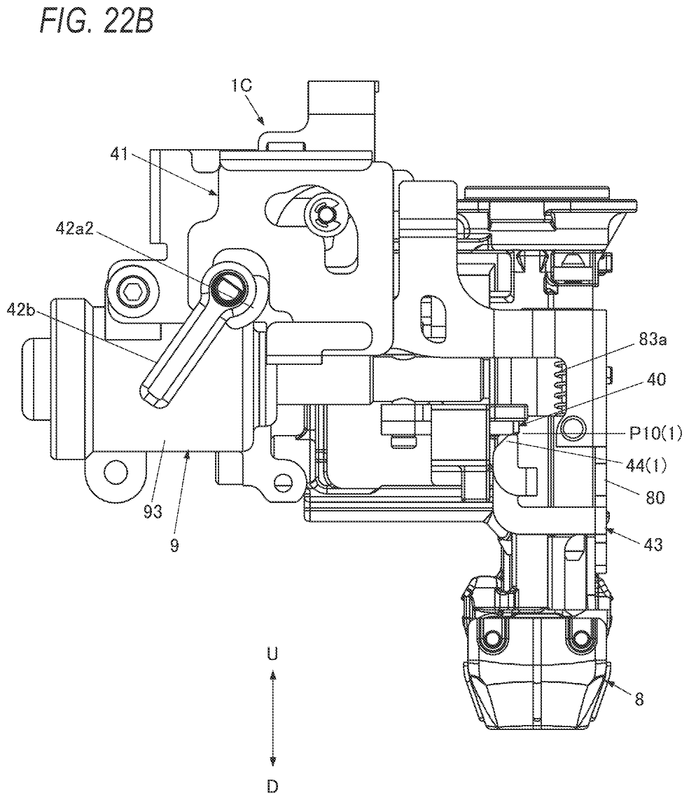

FIG. 22A is a front view of main parts of a screw driving machine according to the second modification of the present illustrative embodiment illustrating a sign-in state where the screw is driven into the driven member at the first driving depth (1) in the first mode, and FIG. 22B is a side view of the main parts of the screw driving machine according to the second modification of the present illustrative embodiment illustrating the sign-in state where the screw is driven into the driven member at the first driving depth (1) in the first mode.

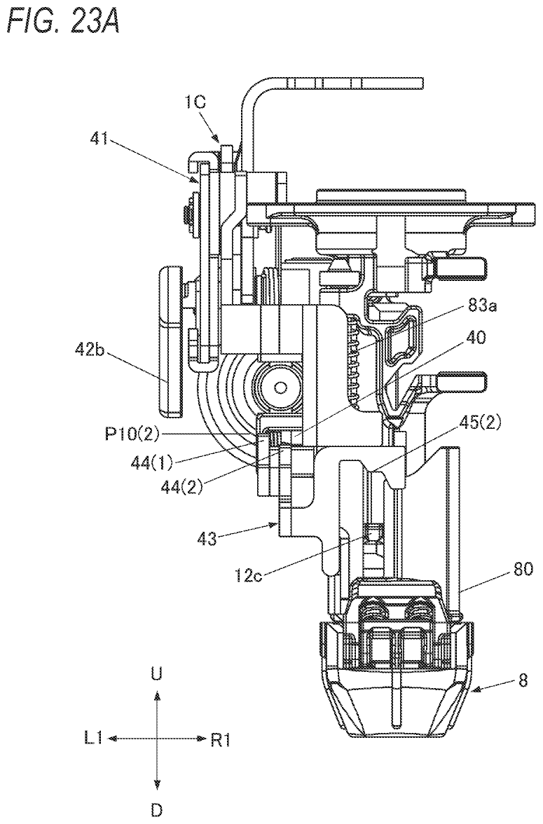

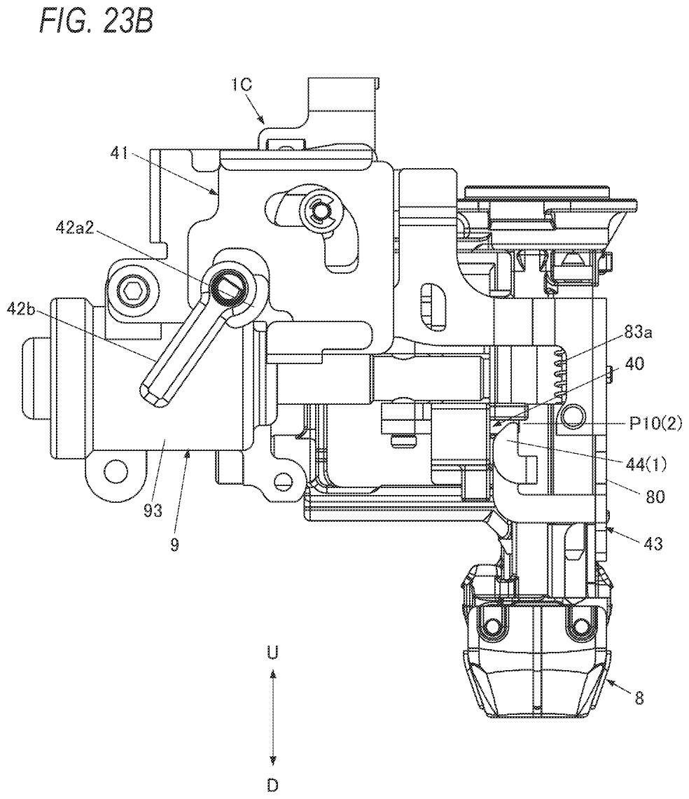

In addition, FIG. 23A is a front view of main parts of a screw driving machine according to the second modification of the present illustrative embodiment illustrating a sign-in state where the screw is driven into the driven member at the first driving depth (2) in the first mode, and FIG. 23B is a side view of the main parts of the screw driving machine according to the second modification of the present illustrative embodiment illustrating the sign-in state where the screw is driven into the driven member at the first driving depth (2) in the first mode.

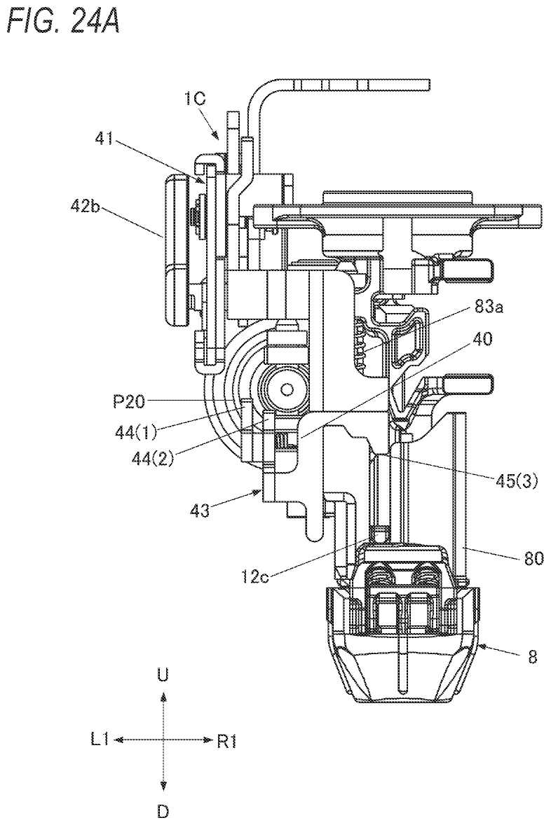

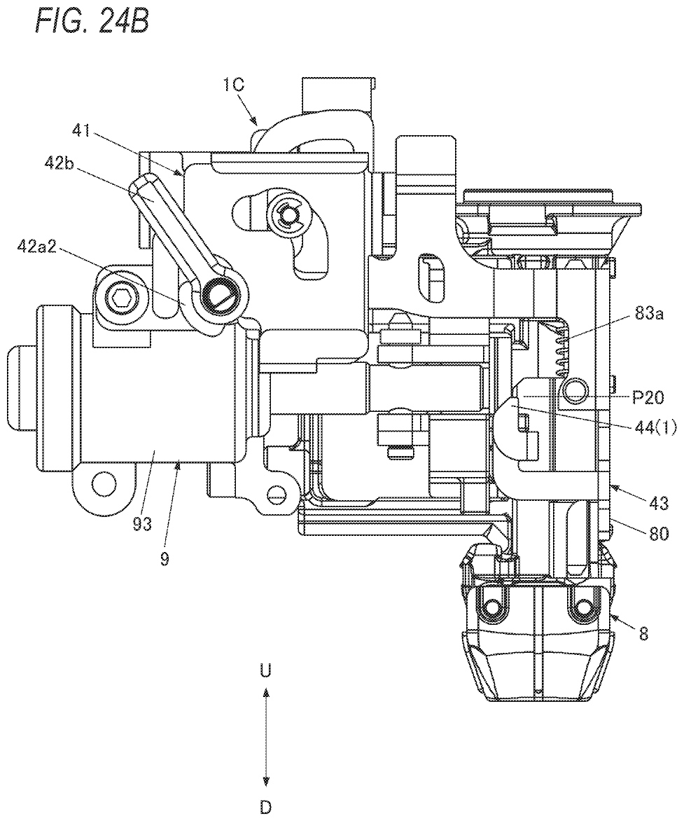

Further, FIG. 24A is a front view of main parts of a screw driving machine according to the second modification of the present illustrative embodiment illustrating a sign-in state where the screw is driven into the driven member in the second mode, and FIG. 24B is a side view of the main parts of the screw driving machine according to the second modification of the present illustrative embodiment illustrating the sign-in state where the screw is driven into the driven member in the second mode.

A screw driving machine 1C according to the second modification includes a second switching member 43 that is configured to switch a first bottom dead center position of the lower arm 80 and to switch a movement amount from the first bottom dead center position in the first mode. The second switching member 43 is an example of a driving depth regulating portion and a driving depth switching portion. The second switching member 43 is attached to the lower arm 80 and is supported so as to be movable in an arrow L1 direction or an arrow R1 direction intersecting the up-down direction.

The second switching member 43 includes a first locked portion 44(1) and a second locked portion 44(2) that selectively come into contact with the locking member 40 that has moved to the locking position when the lower arm 80 moves in the upward direction due to the relative movement with respect to the main body portion 10.

In addition, the second switching member 43 includes a first bottom dead center position regulating portion 45(1), a second bottom dead center position regulating portion 45(2), and a third bottom dead center position regulating portion 45(3) that selectively come into contact with a bottom dead center position regulating convex portion 12a provided in the nose portion 12 when the lower arm 80 moves in the downward direction due to the relative movement with respect to the main body portion 10.

In a case where the first driving depth (1) is selected in the first mode, the second switching member 43 moves in the arrow L1 direction or the arrow R1 direction, so that as illustrated in FIG. 19A, the first bottom dead center position regulating portion 45(1) moves to a position facing the bottom dead center position regulating convex portion 12a and the first locked portion 44(1) moves to a position facing the locking member 40 moved to the locking position.

In addition, in a case where the first driving depth (2) is selected in the first mode, the second switching member 43 moves in the arrow L1 direction or the arrow R1 direction, so that as illustrated in FIG. 20A, the second bottom dead center position regulating portion 45(2) moves to a position facing the bottom dead center position regulating convex portion 12c and the second locked portion 44(2) moves to a position facing the locking member 40 moved to the locking position.

Further, in the case where the second mode is selected, the second switching member 43 moves in the arrow L1 direction or the arrow R1 direction, so that as illustrated in FIG. 21A, the third bottom dead center position regulating portion 45(3) moves to a position facing the bottom dead center position regulating convex portion 12c and moves from a position facing the locking member 40 moved to the locking position to a position where the first locked portion 44(1) and the second locked portion 44(2) are released.

In the second switching member 43, as illustrated in FIG. 19A, in a state where the first bottom dead center position regulating portion 45(1) has moved to the position facing the bottom dead center position regulating convex portion 12c, when the lower arm 80 moves in the downward direction due to the relative movement with respect to the main body portion 10 by the lower arm 80 being biased by the biasing member 83a, the first bottom dead center position regulating portion 45(1) comes into contact with the bottom dead center position regulating convex portion 12c. Accordingly, in the case where the first driving depth (1) is selected in the first mode, as illustrated in FIGS. 19A and 19B, the bottom dead center position of the lower arm 80 is defined as a first bottom dead center position P1(1).

In the screw driving machine 1C, the lower arm 80 is pressed against a driven member (not illustrated), so that the lower arm 80 moves in the upward direction due to the relative movement with respect to the main body portion 10. In the second switching member 43, as illustrated in FIGS. 19A and 19C, when the lower arm 80 moves in the upward direction in a state where the first locked portion 44(1) has moved to the position facing the locking member 40 moved to the locking position, the first locked portion 44(1) comes into contact with the locking member 40 moved to the locking position as illustrated in FIGS. 22A and 22B. Accordingly, in the case where the first driving depth (1) is selected in the first mode, the movement amount of the lower arm 80 from the first bottom dead center position P1(1) is defined by the first locked portion 44(1), and the lower arm 80 moves to the first driving depth defining position P10(1). Thus, the first driving depth (1) of the screw 200 is defined.

When the lower arm 80 moves in the upward direction due to the relative movement with respect to the main body portion 10 to the first driving depth defining position P10(1) where the first locked portion 44(1) of the second switching member 43 comes into contact with the locking member moved to the locking position, the above-described sign-in state is obtained. The following operation is the same as that in the first mode of the screw driving machine 1A.

As illustrated in FIG. 20A, in the second switching member 43, in a state where the second bottom dead center position regulating portion 45(2) has moved to the position facing the bottom dead center position regulating convex portion 12c, when the lower arm 80 moves in the downward direction due to the relative movement with respect to the main body portion 10 by the lower arm 80 being biased by the biasing member 83a, the second bottom dead center position regulating portion 45(2) comes into contact with the bottom dead center position regulating convex portion 12c. Accordingly, in the case where the first driving depth (2) is selected in the first mode, as illustrated in FIGS. 20A and 20B, the bottom dead center position of the lower arm 80 is defined as a first bottom dead center position P1(2).

In the second switching member 43, as illustrated in FIGS. 20A and 20C, when the lower arm 80 moves in the upward direction in a state where the second locked portion 44(2) has moved to the position facing the locking member 40 moved to the locking position, the second locked portion 44(2) comes into contact with the locking member 40 moved to the locking position as illustrated in FIGS. 23A and 23B. Accordingly, in the case where the first driving depth (2) is selected in the first mode, the movement amount of the lower arm 80 from the first bottom dead center position P1(2) is defined by the second locked portion 44(2), and the lower arm 80 moves to the first driving depth defining position P10(2). Thus, the first driving depth (2) of the screw 200 is defined.

When the lower arm 80 moves in the upward direction due to the relative movement with respect to the main body portion 10 to the first driving depth defining position P10(2) where the second locked portion 44(2) of the second switching member 43 comes into contact with the locking member 40 moved to the locking position, the above-described sign-in state is obtained. The following operation is the same as that in the first mode of the screw driving machine 1A.

In the second switching member 43, as illustrated in FIG. 21A, in a state where the third bottom dead center position regulating portion 45(3) has moved to the position facing the bottom dead center position regulating convex portion 12c, when the lower arm 80 moves in the downward direction due to the relative movement with respect to the main body portion 10 by the lower arm 80 being biased by the biasing member 83a, the third bottom dead center position regulating portion 45(3) comes into contact with the bottom dead center position regulating convex portion 12c. Accordingly, in the case where the second mode is selected, as illustrated in FIGS. 21A and 21B, the bottom dead center position of the lower arm 80 is defined as the second bottom dead center position P2.

In the second switching member 43, as illustrated in FIGS. 21A and 21C, when the lower arm 80 moves in the upward direction in a state where movement is made from the position facing the locking member 40 moved to the locking position to the position where the first locked portion 44(1) and the second locked portion 44(2) are released, the lower arm 80 moves to the second driving depth defining position P20 as illustrated in FIGS. 24A and 24B. Thus, the second driving depth of the screw 200 is defined.

When the lower arm 80 moves in the upward direction due to the relative movement with respect to the main body portion 10 to the second driving depth defining position P20, the above-described sign-in state is obtained. The following operations are the same as those in the second mode of the screw driving machine 1A.

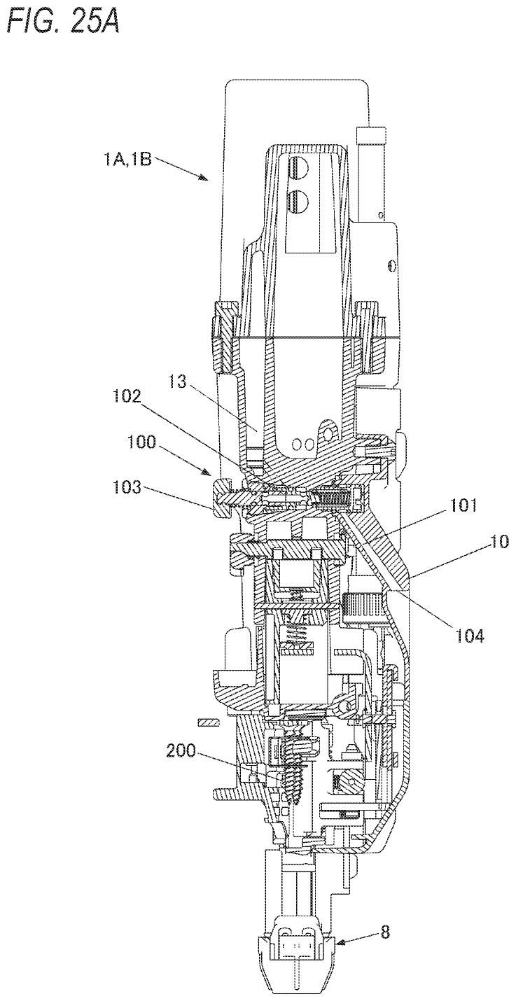

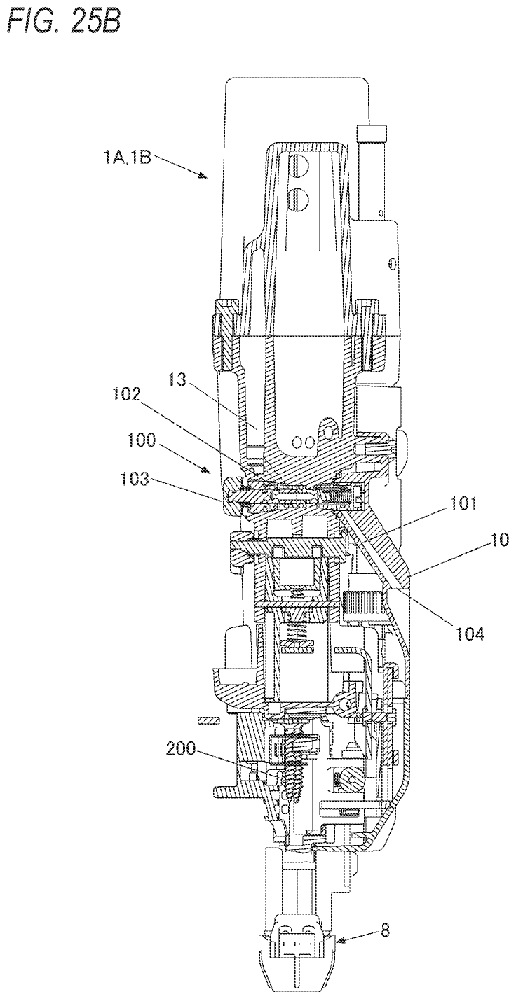

FIGS. 25A and 25B are cross-sectional views illustrating a first modified configuration example of the screw driving machine according to the present illustrative embodiment. The screw driving machines 1A, 1B, and 1C may include an air duster 100 that blows off foreign matter such as dust by air pressure using the compressed air supplied to the main chamber 13.

The air duster 100 includes a duster valve 102, a duster operation portion 103, and a duster blow outlet 104. The duster valve 102 is provided in a duster air flow path 101 connected to the main chamber 13. The duster operation portion 103 causes the duster valve 102 to operate. The duster blow outlet 104 is connected to the duster air flow path 101 and blows compressed air from the side portion of the main body portion 10 to the outside of the main body portion 10, for example.

In a case where the air duster 100 is used, as illustrated in FIG. 25B, when the duster operation portion 103 is pressed, the duster valve 102 is operated to open the duster air flow path 101, and the compressed air is blown out from the duster blow outlet 104. As a result, foreign matter such as dust below the contact arm 8 is blown off by air pressure, and a position where the screw 200 is driven can be visually recognized reliably.

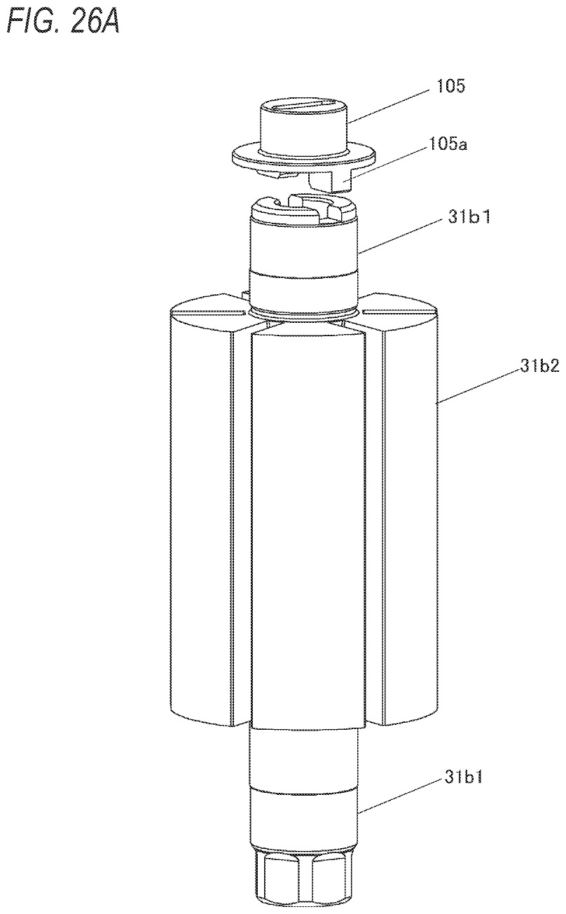

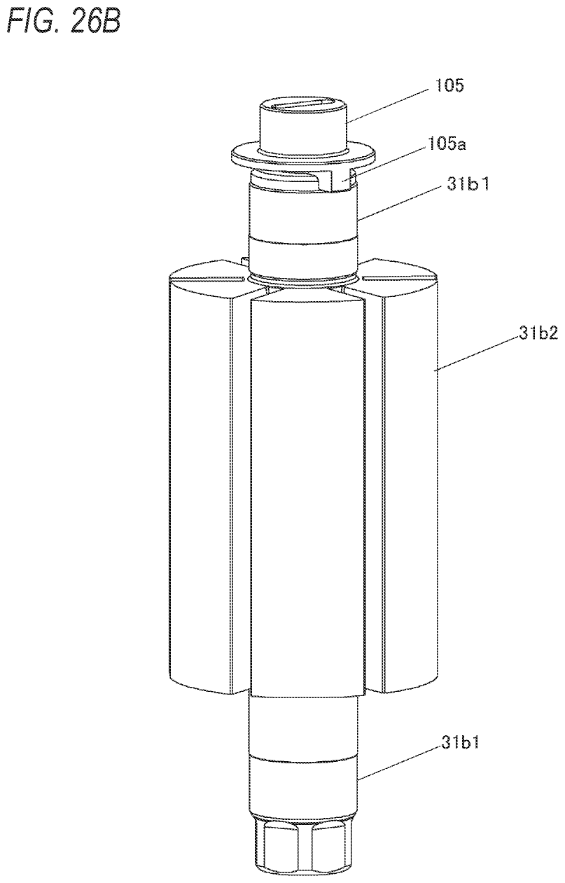

FIGS. 26A and 26B are perspective views of main parts illustrating a second modified configuration example of the screw driving machine according to the present illustrative embodiment. The screw driving machines 1A, 1B, and 1C include a rotation stopping member 105 that regulates rotation of the rotor 31b1 in order to enable replacement of the driver bit 2. The rotation stopping member 105 includes a rotor engaging portion 105a that is operable from the outside of the main body portion 10 and engages with the rotor 31b1.

When the driver bit 2 is to be replaced, as illustrated in FIG. 26B, the rotation stopping member 105 is pressed in a direction of the rotor 31b1 by a tool such as a flathead screwdriver (not illustrated), and the rotation stopping member 105 is pressed so as not to rotate. Accordingly, the rotation stopping member 105 regulates the rotation of the rotor 31b1 by the rotor engaging portion 105a engaging with the rotor 31b1, and regulates the rotation of the motor shaft 31a connected to the rotor 31b1 via the carrier 31h and the rotation of the driver bit 2 attached to the motor shaft 31a. By inserting a tool (not illustrated) from a nose portion 12 side and loosening a bit fixing screw (not illustrated) for fixing the driver bit 2, the driver bit 2 can be removed from the motor shaft 31a and a new driver bit 2 can be attached to the motor shaft 31a.

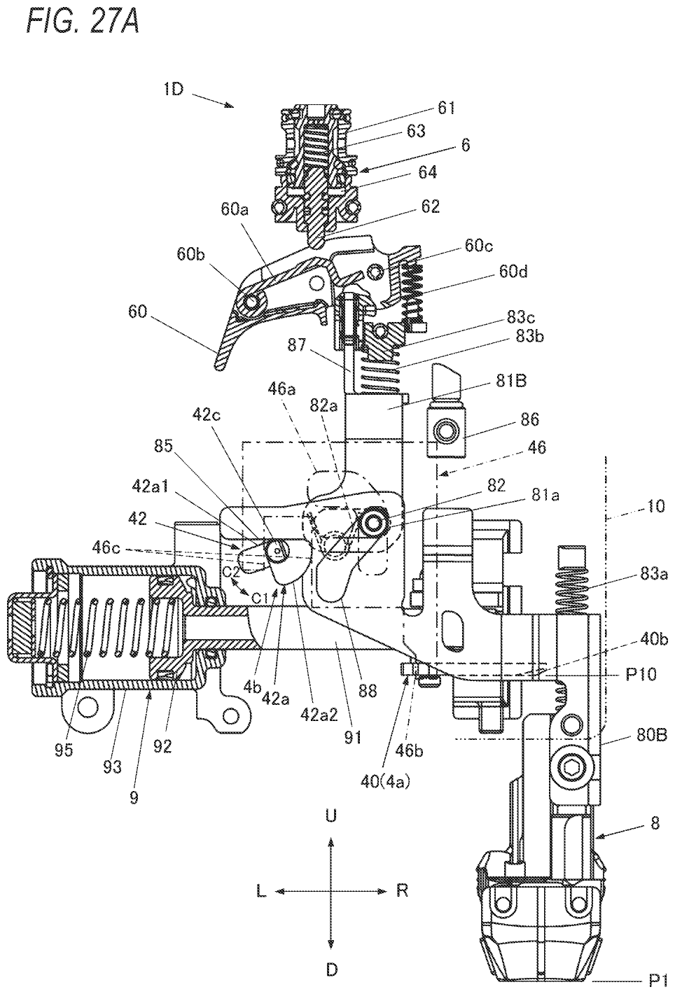

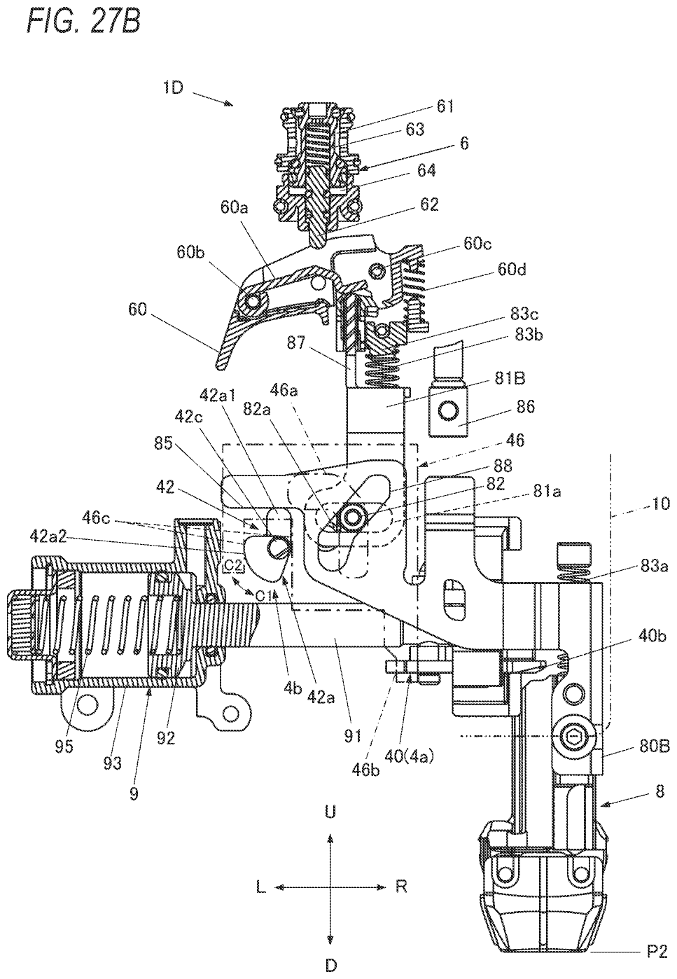

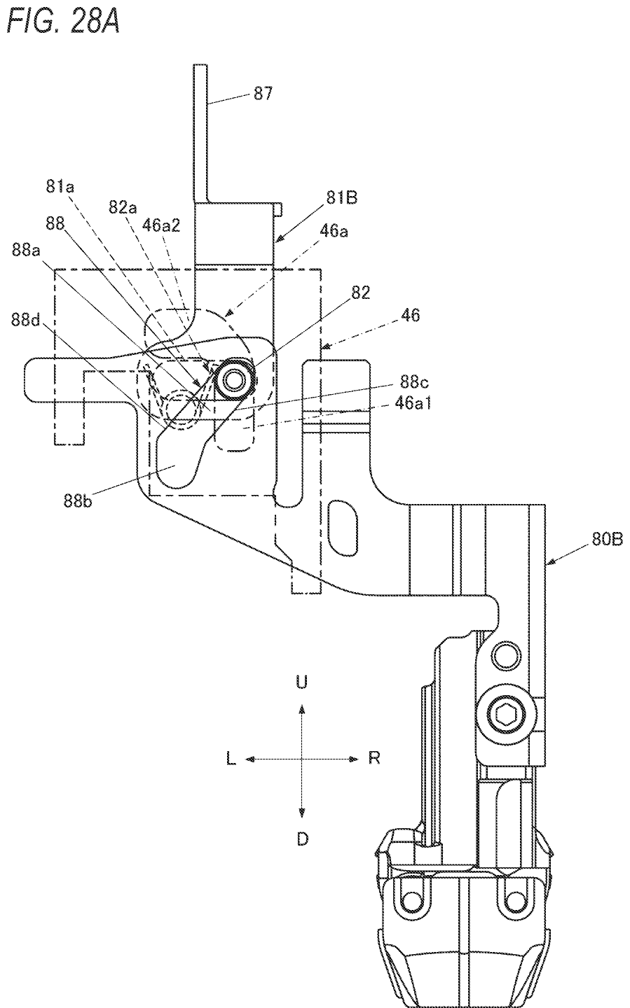

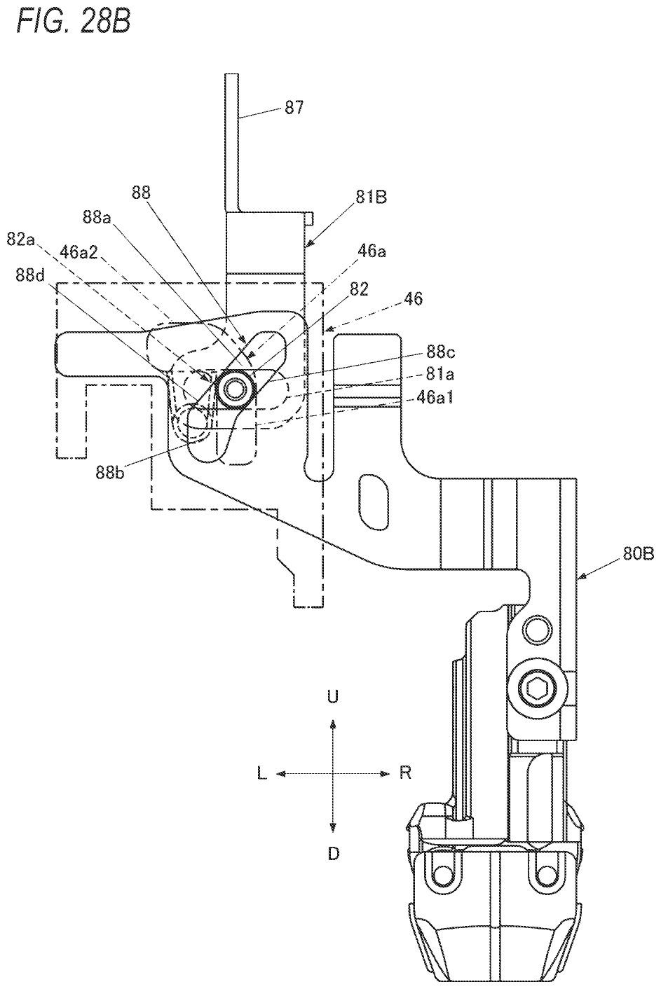

FIGS. 27A, 27B, 28A, and 28B are side sectional views of main parts of a screw driving machine according to a third modification of the present embodiment illustrating a modified example of the switching portion that switches a driving depth of the screw. FIGS. 27A and 28A illustrate states of respective parts when a first mode in which the driving depth of the screw is set to a first driving depth is selected. In addition, FIGS. 27B and 28B illustrate states of the respective parts when a second mode in which the driving depth of the screw is set to a second driving depth that is deeper than the first driving depth is selected. In a screw driving machine 1D according to the third modification, the same reference numerals are given to the same components as those of the screw driving machine 1A.

The screw driving machine 1D includes a lower arm 80B and an upper arm 81B. The lower arm 80B is configured to come into contact with a driven member (not illustrated). The upper arm 81B is configured to cause a pressing member 87 for pressing a contact lever 60a of a trigger 60 to operate. The upper arm 81B and the pressing member 87 may be integrally formed. The lower arm 80B and the upper arm 81B are configured to make a start valve 6 operable in cooperation with an operation of the trigger 60. The lower arm 80B and the upper arm 81B configure the contact arm 8 that is configured to cause the controller 70 illustrated in FIG. 1B and the like to operate. In addition, the screw driving machine 1D includes a roller 82 configured to transmit movement of the lower arm 80B to the upper arm 81B. Further, the screw driving machine 1D includes a switching member 46 configured to switch whether to regulate a movement amount of the lower arm 80B.

The lower arm 80B is an example of a first arm. The lower arm 80B is supported by a nose portion (not illustrated) of the screw driving machine 1D so as to be movable in the up-down direction. The lower arm 80B is biased in the downward direction by a biasing member 83a configured by a coil spring or the like.

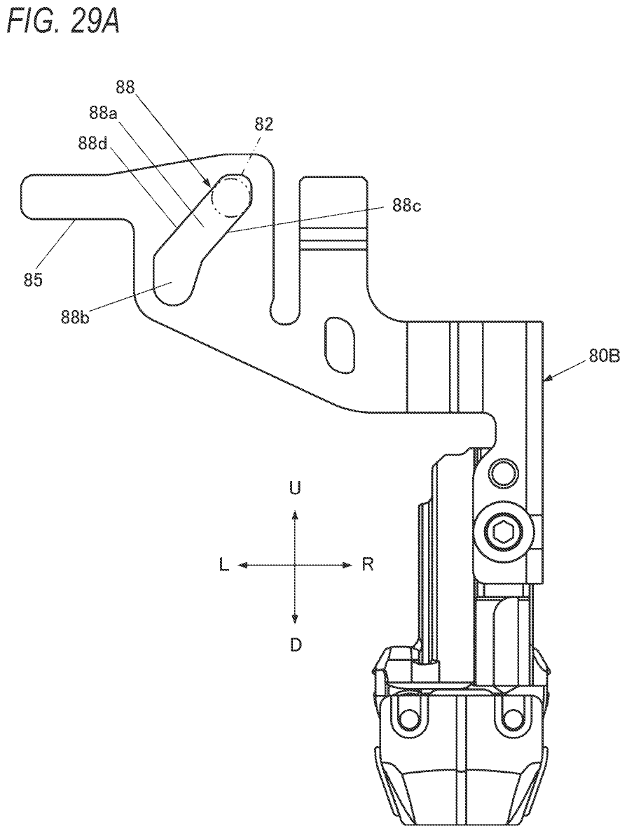

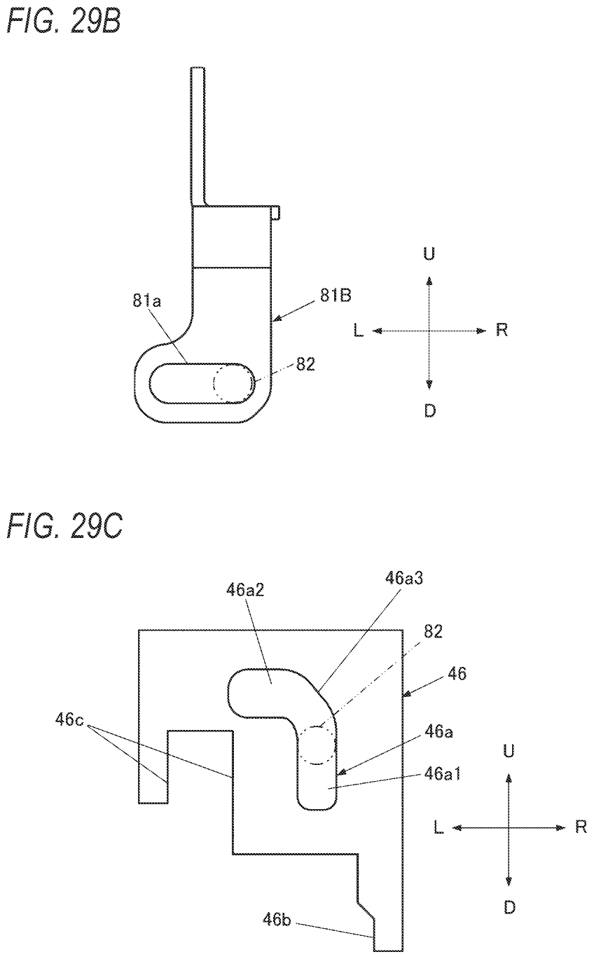

FIG. 29A is a side view illustrating a modified example of a lower arm. The lower arm 80B includes a cam groove 88 that causes the roller 82 to move and causes the lower arm 80 to move by movement of the roller 82.

In addition, the lower arm 80B includes a bottom dead center position switching affected portion 85. The bottom dead center position switching affected portion 85 receives a force for causing the lower arm 80B to move in the upward direction by a switching operation member 42.

The cam groove 88 includes a first cam groove 88a and a second cam groove 88b. The first cam groove 88a extends in an oblique direction with respect to a moving direction of the lower arm 80 indicated by arrows U and D and a moving direction of the switching member 41 indicated by arrows L and R. The second cam groove 88b extends along the moving direction of the lower arm 80 indicated by the arrows U and D.

The first cam groove 88a is inclined at a predetermined angle in a direction in which an upper side of the first cam groove 88a is directed to an arrow R side approaching an injection passage of the screw and a lower side of the first cam groove 88a is directed to an arrow L side moving away from the injection passage.

The first cam groove 88a includes a first engaging portion 88c and a second engaging portion 88d. The first engaging portion 88c is configured by a lower side of a pair of sides facing each other inclined in the same direction. The second engaging portion 88d is configured by an upper side of the pair of sides.

In the first cam groove 88a, the first engaging portion 88c and the second engaging portion 88d face each other at a predetermined distance, the predetermined distance allowing the roller 82 to be inserted between the first engaging portion 88c and the second engaging portion 88d and the roller 82 to move along the first engaging portion 88c and the second engaging portion 88d. The first engaging portion 88c and the second engaging portion 88d may be formed in a straight line or in a curved line.

The upper arm 81B is an example of a second arm. The upper arm 81B is supported by a side portion of the main body portion 10 of the screw driving machine 1D so as to be movable in the up-down direction. The upper arm 81B is biased in the downward direction by a biasing member 83b configured by a coil spring or the like.

FIG. 29B is a side view illustrating a modified example of an upper arm. The upper arm 81B has a guide groove 81a to which movement of the lower arm 80B is transmitted via the roller 82.

The guide groove 81a is an example of a transmission guide groove. The guide groove 81a has an elongated hole shape extending along an arrow L direction and an arrow R direction intersecting a moving direction of the upper arm 81B and a moving direction of the lower arm 80B indicated by the arrows U and D. The guide groove 81a is formed such that a distance between two sides facing each other in the short direction is slightly longer than a diameter of the roller 82. Accordingly, the guide groove 81a allows the roller 82 to be inserted thereinto and guides the roller 82 along the arrow L direction and the arrow R direction intersecting the moving direction of the upper arm 81B.

The switching member 46 is supported by the side portion of the main body portion 10 of the screw driving machine 1D so as to be movable in the arrow L direction and the arrow R direction intersecting the moving direction of the lower arm 80B in a state where movement along the moving direction of the lower arm 80B indicated by the arrows U and D is regulated.

FIG. 29C is a side view illustrating a modified example of a switching member. The switching member 46 has a guide groove 46a that is configured to guide and cause the roller 82 to move to a predetermined position. In addition, the switching member 46 includes an actuation portion 46b that is configured to cause the locking member 40 to operate. Further, the switching member 46 includes an affected portion 46c that receives a force for causing the switching member 46 to move in the arrow L direction or the arrow R direction intersecting the up-down direction.

The guide groove 46a includes a first guide groove 46a1 extending along the moving direction of the lower arm 80B indicated by the arrows U and D. The first guide groove 46a1 is formed such that a distance between two sides facing each other in the short direction is slightly longer than the diameter of the roller 82. Accordingly, the first guide groove 46a1 allows the roller 82 to be inserted thereinto and guides the roller 82 along the moving direction of the lower arm 80B in a state where the movement of the roller 82 is regulated in the arrow L direction and the arrow R direction intersecting the moving direction of the lower arm 80B.

The guide groove 46a includes a second guide groove 46a2 extending along the arrow L direction and the arrow R direction intersecting the moving direction of the lower arm 80B indicated by the arrows U and D. The second guide groove 46a2 is formed such that a distance between two sides facing each other in the short direction is slightly longer than the diameter of the roller 82. Accordingly, the second guide groove 46a2 allows the roller 82 to be inserted thereinto and guides the roller 82 along the arrow L direction and the arrow R direction intersecting the moving direction of the lower arm 80B in a state where the movement of the roller 82 is regulated in the moving direction of the lower arm 80B.

The guide groove 46a includes a third guide groove 46a3 that is configured to guide the roller 82 between the first guide groove 46a1 and the second guide groove 46a2. In the third guide groove 46a3, an inner side of a portion bent from the first guide groove 46a1 to the second guide groove 46a2 is formed by a curved surface, and an outer side of the portion is formed by a curved surface and an inclined surface.

In the screw driving machine 1D, when the lower arm 80B, the upper arm 81B, and the switching member 46 are attached, the cam groove 88, the guide groove 81a, and the guide groove 46a overlap. The roller 82 is inserted into a space formed at a portion where the cam groove 88, the guide groove 81a, and the guide groove 46a are intersected. The roller 82 is biased by a biasing member 82a such as a torsion coil spring in a direction of moving from the second guide groove 46a2 to the first guide groove 46a1.

In the screw driving machine 1D, when the contact arm 8 is pressed against the driven member (not illustrated) in a state where the first mode illustrated in FIGS. 27A and 28A is selected, the lower arm 80B moves in the upward direction indicated by the arrow U due to a relative movement with respect to the main body portion 10.

When the lower arm 80B moves in the upward direction, the first engaging portion 88c of the first cam groove 88a of the cam groove 88 inclined with respect to the moving direction of the lower arm 80B presses the roller 82.

When the roller 82 receives a pressing force from the first engaging portion 88c of the first cam groove 88a of the cam groove 88, the roller 82 is guided by the first guide groove 46a1 of the guide groove 46a of the switching member 46 and moves in the upward direction indicated by the arrow U.

When the roller 82 moves in the upward direction, the guide groove 81a of the upper arm 81B is pressed upward. Accordingly, the upper arm 81B moves in the upward direction indicated by the arrow U interlockingly with the lower arm 80B due to the relative movement with respect to the main body portion 10.

When the lower arm 80B moves in the upward direction due to the relative movement with respect to the main body portion 10 and the lower arm 80B moves to a first driving depth defining position P10 where the lower arm 80B comes into contact with the locking portion 40b of the locking member 40 (see FIG. 9A), the upper arm 81B moves to an operation possible position where the contact lever 60a of the trigger 60 is caused to operate. Accordingly, in a state where the contact arm 8 is pressed against the driven member until the lower arm 80 moves to the first driving depth defining position P10, when an operation of pulling the trigger 60 is performed, the contact lever 60a presses a valve stem 62 of the start valve 6, and the start valve 6 is brought into a sign-in state in which the start valve 6 is operated.

When the start valve 6 is operated, the main valve 5 is operated as described above, the compressed air is supplied to a driving cylinder 30, a driver bit 2 (driving piston 30a) is moved in the downward direction from a top dead center position, and the screw is driven into the driven member. When the driver bit 2 (driving piston 30a) moves to the bottom dead center position, the compressed air in a blowback chamber 33 supplied from the driving cylinder 30 is supplied to a feed piston 92, a feeding member 91 coupled to the feed piston 92 moves in the arrow L direction, and the locking member 40 attached to the feeding member 91 moves in the arrow L direction. Accordingly, the locking member 40 moves to a second retracted position to which the locking portion 40b is retracted from a movement path of the lower arm 80B.

When the locking member 40 moves to the second retracted position, by the operation of pressing the contact arm 8 against the driven member, the lower arm 80B can move in the upward direction beyond the first driving depth defining position P10 due to the relative movement with respect to the main body portion 10. Further, the compressed air is supplied to the air motor 31 and the driver bit 2 rotates.

When the driver bit 2 rotates, the screw driven into the driven member is tightened. In addition, by the operation of pressing the contact arm 8 against the driven member, the main body portion 10 further moves in the downward direction following the tightening of the screw.

When the lower arm 80B moves in the upward direction beyond the first driving depth defining position P10 due to the relative movement of the main body portion 10 and the lower arm 80B, the roller 82 is pressed by the first engaging portion 88c of the first cam groove 88a of the cam groove 88 and moves to the second guide groove 46a2 of the guide groove 46a of the switching member 46.

When the roller 82 receives a further pressing force from the first engaging portion 88c of the first cam groove 88a of the cam groove 88, the roller 82 is guided by the second guide groove 46a2 of the guide groove 46a of the switching member 46 and moves in a lateral direction indicated by the arrow L. When the upper arm 81B moves to the operation possible position, the upper arm 81B comes into contact with a support convex portion 83c to which the biasing member 83b is attached. Accordingly, even when the lower arm 80B moves in the upward direction due to the relative movement of the main body portion 10 and the lower arm 80B, the upper arm 81B is regulated from moving upward. Accordingly, interlocking engagement between the lower arm 80B and the upper arm 81B via the roller 82 is released, and a position of the upper arm 81B is held at the operation possible position while the upper arm 81B moves to the operation possible position and the roller 82 is located in the second guide groove 46a2.

When the main body portion 10 further moves in the downward direction following the tightening of the screw and the lower arm 80B relatively moves in the upward direction due to the operation of pressing the contact arm 8 against the driven member, the lower arm 80B comes into contact with the tightening depth adjusting portion 86 and presses the tightening depth adjusting portion 86 in the upward direction.

When the tightening depth adjusting portion 86 is pressed in the upward direction, as described above, an on-off valve 7 illustrated in FIG. 1B and the like is operated, and supply of the compressed air to the air motor 31 is stopped. When the supply of the compressed air to the air motor 31 is stopped, rotation of the driver bit 2 is stopped.

When the rotation of the driver bit 2 is stopped and the tightening of the screw is completed, the operator weakens a force for pressing the contact arm 8 against the driven member and causes the main body portion 10 to move in a direction separating from the driven member.

When the main body portion 10 moves in the direction separating from the driven member, the lower arm 80B moves in the arrow D direction by biasing of the biasing member 83a due to the relative movement of the main body portion 10 and the lower arm 80B. When the lower arm 80B moves in the arrow D direction from the top dead center position, the roller 82 is guided by the second guide groove 46a2 of the guide groove 46a and moves in the arrow R direction by inclination of the second engaging portion 88d of the cam groove 88 of the lower arm 80B and a biasing force of the biasing member 82a. When the roller 82 moves from the second guide groove 46a2 to the first guide groove 46a1 of the guide groove 46a, the roller 82 is guided by the first guide groove 46a1 and becomes movable in the downward direction. Accordingly, the upper arm 81B follows the lower arm 80B by the biasing of the biasing member 83b, and moves in the arrow D direction due to the relative movement with respect to the main body portion 10.

When the upper arm 81 moves in the arrow D direction, pressing of the contact lever 60a is released, and the contact lever 60a is separated from the start valve 6. When the contact lever 60a is separated from the start valve 6, the main valve 5 is closed as described above, and the supply of the compressed air to the driving cylinder 30 is stopped.

When the supply of the compressed air to the driving cylinder 30 is stopped and the pressure in the driving cylinder 30 decreases to the atmospheric pressure, the driver bit 2 (driving piston 30a) moves to the top dead center position. In addition, when the driver bit 2 moves to the top dead center position, supply of the compressed air to the feed piston 92 is stopped, and the feeding member 91 coupled to the feed piston 92 moves in the arrow R direction due to biasing of the biasing member 94a.

When the feeding member 91 moves in the arrow R direction, a feeding pawl (not illustrated) provided on the feeding member 91 feeds a next screw to the nose portion. In addition, the locking member 40 attached to the feeding member 91 moves in the arrow R direction. Accordingly, the locking member 40 moves to the locking position where the locking portion 40b protrudes to the movement path of the lower arm 80B.

Next, an operation of switching the screw driving machine 1D from a first mode to a second mode will be described, in the first mode, the driving depth of the screw is set to a first driving depth, and in the second mode, the driving depth of the screw is set to be deeper than the first driving depth.

In order to switch from the first mode to the second mode, the bottom dead center position of the lower arm 80B is raised from a first bottom dead center position P1 illustrated in FIG. 27A to a second bottom dead center position P2 illustrated in FIG. 27B, and the locking portion 40b of the locking member 40 is caused to move to the retracted position to which the locking portion 40b is retracted from the movement path of the lower arm 80B.

Therefore, in the second mode, an action portion 42a of the switching operation member 42 is caused to rotate clockwise as indicated by an arrow C2 by the operation of an operation portion 42b. When the action portion 42a rotates clockwise as indicated by the arrow C2, the second cam surface 42a2 presses the affected portion 46c of the switching member 46 in the arrow L direction. Accordingly, the switching member 46 moves in the arrow L direction.

When the switching member 46 moves in the arrow L direction, the roller 82 is pressed in the arrow L direction by the first guide groove 46a1 of the guide groove 46a of the switching member 46 and moves in the arrow L direction.

In addition, when the action portion 42a rotates clockwise as indicated by the arrow C2, a first cam surface 42a1 comes into contact with the bottom dead center position switching affected portion 85 of the lower arm 80B and presses up the bottom dead center position switching affected portion 85. Accordingly, the lower arm 80B moves in the upward direction.

In this manner, the switching operation member 42 causes the lower arm 80B to move in the upward direction indicated by the arrow U. When the lower arm 80B moves in the upward direction, a force to cause the roller 82 to move in the upward direction indicated by the arrow U and a force to cause the roller 82 to move in the arrow L direction are generated due to inclination of the first cam groove 88a of the cam groove 88.

On the other hand, the switching operation member 42 causes the roller 82 to move in the arrow L direction by the switching member 46 interlockingly with the movement of the lower arm 80B. Accordingly, even when the lower arm 80B moves in the upward direction, the roller 82 can be prevented from moving in the upward direction. Therefore, the roller 82 can be prevented from pressing the guide groove 81a of the upper arm 81B upward, and the upper arm 81B can be prevented from moving upward.

Therefore, engagement of the lower arm 80B with the upper arm 81B via the roller 82 is released and the lower arm 80B moves in the upward direction independently of the upper arm 81B. Then, the lower arm 80B moves to the second bottom dead center position P2 as illustrated in FIG. 27B.

The roller 82 may be configured to move upward by a predetermined amount due to the inclination of the first cam groove 88a of the cam groove 88 by an operation of causing the lower arm 80B to move to the second bottom dead center position P2 by the switching operation member 42. The upper arm 81B moves upward by a predetermined amount smaller than an amount by which the lower arm 80B moves from the first bottom dead center position P1 to the second bottom dead center position P2 interlockingly with the operation of causing the lower arm 80B to move to the second bottom dead center position P2 by the switching operation member 42. When the roller 82 moves upward by a predetermined amount, the guide groove 81a of the upper arm 81B is pressed upward by the roller 82, and a standby position of the upper arm 81B moves upward.

In the second mode, an upward movement amount of the upper arm 81B when the lower arm 80B moves to the second bottom dead center position P2 is an amount by which the upper arm 81B does not move to the operation possible position where the contact lever 60a of the trigger 60 is caused to operate. Accordingly, in the second mode, the pressing member 87, which is operated by the upper arm 81B, stands by at a position closer to the contact lever 60a than in the first mode.

Therefore, in the second mode, the movement amount of the upper arm 81B until the contact arm 8 is pressed against the driven member (not illustrated) and the upper arm 81B moves to the operation possible position where the contact lever 60a of the trigger 60 is caused to operate and the sign-in state is achieved can be reduced as compared with a case where the position of the upper arm 81B is not changed from a state in the first mode, and the operation feeling can be further improved.

In the screw driving machine 1D, the guide groove 81a of the upper arm 81B, the cam groove 88 of the lower arm 80B, and the guide groove 46a of the switching member 46 are coupled via the roller 82, and the upper arm 81B is biased in the downward direction by the biasing member 83b. Further, in the screw driving machine 1D, the lower arm 80 is biased in the downward direction by the biasing member 83a, and in the second mode, in a state where the contact arm 8 is not pressed against the driven member (not illustrated), the first cam surface 42a1 of the action portion 42a comes into contact with the bottom dead center position switching affected portion 85 of the lower arm 80B, and the lower arm 80B is supported at the second bottom dead center position P2. Accordingly, in the second mode, in the state where the contact arm 8 is not pressed against the driven member (not illustrated), the lower arm 80B can be fixed at the second bottom dead center position P2 even when the roller 82 is in contact with the middle of the first engaging portion 88c of the first cam groove 88a formed by an inclined surface of the cam groove 88.

What is claimed is:

1. A screw driving machine comprising:
a contact portion configured to abut against a driven member and to move from a first position to a second position via a third position by abutting against the driven member to press against the driven member;
a driving portion configured to move a driver bit in an axial direction when the contact portion reaches the third position and to drive a screw into the driven member by moving the driver bit in the axial direction;
a tightening portion configured to cause the driver bit to rotate about an axis and tighten the screw at least after the screw is driven;
a tightening depth switching portion configured to switch a tightening depth of the screw by the tightening portion after the screw is driven;
a driving depth regulating portion configured to regulate a movement amount of the contact portion between the second position and the third position; and
a driving depth switching portion configured to switch whether to regulate the movement amount of the contact portion by the driving depth regulating portion.

2. The screw driving machine according to claim 1, wherein the driving depth regulating portion includes a locking member configured to regulate the movement amount of the contact portion by protruding into a movement path of the contact portion.

3. The screw driving machine according to claim 2, wherein the locking member is movable between a locking position and a first retracted position by an operation of the driving depth switching portion, the locking member protruding into a movement path of the contact portion when the locking member is in the locking position, the locking member being retracted from the movement path of the contact portion when the locking member is in the first retracted position.

4. The screw driving machine according to claim 3, further comprising:
a screw feeding portion configured to operate interlocking with the driving portion and to feed the screw to an injection passage of the screw,
wherein the locking member is coupled to the screw feeding portion and is movable between the locking position and a second retracted position or between the first retracted position and the second retracted position by interlocking with an operation of the screw feeding portion feeding the screw, the locking member being retracted from a movement path of the contact portion when the locking member is in the second retracted position.

5. The screw driving machine according to claim 4,
wherein the locking member is rotatably supported by a feeding member of the screw feeding portion with a shaft as a fulcrum, and
wherein the driving depth switching portion is configured to cause the locking member to rotate with the shaft as a fulcrum so as to move the locking member between the locking position and the first retracted position.

6. The screw driving machine according to claim 2,
wherein the driving depth regulating portion includes a plurality of the locking members configured to regulate the movement amount of the contact portion, and
wherein the driving depth regulating portion is configured to switch the movement amount of the contact portion according to the locking member protruding to the movement path of the contact portion.

7. The screw driving machine according to claim 1, wherein the contact portion includes the driving depth regulating portion and the driving depth switching portion.

8. The screw driving machine according to claim 1, wherein the driving depth switching portion includes a switching operation portion configured to switch the first position of the contact portion.

9. The screw driving machine according to claim 8, wherein the switching of whether to regulate the movement amount of the contact portion and the switching of the first position of the contact portion are interlocked with an operation to the switching operation portion.

10. The screw driving machine according to claim 8, further comprising:
a main valve configured to switch whether to supply compressed air to the driving portion;
a start valve configured to cause the main valve to operate; and
a trigger including a contact lever configured to cause the start valve to operate,
wherein the contact portion includes:
a first arm configured to come into contact with the driven member;
a second arm configured to cause the contact lever to operate; and
a transmission member configured to engage with the first arm and the second arm and to transmit a movement of the first arm to the second arm so as to cause the second arm to interlock with the first arm,
wherein the first arm is configured to move from the first position to the second position via the third position, and
wherein the switching operation portion is configured to switch the first position of the first arm by releasing engagement between the first arm and the second arm via the transmission member and by causing the first arm to independently move with respect to the second arm.

11. The screw driving machine according to claim 10,
wherein the first arm has a cam groove for switching whether to interlock the first arm with the second arm,
wherein the cam groove includes:
an engaging portion configured to cause the first arm and the second arm to engage with each other via the transmission member; and
an engagement releasing portion configured to release the engagement between the first arm and the second arm by the engaging portion via the transmission member to allow the first arm to independently move with respect to the second arm, and
wherein the driving depth switching portion includes a switching member having a guide groove configured to cause the transmission member to move from the engaging portion to the engagement releasing portion.

12. The screw driving machine according to claim 10,
wherein the first arm has a cam groove for switching whether to interlock the first arm with the second arm,
wherein the cam groove includes:
a plurality of engaging portions configured to cause the first arm and the second arm to engage with each other via the transmission member; and
a plurality of engagement releasing portions configured to release the engagement between the first arm and the second arm by the engaging portions via the transmission member to allow the first arm to independently move with respect to the second arm, and
wherein the driving depth switching portion includes a switching member having a guide groove configured to cause the transmission member to move from the engaging portions to the engagement releasing portions.

13. The screw driving machine according to claim 10,
wherein the driving depth switching portion includes a switching member configured to switch whether to interlock the first arm with the second arm,
wherein the switching member has a guide groove configured to cause the transmission member to move, the switching member being configured to move interlockingly with the switching operation portion, and
wherein movement of the switching member causes the transmission member to move, so as to release the engagement between the first arm and the second arm via the transmission member.

14. The screw driving machine according to claim 13,
wherein the first arm has a cam groove, the transmission member being inserted into the cam groove, and
wherein the second arm has a transmission guide groove, the transmission member being inserted into the transmission guide groove.

15. The screw driving machine according to claim 14,
wherein the cam groove includes:
a first engaging portion configured by a lower side of a pair of sides facing each other obliquely with respect to a moving direction of the first arm and a moving direction of the switching member; and
a second engaging portion configured by an upper side of the pair of sides,
wherein the transmission guide groove extends along a direction intersecting the moving direction of the first arm, and
wherein the guide groove includes:
a first guide groove extending along the moving direction of the first arm; and
a second guide groove extending along the direction intersecting the moving direction of the first arm.

16. The screw driving machine according to claim 10,
wherein the first arm is movable in the axial direction,
wherein the switching operation portion is rotatable with a switching operation shaft as a fulcrum, the switching operation shaft extending in a direction perpendicular to the axial direction, and
wherein in case of the switching operation portion rotating with the switching operation shaft as the fulcrum, the switching operation portion is configured to:
cause the first arm to move in the axial direction and;
move the switching member in a direction perpendicular to the axial direction and an extending direction of the switching operation shaft.

17. The screw driving machine according to claim 16, wherein the switching operation portion comprises:
an operation portion having:
a first cam surface contactable with an affected portion of the first arm from the axial direction; and
a second cam surface contactable with an affected portion of the switching member from a movement direction of the switching member; and
an operation portion configured to receive a user's operation.

18. The screw driving machine according to claim 16,
wherein the driving depth regulating portion includes a locking member configured to regulate the movement amount of the contact portion by protruding into a movement path of the contact portion, and
wherein the switching member includes an actuation portion that is contactable with the locking member from the third direction to rotate the locking member with a shaft as a fulcrum to cause the locking portion to protrude into or retract from the movement path of the contact portion.
